(19) United States
(12) Patent Application Publication
(10) Pub. No.: US 2023/0383158 A1
(43) Pub. Date: Nov. 30, 2023

(54) ABRASIVE PARTICLES INCLUDING COATING, ABRASIVE ARTICLE INCLUDING THE ABRASIVE PARTICLES, AND METHOD OF FORMING

(71) Applicants: SAINT-GOBAIN ABRASIVES, INC., Worcester, MA (US); SAINT-GOBAIN ABRASIFS, Conflans-Sainte-Honorine (FR)

(72) Inventors: Marc YONGER, Paris (FR); Leslie DOS SANTOS, Paris (FR); Anne M. BONNER, Hudson, MA (US); Mark W. SIMON, Sutton, MA (US); Subramanian RAMALINGAM, Shrewsbury, MA (US); Anthony MARTONE, Belmont, MA (US); Hua FAN, Southborough, MA (US); Darrell K. EVERTS, Malta, NY (US); Brahmanandam V. TANIKELLA, Northborough, MA (US); Aldric BARBIER, Longnes (FR)

(21) Appl. No.: 18/248,313

(22) PCT Filed: Oct. 8, 2021
(86) PCT No.: PCT/US2021/071794

§ 371 Date: Apr. 7, 2023

Related U.S. Application Data
(60) Provisional application No. 63/172,037, filed on Apr. 7, 2021.
(60) Provisional application No. 63/090,172, filed on Oct. 9, 2020.

(51) Int. Cl. C09K 3/14; B24D 3/34

(52) U.S. Cl. CPC C09K 3/1436; B24D 3/346

(57) ABSTRACT

A plurality of abrasive particles can include a coating overlying at least a portion of a core. In an embodiment, the plurality of abrasive particles can include a sintered coating overlying the core, wherein the sintered coating can include an oxide material, and wherein more than 75% of the plurality of abrasive particles are fully covered. In another embodiment, the plurality of abrasive particles can include a sintered coating overlying the core, wherein the sintered coating can include an oxide material, and wherein more the plurality of abrasive particles can have an average coating coverage of greater than 85% of the surface of the core. In an embodiment, the plurality of abrasive particles can include an average coating thickness of not greater than 2 microns. In another embodiment, the plurality of abrasive particles can include a thickness standard deviation of the coating of not greater than 200% of the average coating thickness. In a particular embodiment, the coating can include sintered silica.

### TECHNICAL FIELD

The following is directed to abrasive particles including a coating overlying a portion of a core, abrasive article including the abrasive particles, and methods of forming.

### BACKGROUND ART

Abrasive articles are used in material removal operations, such as cutting, grinding, or shaping various materials. Fixed abrasive articles include abrasive particles held in a bond material. The bond material can include an organic and/or inorganic material. Organic bond abrasive articles often perform poorly under wet grinding conditions. Specifically, in a wet grinding operation, abrasive particles can become dislodged from the abrasive article before their consumption. The industry continues to demand improved abrasive articles.

### BRIEF DESCRIPTION OF THE DRAWINGS

The present disclosure may be better understood, and its numerous features and advantages made apparent to those skilled in the art by referencing the accompanying drawings.

FIG. 1 includes a flowchart illustrating a forming process of a coated abrasive article according to an embodiment.

FIGS. 2A and 2B include illustrations of cross sections of abrasive particles according to embodiments.

FIGS. 3A to 3C include graphs of Energy Dispersive Spectroscopy readouts of abrasive particle samples.

FIG. 4 includes a plot illustrating Modulus of Rupture (MoR) of abrasive samples.

FIG. 5 includes a plot illustrating MoR between abrasive samples.

FIG. 6 includes a plot illustrating of dry and wet MoR and MoR retention of abrasive samples.

FIGS. 7A and 7B include plots illustrating G-Ratio and Material Removal Rate (MRR) of abrasive samples.

FIGS. 8A to 8C include atomic force microscopic images of abrasive particle samples.

FIG. 9 includes an illustration of a cross section of a bonded abrasive article according to an embodiment.

FIG. 10 includes an illustration of a process of forming an abrasive article according to an embodiment.

FIG. 11 includes an illustration of a cross section of a coated abrasive article according to an embodiment.

FIGS. 12A to 12D include images of abrasive particles according to embodiments herein.

FIGS. 13A and 13B include images of abrasive particles.

FIG. 14A and FIG. 14B include a graph illustrating contents of silica of samples.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE PREFERRED EMBODIMENTS

The following description in combination with the figures is provided to assist in understanding the teachings provided herein. The following disclosure will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

Embodiments are directed to abrasive particles, wherein each abrasive particle can include a coating overlying a core. The abrasive particles can include a batch of abrasive particles or otherwise have a suitable sample size that is statically relevant. The abrasive particles can be suitable for forming various abrasive articles including, for example, fixed abrasive articles, such as bonded abrasives, coated abrasives, and superabrasive articles. The abrasive particles can have improved bonding to the bond material contained in an abrasive article and facilitate improved performance of the abrasive article.

Embodiments further relate to process of forming the abrasive particles. The process can include a heat treatment to facilitate formation of a coating that has improved properties. For example, the process can allow formation of abrasive particles having improved average thickness of the coating, improved standard deviation of the coating thickness, and improved morphology of the abrasive particles. In another instance, the coating can facilitate improved moisture resistance of the abrasive particles and formation of an interface that has improved moisture resistance between the abrasive particles and the bond material in an abrasive article.

Further embodiments are directed to abrasive articles including a bond material and the abrasive particles. The abrasive articles can have improved bonding between the bond material and abrasive particles, which in turn can help improve performance and/or properties of abrasive articles. For example, abrasive articles of embodiments herein can have improved grinding performance under wet conditions, improved performance after aging, and extended service life.

The abrasive articles can include a fixed abrasive article including, for example, coated abrasives, such as a belt and a disc, bonded abrasives including organic bond materials and/or inorganic bond materials, and superabrasive tools. Exemplary bonded abrasive articles can include, for instance, grinding wheels, cutoff wheels, ultra-thin wheels, combination wheels, cutting wheels, chop saws, or any combination thereof.

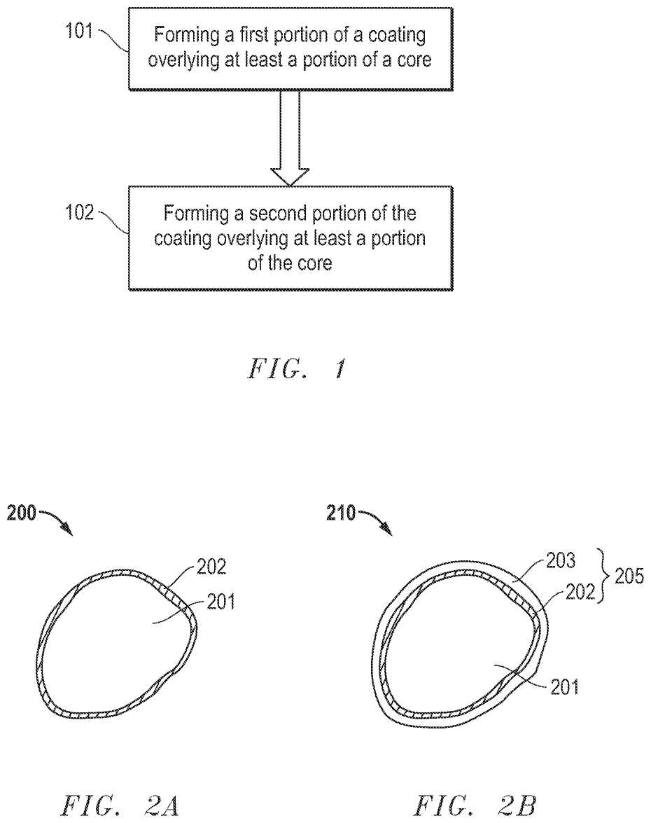

FIG. 1 includes a flowchart illustrating an exemplary process of forming abrasive particles, wherein each abrasive particle can include a coating overlying a core. At block 101, the process can include forming a first portion of a coating overlying at least a portion of a core of each abrasive particle. Formation of the first portion can include treating the core with a first material including silica. For example, the first material can include a dispersion of silica in a solvent, and cores can be mixed with the dispersion. The solvent can be aqueous or an organic solvent. In another instance, the first material can include a powder including silica and a blend of powder and cores can be formed. Mixing equipment may be used to facilitate formation of uniform mixture of cores and the first material. Examples of mixing equipment can include Hobart mixers, Hudson mixers, or the like, or another mixing device.

In a particular embodiment, the first material can include colloidal silica. In an aspect, the first material can include a colloidal silica suspension. Cores can be wetted with the colloidal silica suspension. In another aspect, colloidal silica can be mixed with the cores such that the mixture can include a particular content of silica for a total weight of the cores that can facilitate improved formation and properties of the coating. For example, the mixture can include at least 0.01 wt. % of silica for a total weight of the cores, such as at least 0.02 wt. %, at least 0.03 wt. %, at least 0.04 wt. %, at least 0.05 wt. %, at least 0.06 wt. %, at least 0.07 wt. %, at least 0.08 wt. %, at least 0.09 wt. %, at least 0.1 wt. %, at least 0.15 wt. %, at least 0.16 wt. %, at least 0.17 wt. %, at least 0.18 wt. %, at least 0.19 wt. %, at least 0.2 wt. %, at least 0.25 wt. %, at least 0.26 wt. %, at least 0.27 wt. %, at least 0.28 wt. %, at least 0.29 wt. %, or at least 0.3 wt. % for a total weight of the cores. In another instance, the mixture may include not greater than 1 wt. % of silica for a total weight of the cores, such as not greater than 0.9 wt. %, not greater than 0.8 wt. %, not greater than 0.7 wt. %, not greater than 0.6 wt. %, not greater than 0.55 wt. %, not greater than 0.5 wt. %, not greater than 0.48 wt. %, not greater than 0.46 wt. %, not greater than 0.45 wt. %, not greater than 0.43 wt. %, not greater than 0.42 wt. %, not greater than 0.41 wt. %, not greater than 0.4 wt. %, not greater than 0.38 wt. %, not greater than 0.37 wt. %, not greater than 0.36 wt. %, not greater than 0.35 wt. %, or not greater than 0.34 wt. % for a total weight of the cores. Moreover, the mixture can include silica in a content including any of the minimum and maximum percentages noted herein.

In an embodiment, core can include an abrasive material including a crystalline material, such as a polycrystalline material, a monocrystalline material, or a combination thereof, an amorphous material, a ceramic material, a glass-ceramic material, superabrasives, minerals, a carbon-based material, or any combination thereof. In a further aspect, the sintered ceramic material can include oxides, carbides, nitrides, borides, oxycarbides, oxynitrides, silicates, or any combination thereof. For instance, core can include a material selected from the group of silicon dioxide, silicon carbide, alumina, zirconia, flint, garnet, emery, rare earth oxides, rare earth-containing materials, cerium oxide, sol-gel derived particles, gypsum, iron oxide, glass-containing particles, and a combination thereof. In another instance, abrasive particles may also include silicon carbide (e.g., Green 39C and Black 37C), brown fused alumina (57A), seeded gel abrasive, sintered alumina with additives, shaped and sintered aluminum oxide, pink alumina, ruby alumina (e.g., 25A and 86A), electrofused monocrystalline alumina 32A, MA88, alumina zirconia abrasives (e.g., NZ, NV, ZF Brand from Saint-Gobain Corporation), extruded bauxite, sintered bauxite, cubic boron nitride, diamond, aluminum oxy-nitride, sintered alumina (e.g., Treibacher's CCCSK), extruded alumina (e.g., SR1, TG, and TGII available from Saint-Gobain Corporation), or any combination thereof. In another example, core can have a Mohs hardness or at least 7, such as at least 8, or even at least 9.

In another embodiment, the core can include non-agglomerated particle, non-shaped abrasive particles, shaped abrasive particle, or any combination thereof. For example, the core can include shaped abrasive particles as disclosed for example, in US 20150291865, US 20150291866, and US 20150291867. Shaped abrasive particles are formed such that each particle has substantially the same arrangement of surfaces and edges relative to each other for shaped abrasive particles having the same two-dimensional and three-dimensional shapes. As such, shaped abrasive particles can have a high shape fidelity and consistency in the arrangement of the surfaces and edges relative to other shaped abrasive particles of the group having the same two-dimensional and three-dimensional shape. By contrast, non-shaped abrasive particles can be formed through different process and have different shape attributes. For example, non-shaped abrasive particles are typically formed by a comminution process, wherein a mass of material is formed and then crushed and sieved to obtain abrasive particles of a certain size. However, a non-shaped abrasive particle will have a generally random arrangement of the surfaces and edges, and generally will lack any recognizable two-dimensional or three dimensional shape in the arrangement of the surfaces and edges around the body. Moreover, non-shaped abrasive particles of the same group or batch generally lack a consistent shape with respect to each other, such that the surfaces and edges are randomly arranged when compared to each other. Therefore, non-shaped grains or crushed grains have a significantly lower shape fidelity compared to shaped abrasive particles.

In a particular embodiment, the core can include a sintered ceramic material having a particular average crystallite size. In an aspect, the average crystallite size can be less than 1 micron, such as not greater than 0.9 microns, not greater than 0.8 microns, not greater than 0.7 microns, not greater than 0.6 microns, not greater than 0.5 microns, not greater than 0.4 microns, not greater than 0.3 microns, not greater than 0.2 microns, not greater than 0.1 microns, not greater than 0.09 microns, not greater than 0.08 microns, not greater than 0.07 microns, not greater than 0.06 microns, not greater than 0.05 microns, not greater than 0.04 microns, not greater than 0.03 microns, not greater than 0.02 microns, or not greater than 0.01 microns. In another aspect, the core 201 can include a sintered ceramic material having an average crystallite size of at least 0.01 microns, such as at least 0.02 microns, at least 0.03 microns, at least 0.04 microns, at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16, at least 0.17 microns, at least 0.18 microns, at least 0.19 microns, at least 0.2 microns, at least 0.3 microns, or at least 0.4 microns, or at least 0.5 microns. Moreover, the core can include a sintered ceramic material including an average crystallite size in a range including any of the minimum and maximum values noted herein. For instance, the core can include a sintered ceramic material having an average crystallite size in a range including at least 0.01 microns and less than 1 micron, in a range including at least 0.03 microns and not greater than 0.8 microns, in a range including at least 0.05 microns and not greater than 0.6 microns, in a range including at least 0.08 microns and not greater than 0.4 microns, or in a range including at least 0.1 microns and not greater than 0.2 microns. The average crystallite size can be measured by an uncorrected intercept method by SEM micrographs.

A particular example of sintered ceramic material can include alumina (Al₂O₃), including, for example, microcrystalline alumina (e.g., sol-gel alumina), nanocrystalline alumina, fused alumina, such as brown fused alumina, or a combination thereof. Particularly, alumina (Al₂O₃) can include alpha alumina (α-Al₂O₃).

In a particular aspect, the core can include a polycrystalline alpha alumina (α-Al₂O₃), and more particularly, the polycrystalline alpha alumina (α-Al₂O₃) can include an average crystallite size less than 1 micron, such as the average crystallite size as described with respect to the sintered ceramic material. In an even more particular aspect, the core can consist essentially of polycrystalline alpha alumina (α-Al₂O₃) including an average crystallite size of less than 1 micron.

In an embodiment, the core can include a density of at least 80% of its theoretical density, such as at least 85%, at least 88%, at least 90%, at least 92%, at least 95%, or at least 98% of its theoretical density. In another embodiment, the core may include a porosity not greater than 10 vol % for a total volume of the core, not greater than 9 vol %, not greater than 8 vol %, not greater than 7 vol %, not greater than 6 vol %, not greater than 5 vol %, not greater than 4 vol %, not greater than 3 vol %, not greater than 2 vol %, or not greater than 1 vol % for the total volume of the core. In a particular embodiment, the core can be essentially free of pores.

In a further embodiment, the core can have the density of the sintered ceramic material that forms the core. For example, depending on the sintered ceramic material, the core can include a density of at least 2.10 g/cm³, at least 2.20 g/cm³, 2.30 g/cm³, at least 2.40 g/cm³, at least 2.50 g/cm³, at least 2.60 g/cm³, at least 2.70 g/cm³, 2.80 g/cm³, at least 2.90 g/cm³, at least 3.00 g/cm³, at least 3.10 g/cm³, at least 3.20 g/cm³, at least 3.30 g/cm³, at least 3.40 g/cm³, 3.50 g/cm³, at least 3.55 g/cm³, at least 3.60 g/cm³, at least 3.65 g/cm³, at least 3.70 g/cm³, at least 3.75 g/cm³, at least 3.80 g/cm³, at least 3.85 g/cm³, at least 3.90 g/cm³, or at least 3.95 g/cm³. Additionally or alternatively, the core can include a density of not greater than 5.80 g/cm³, not greater than 5.70 g/cm³, not greater than 5.60 g/cm³, not greater than 5.50 g/cm³, not greater than 5.40 g/cm³, not greater than 5.30 g/cm³, not greater than 5.20 g/cm³, not greater than 5.10 g/cm³, not greater than 5.00 g/cm³, not greater than 4.90 g/cm³, not greater than 4.80 g/cm³, not greater than 4.70 g/cm³, not greater than 4.60 g/cm³, not greater than 4.50 g/cm³, not greater than 4.40 g/cm³, not greater than 4.30 g/cm³, not greater than 4.20 g/cm³, not greater than 4.10 g/cm³, not greater than 4.00 g/cm³, or not greater than 3.97 g/cm³. In a further example, the core can have a density in a range including any of the minimum and maximum values noted herein.

Turning to FIG. 1, in an aspect, forming the first portion of the coating can further include heating the mixture including the cores treated with silica. Particularly, heating can be conducted at a temperature sufficient to form the first portion including a sintered ceramic material overlying at least a portion of the core. In an aspect, heating can include sintering silica. In a particular aspect, heating can include sintering colloidal silica. For instance, heating can be performed at a sintering temperature of colloidal silica. In another example, heating can be conducted at a temperature of at least 800° C., such as at least 830° C. or at least 850° C. In still another instance, the heating temperature may be not greater than 1100° C., such as not greater than 1000° C., not greater than 950° C., not greater than 900° C., or not greater than 850° C. Moreover, the heating temperature can be in a range including any of the minimum and maximum temperatures noted herein. In a particular instance, the heating temperature can be in a range from 800° C. to 950° C. or in a range from 850° C. to 900° C.

In an aspect, heating can be performed in a calciner, particularly in a rotary tube. The rotary tube can have a tilted angle of not greater than 200 with respect to the floor. In another aspect, heating can be performed for a certain period of time sufficient for forming sintered silica. For instance, heating can include sintering silica, such as colloidal silica, for at least 5 minutes, such as at least 10 minutes, at least 13 minutes, or at least 15 minutes. In another instance, sintering silica may be performed for not greater than 60 minutes, such as not greater than 45 minutes, not greater than 30 minutes, not greater than 30 minutes, or not greater than 15 minutes. Moreover, heating can include sintering silica for a time period in a range including any of the minimum and maximum values noted herein. In a particular example, heating can be performed in a rotary tube with a residence time from 15 minutes to 20 minutes.

In a further aspect, forming the first portion of coating can include forming a sintered ceramic material including silica. In a particular aspect, forming the first portion of the coating can include forming sintered colloidal silica.

In a particular exemplary implementation of forming the first portion of the coating, polycrystalline alpha-alumina particles can be mixed with a colloidal silica suspension. Wetted particles can be heated to 830° C. to 1100° C., particularly 850° C. to 900° C., sintered for 10 to 30 minutes, and then cooled at ambient air. The formed abrasive particles include sintered colloidal silica overlying polycrystalline alpha-alumina particles.

It is notable the forming process disclosed in embodiments herein can allow improved formation of abrasive particles. For instance, the abrasive particles as sintered may include not greater than 30 wt. % of agglomerated abrasive particles for a total weight of the as-sintered abrasive particles, such as not greater than 25 wt. %, not greater than 20 wt. %, not greater than 15 wt. %, not greater than 10 wt. %, not greater than 5 wt. %, not greater than 2 wt. %, not greater than 1 wt. %, not greater than 0.8 wt. %, not greater than 0.5%, not greater than 0.3 wt. %, or not greater than 0.1 wt. % of agglomerated abrasive particles for a total weight of the as-sintered abrasive particles. In particular instances, the as-sintered abrasive particles can consist essentially of loose abrasive particles.

In embodiments, the forming process may not continue to Block 102 so that abrasive particles as illustrated in FIG. 2A can be formed. The abrasive particle 200 illustrated in FIG. 2A, in comparison to the abrasive particle 210 illustrated in FIG. 2B, includes the core 201 that is only coated with the coating 202. In other embodiments, the process can continue to Block 102 to form a second portion of the coating forming abrasive particles similar to the abrasive particle 210 as illustrated in FIG. 2B.

The coating 202 can be in direct contact with the core 201. As illustrated, the coating 202 can be a layer overlying the entire surface of the core 201. In at least one embodiment, the coating 202 may be overlying a majority of the surface of the core 201, and a portion of the core surface may not be covered by the coating 202.

In an embodiment, the abrasive particles 200 can have an average coating coverage of the surface of the core 201 that can facilitate improved property and performance of the abrasive particles. In an aspect, the average coating coverage can be at least 50% of the entire surface of the core, at least 55%, at least 57%, at least 59%, at least 61%, at least 63%, at least 65%, at least 68%, at least 70%, at least 72%, at least 75%, at least 76%, at least 77%, at least 79%, at least 80%, at least 82%, at least 84%, at least 85%, at least 87%, at least 88%, at least 90%, at least 91%, at least 92%, at least 93%, at least 94%, at least 95%, at least 96%, at least 97%, at least 98%, or at least 99% of the entire surface of the core 201. In another aspect, the average coating coverage may be not greater than 100% of the entire surface of the core 201, such as not greater than 99.5%, not greater than 99%, not greater than 98.5%, or not greater than 98% of the entire surface of the core 201. In particular aspects, the average coating coverage can be greater than 85%, such as at least 86%, at least 87%, at least 88%, at least 90%, at least 91%, at least 92%, at least 93%, at least 94%, at least 95%, at least 96%, at least 97%, at least 98%, at least 99%, or at least 99.5% of the entire surface of the core 201.

In a further aspect, the average coating coverage can be in a range including any of the minimum and maximum values noted herein.

The coating coverage can be determined by Energy Dispersive Spectroscopy (EDS) analysis as follows.

Abrasive particles can be placed on a carbon tape on an aluminum SEM stub and then gently pushed flat with a hard surface (i.e., another SEM stub) and then coated with Au/Pd using the Quorum coater for 30 seconds.

Image acquisition of the treated abrasive particles can be conducted by using Merlin™ field emission scanning electron microscopy (FESEM) from Zeiss with suitable imaging parameters and Fast Acquisition in the Bruker Esprit software. A skilled artisan will appreciate coating coverage can be properly determined using equipment equivalent to Merlin™ FESEM from Zeiss and software equivalent to Bruker Esprit may be utilized. The settings of FESEM can include the selection of analytical mode, an accelerating voltage of 7 kV, beam current of up to 400 pA, sufficient to give greater than 5000 counts per seconds (CPS) to the EDS detector, and up to 10 mm working distance.

An image area of an abrasive particle can be collected in the tab of Objects of the Bruker Esprit Software. 3 to 5 spots on a chosen particle can be selected for analysis. The acquisition mode can be set to “Fast”.

Using EDS, elements of the abrasive particles (i.e., the first portion) can be quantified and used as an indication whether a spot of the core is covered by the first portion. For example, elements O, Na, Mg, Al, and Si can be selected from “List Elements” in Bruker Esprit Software and quantified. The quantification method can be set to atomic %. The C, Au and Pd peaks can be ignored. The coating material can be set to “none” in the Sample pulldown.

The quantitative chemical analysis for each spot can be reduced to a binomial (covered or not). In at least one embodiment, Si may be used as an indication of coating coverage for abrasive cores that may be free of Si. In particular, 1 atomic % of Si can be used as the threshold for determining whether the spot is covered by the coating. When a selected spot has greater than 1 atomic % of Si, the spot can be considered covered by the coating. When a selected spot has less than 1 atomic % of Si, the spot can be considered not covered by the coating.

Data can be collected from 15 to 20 different grains and a total of 60 to 100 spectra can be collected for a sample including up to 2.5 kg of abrasive particles. A proportionally increased number of abrasive particles can be analyzed for the data to be representative of a sample of a bigger size. The selected spots should be well dispersed from each other so that the data can be representative of the entire surface of the abrasive particle. For example, the distance between selected spots on a particle of grit 36 should be greater than 200 μm. Regions of the surface where the coating is clearly visible in the acquired image should be avoided for selection of spots for analysis.

A 95% confidence interval (95% CI) can be used on a binomial distribution calculator to calculate the reported confidence intervals. A suitable example can include Binomial Probability Confidence Interval Calculator (version 4.0), which may be available at www.danielsoper.com. In an example of an analysis, when 53 out of 60 spots demonstrate greater than 1 atomic % of Si, the trial number to input to the calculator is 60 and successes 53. At 95% CI, the coverage is within the range of 77% to 95%.

The average coating coverage of a plurality of abrasive particles may be determined by CAV=(PP/PT)×100%, wherein CAV can be the average coating coverage of the plurality of abrasive particles, PP can be the total number of the spots that have greater than 0.1 atomic % of Si, and PT can be the total number of the examined spots of the plurality of abrasive particles.

In another embodiment, for abrasive particles including cores including Si, an element other than Si that is present in the coating may be used as an indication of coating coverage. For example, for abrasive particles including SiC abrasive cores, one or more of O, Na, Mg, and Al may be used for determination of coating coverage.

In a further embodiment, abrasive particles 200 may include a batch of abrasive particles, in which more than 75% of the particles can be fully covered. As used herein, a fully covered particle is intended to mean all of the minimum of at least 3 analyzed spots per particle has greater than 0.1 atomic % of Si, which particle can also be considered as having a coating coverage of 100% of the entire surface of the core. In an aspect, at least 76% of the particles of a batch may be fully covered, such as at least 78%, at least 80%, at least 83%, at least 85%, at least 88%, at least 90%, at least 92%, at least 93%, at least 94%, at least 95%, at least 96%, at least 97%, or at least 98% of abrasive particles of the batch may be fully covered. In another aspect, abrasive particles 200 may include a batch of particles, in which up to 100% of the particles may be fully covered. In a further aspect, not greater than 99.5% of abrasive particles of the batch may be fully covered, such as not greater than 99%, not greater than 98% of abrasive particles of the batch may be fully covered. In a further aspect, abrasive particles may include a batch of abrasive particles, in which the fully covered particles may be in a range including any of the minimum and maximum percentages noted herein. In a further embodiment, a batch of abrasive particles can include at least 500 g of abrasive particles, at least 1 kg of abrasive particles, at least 2 kg of abrasive particles, at least 2.5 kg of abrasive particles, at least 3 kg of abrasive particles, at least 4 kg abrasive particles, or at least 5 kg abrasive particles. A skilled artisan will appreciate, after reading the present disclosure, the size of the batch can be adjusted as needed, and the number of the abrasive particles in a batch should not be limited to the exemplary numbers noted herein. In a further embodiment, abrasive particles 200 can include a plurality of batches, and the average coating coverage of the plurality of batches can be any percentage or in a range including any of the minimum and maximum percentages disclosed in embodiments herein.

In another embodiment, the coating 202 can have a substantially uniform thickness. In one embodiment, thickness of the coating 202 may change along the surface of the core 201.

In another embodiment, abrasive particles 200 may include an average thickness of the coating 202 that can facilitate improved formation and properties of the abrasive particles. For instance, the average thickness of the coating 202 can be at least 10 nm, at least 12 nm, at least 15 nm, at least 18 nm, at least 20 nm, at least 25 nm, at least 28 nm, at least 30 nm, at least 32 nm, at least 35 nm, at least 38 nm, at least 40 nm, at least 43 nm, at least 45 nm, at least 48 nm, at least 50 nm, at least 52 nm, at least 55 nm, at least 58 nm, at least 60 nm, at least 63 nm, at least 68 nm, at least 70 nm, at least 74 nm, at least 76 nm, at least 80 nm, at least 83 nm, at least 86 nm, at least 90 nm, at least 93 nm, at least 95 nm, at least 98 nm, at least 100 nm, at least 105 nm, at least 110 nm, at least 114 nm, at least 116 nm, at least 120 nm, at least 125 nm, at least 130 nm, at least 135 nm, at least 138 nm, at least 140 nm, at least 145 nm, at least 148 nm, at least 149 nm, at least 152 nm, at least 155 nm, at least 158 nm, at least 160 nm, at least 163 nm, at least 165 nm, at least 168 nm, at least 170 nm, at least 172 nm, at least 175 nm, at least 178 nm, at least 180 nm, at least 184 nm, at least 188 nm, at least 190 nm, at least 192 nm, at least 194 nm, at least 196 nm, at least 198 nm, at least 200 nm, at least 203 nm, at least 205 nm, at least 207 nm, at least 210 nm, at least 212 nm, at least 215 nm, at least 217 nm, at least 219 nm, at least 200 nm, at least 202 nm, at least 204 nm, at least 206 nm, at least 208 nm, at least 210 nm, at least 212 nm, at least 213 nm, at least 215 nm, at least 218 nm, at least 220 nm, at least 222 nm, at least 225 nm, at least 228 nm, at least 230 nm, at least 231 nm, at least 234 nm, at least 236 nm, at least 238 nm, at least 240 nm, at least 242 nm, at least 246 nm, at least 248 nm, at least 250 nm, at least 252 nm, at least 254 nm, at least 257 nm, at least 260 nm, at least 263 nm, at least 265 nm, at least 268 nm, at least 270 nm, at least 273 nm, at least 275 nm, at least 277 nm, at least 280 nm, at least 283 nm, at least 285 nm, at least 287 nm, at least 289 nm, at least 290 nm, at least 293 nm, at least 295 nm, at least 300 nm, at least 310 nm, at least 315 nm, at least 320 nm, at least 325 nm, at least 330 nm, at least 335 nm, at least 340 nm, at least 345 nm, at least 350 nm, at least 355 nm, at least 360 nm, at least 365 nm, at least 370 nm, at least 375 nm, at least 380 nm, at least 385 nm, at least 390 nm, at least 395 nm, or at least 400 nm. In another instance, the average thickness of the coating 202 of the abrasive particles 200 may be not greater than 2 microns, not greater than 1 micron, not greater than 900 nm, not greater than 890 nm, not greater than 880 nm, not greater than 870 nm, not greater than 860 nm, not greater than 850 nm, not greater than 840 nm, not greater than 830 nm, not greater than 810 nm, not greater than 800 nm, not greater than 780 nm, not greater than 770 nm, not greater than 760 nm, not greater than 750 nm, not greater than 740 nm, not greater than 730 nm, not greater than 710 nm, not greater than 700 nm, not greater than 690 nm, not greater than 680 nm, not greater than 670 nm, not greater than 660 nm, not greater than 650 nm, not greater than 640 nm, not greater than 630 nm, not greater than 610 nm, not greater than 600 nm, not greater than 590, not greater than 580 nm, not greater than 570 nm, not greater than 560 nm, not greater than 550 nm, not greater than 540 nm, not greater than 530 nm, not greater than 510 nm, not greater than 500 nm, not greater than 490 nm, not greater than 480 nm, not greater than 470 nm, not greater than 460 nm, not greater than 450 nm, not greater than 440 nm, not greater than 430 nm, not greater than 420 nm, not greater than 410 nm, not greater than 400 nm, not greater than 390 nm, not greater than 380 nm, not greater than 370 nm, not greater than 360 nm, not greater than 350 nm, not greater than 340 nm, not greater than 330 nm, not greater than 320 nm, not greater than 310 nm, not greater than 300 nm, not greater than 290 nm, not greater than 280 nm, not greater than 270 nm, not greater than 260 nm, not greater than 250 nm, not greater than 240 nm, not greater than 230 nm, not greater than 220 nm, not greater than 210 nm, not greater than 200 nm, not greater than 190 nm, not greater than 180 nm, not greater than 170 nm, not greater than 160 nm, not greater than 150 nm, not greater than 140 nm, not greater than 130 nm, not greater than 120 nm, not greater than 110 nm, not greater than 100 nm, not greater than 90 nm, not greater than 80 nm, not greater than 70 nm, not greater than 60 nm, or not greater than 50 nm. Moreover, the average thickness of the coating 202 of the abrasive particles 200 can be in a range including any of the minimum and maximum values noted herein. For example, the abrasive particles can include an average thickness of the coating 202 in a range from 50 nm to 2 microns, or in a range from 100 nm to 1 micron or in a range from 100 nm to 500 nm.

In a further embodiment, the abrasive particles 200 can include a particular thickness standard deviation of the coating 202 that can facilitate improved formation of the abrasive particles and improved performance of the abrasive particles. In an aspect, an absolute value of the thickness standard deviation may be not greater than 200% of the average thickness, not greater than 150%, not greater than 100%, not greater than 80%, not greater than 50%, not greater than 49%, not greater than 47%, not greater than 44%, not greater than 42%, not greater than 40%, not greater than 38%, not greater than 36%, not greater than 34%, not greater than 33%, not greater than 31%, not greater than 30%, not greater than 29%, not greater than 27%, not greater than 25%, not greater than 23%, not greater than 21%, not greater than 20%, not greater than 19%, not greater than 18%, not greater than 17%, not greater than 16%, not greater than 14%, not greater than 12%, not greater than 11%, not greater than 10%, not greater than 9%, not greater than 8%, not greater than 7%, not greater than 6%, not greater than 5%, not greater than 4%, not greater than 3%, not greater than 2%, not greater than 1%, not greater than 0.8%, not greater than 0.7%, or not greater than 0.5% of the average thickness of the coating. In another aspect, the abrasive particles can include an absolute value of the thickness standard deviation of at least 0.001% of the average thickness, at least 0.05%, at least 0.08%, at least 0.1%, at least 0.2%, at least 0.3%, at least 0.4%, at least 0.5%, at least 0.7%, at least 0.8%, at least 0.9%, at least 1%, at least 1.2%, at least 1.5%, at least 1.8%, at least 2%, at least 2.2%, at least 2.5%, at least 2.8%, at least 3%, at least 4%, or at least 5% of the average thickness of the coating. Moreover, the abrasive particles can include a thickness standard deviation of the coating having an absolute value in a range including any of the minimum and maximum values noted therein.

In a further aspect, the abrasive particle can include a thickness standard deviation of the coating 202 of at least 1 nm, at least 3 nm, at least 5 nm, at least 7 nm, at least 9 nm, at least 10 nm, at least 13 nm, at least 15 nm, at least 17 nm, at least 19 nm, at least 21 nm, at least 23 nm, at least 25 nm, at least 28 nm, at least 30 nm, at least 32 nm, at least 34 nm, at least 36 nm, at least 39 nm, at least 41 nm, at least 45 nm, at least 46 nm, at least 48 nm, or at least 50 nm, at least 60 nm, at least 70 nm, at least 80 nm, at least 100 nm, at least 110 nm, at least 120 nm, at least at least 130 nm, at least 140 nm, at least 150 nm, at least 160 nm, at least 170 nm, at least 180 nm, at least 190 nm, at least 210 nm, at least 220 nm, or at least 230 nm, at least 240 nm, at least 250 nm, at least 260 nm, at least 270 nm, or at least 280 nm. In another aspect, the thickness standard deviation may be not greater than 500 nm, not greater than 480 nm, not greater than 460 nm, not greater than 420 nm, not greater than 400 nm, not greater than 350 nm, not greater than 320 nm, not greater than 310 nm, not greater than 300 nm, not greater than 280 nm, not greater than 260 nm, not greater than 230 nm, not greater than 210 nm, not greater than 190 nm, not greater than 170 nm, not greater than 150 nm, not greater than 130 nm, not greater than 120 nm, not greater than 110 nm, not greater than 100 nm, not greater than 90 nm, not greater than 80 nm, not greater than 70 nm, not greater than 60 nm, not greater than 50 nm, not greater than 40 nm, not greater than 30 nm, not greater than 20 nm, not greater than 18 nm, not greater than 15 nm, not greater than 12 nm, not greater than 10 nm, or not greater than 5 nm. Moreover, the thickness standard deviation of the coating can be in a range including any of the minimum and maximum values noted herein. In a particular instance, the thickness standard deviation of the coating can be in a range from 10 nm to 400 nm, or in a range from 30 nm to 300 nm, or in a range from 50 nm to 200 nm.

In an embodiment, the coating 202 of the coating can include a ceramic material consisting essentially of silica. In an aspect, the coating 202 can consist essentially of a polycrystalline material including silica. In another aspect, the first coating 202 can be essentially free of an amorphous phase.

In another embodiment, the coating 202 of can include a vitreous material including silica. In an aspect, the coating 202 can include an amorphous phase including silica. In a particular aspect, the coating 202 can include an amorphous phase consisting essentially of silica. In another particular aspect, the coating 202 can include a particular amount of amorphous phase that can facilitate improved formation and property of the abrasive grains 210 and abrasive articles including the abrasive grains 210. For example, at least 1 vol % of the total volume of the coating 202 can be an amorphous phase, such as at least 3 vol %, at least 5 vol %, at least 10 vol %, at least 30 vol %, at least 35 vol %, at least 37 vol %, at least 39 vol %, at least 45 vol %, at least 50 vol %, at least 60 vol %, at least 65%, at least 70 vol %, at least 75 vol %, at least 80 vol %, at least 85 vol %, at least 90 vol %, or at least 95 vol % of the first portion can be an amorphous phase. In a further particular aspect, not greater than 99 vol % of the total volume of the coating 202 may be amorphous phase, such as not greater than 97 vol %, not greater than 95 vol %, not greater than 90 vol %, not greater than 85 vol %, not greater than 80 vol %, not greater than 75 vol %, not greater than 70 vol %, not greater than 65 vol %, not greater 60 vol %, not greater than 50 vol %, not greater than 45 vol %, not greater than 40 vol %, not greater than 33 vol %, or not greater than 31 vol % of the first portion 202 may be amorphous phase. Moreover, the first portion 202 can include amorphous phase in a range including any of the minimum and maximum percentages noted herein.

In another aspect, the coating 202 can include silica in an amorphous phase and in a crystalline phase. In another particular aspect, the coating 202 can include an amorphous phase consisting essentially of silica and a crystalline phase consisting essentially of silica.

In an aspect, the coating 202 can include a crystalline phase of at least 1 vol % of the total volume of the first portion 202, such as at least 3 vol %, at least 5 vol %, at least 10 vol %, at least 20 vol %, at least 30 vol %, at least 35 vol %, at least 37 vol %, at least 39 vol %, at least 45 vol %, at least 50 vol %, at least 60 vol %, at least 65%, at least 70 vol %, at least 75 vol %, at least 80 vol %, at least 85 vol %, at least 90 vol %, or at least 95 vol % of crystalline phase of the first portion. In a further aspect, not greater than 99 vol % of the total volume of the coating 202 may be crystalline phase, such as not greater than 97 vol %, not greater than 95 vol %, not greater than 90 vol %, not greater than 85 vol %, not greater than 80 vol %, not greater than 75 vol %, not greater than 70 vol %, not greater than 65 vol %, not greater 63 vol %, not greater than 61 vol %, not greater than 50 vol %, not greater than 40 vol %, not greater than 33 vol %, or not greater than 20 vol % of the coating 202 may be crystalline phase. Moreover, the coating 202 can include crystalline phase in a range including any of the minimum and maximum percentages noted herein.

In another aspect, the coating 202 can include a particular crystallinity that can facilitate improved formation and property of the abrasive grains 210 and abrasive articles including the abrasive grains 210. Crystallinity can be determined by performing X-ray diffraction (also referred to as “XRD” in this disclosure) analysis on a powder sample of the coating 202 prepared as follows. The first material can be disposed in an alumina crucible and heated in a furnace at sintering temperature noted in embodiments herein for 30 min. Then the crucibles can be taken out of the furnace and left to cool down at ambient temperature (i.e., 20° C. to 25° C.). The solids can be recovered from the crucibles and milled manually, such as using mortar and pestle, to obtain the powder sample of the coating 202. XRD can be acquired in Bragg-Brentano configuration (standard for powder XRD) using a copper X-ray source having Cu K alpha wavelength of 1.54 Angstrom. Identification of crystalline phase can be performed using the EVA Bruker AXS software or another equivalent software, and the ICDD-PDF4+ database (Release 2020). Crystallinity can be determined by Rietveld refinement using the TOPAS 4.2 software from Bruker or another equivalent software following the Corindon Al₂O₃ standard.

In a particular aspect, the coating 202 can include at least 1% crystallinity, at least 3%, at least 5%, least 6%, at least 7%, at least 8%, at least 9%, at least 10%, at least or 11%. In another aspect, the coating 202 may include a percentage crystallinity not greater than 63%, not greater than 62%, not greater than 61%, not greater than 60%, not greater than 58%, not greater than 55%, not greater than 53%, not greater than 51%, not greater than 50%, not greater than 48%, not greater than 46%, not greater than 44%, not greater than 41%, not greater than 40%, not greater than 38%, not greater than 36%, not greater than 34%, not greater than 31%, not greater than 30%, not greater than 28%, not greater than 26%, not greater than 24%, not greater than 22%, not greater than 20%, not greater than 18%, not greater than 16%, not greater than 14%, not greater than 12%, not greater than 10%, not greater than 8%, not greater than 7%, not greater than 5%, not greater than 4, or not greater than 3%. Moreover, the first portion 202 can include crystallinity in a range including any of the minimum and maximum percentages noted herein.

In a further aspect, a majority of coating 202 can be silica. For example, at least 51 wt. % of the coating 202 can be silica, such as at least 52 wt. %, at least 53 wt. %, at least 54 wt. %, at least 55 wt. %, at least 56 wt. %, at least 57 wt. %, at least 58 wt. %, at least 59 wt. %, at least 60 wt. %, at least 61 wt. %, at least 62 wt. %, at least 63 wt. %, at least 64 wt. %, at least 65 wt. %, at least 66 wt. %, at least 67 wt. %, at least 68 wt. %, at least 69 wt. %, at least 70 wt. %, at least 71 wt. %, at least 72 wt. %, at least 73 wt. %, at least 74 wt. %, at least 75 wt. %, at least 76 wt. %, at least 77 wt. %, at least 78 wt. %, at least 79 wt. %, at least 80 wt. %, at least 81 wt. %, at least 82 wt. %, at least 83 wt. %, at least 84 wt. %, at least 85 wt. %, at least 86 wt. %, at least 87 wt. %, at least 88 wt. %, at least 89 wt. %, at least 90 wt. %, at least 91 wt. %, at least 92 wt. %, at least 93 wt. %, at least 94 wt. %, at least 95 wt. %, at least 96 wt. %, at least 97 wt. %, at least 98 wt. %, or at least 99 wt. % of the coating 202 can be silica. In another aspect, the first portion 202 can consist essentially of silica.

In an embodiment, the first portion of the coating can include domains having a particular average domain size that can facilitate improved formation and performance of the abrasive particles.

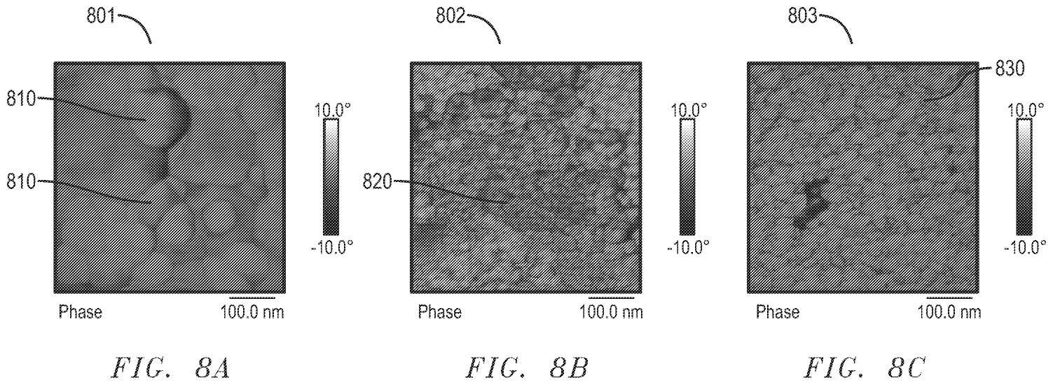

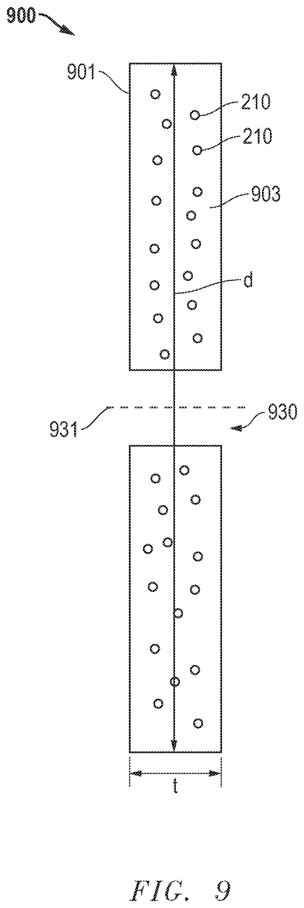

FIGS. 8A to 8C include atomic force microscopic (also referred to as “AFM” in this disclosure) phase images of abrasive particles. FIG. 8A includes an image of the core 801 including crystallites 810. FIG. 8B includes an image of the coating 802 overlying a core (not illustrated), wherein the coating is dried at a temperature of approximately 250° C. FIG. 8C includes an image of the coating 803 according to an embodiment. The coating 803 can be formed by sintering. As illustrated in FIG. 8C, the coating 803 can include domains 830. As illustrated, the coating 803 can have a greater average domain size than the average domain size of domains 820 present in the coating 802.

In an embodiment, the abrasive particles can include an average domain size of the coating of at least 15 nm, at least 16 nm, at least 17 nm, at least 18 nm, at least 19 nm, at least 20 nm, at least 21 nm, at least 22 nm, at least 23 nm, at least 24 nm, at least 25 nm, at least 26 nm, at least 27 nm, or at least 28. In another aspect, the abrasive particles may include an average domain size of the coating of greater than 19 nm or greater than 26 nm. In particular aspect, the abrasive particles can include an average domain size of the coating of not greater than 130 nm, not greater than 126 nm, not greater than 125 nm, not greater than 124 nm, not greater than 122 nm, not greater than 120 nm, not greater than 115 nm, not greater than 110 nm, not greater than 105 nm, not greater than 100 nm, not greater than 90 nm, not greater than 85 nm, not greater than 80 nm, not greater than 75 nm, not greater than 70 nm, not greater than 65 nm, not greater than 60 nm, not greater than 55 nm, not greater than 50 nm, not greater than 45 nm, not greater than 40 nm, not greater than 35 nm, or not greater than 30 nm. Moreover, the first portion of the coating can include an average domain size including any of the minimum and maximum values noted herein. As used herein, average domain size is intended to refer to the average value of the largest dimensions of at least 20 identifiable domains in the phase images of randomly selected abrasive particles.

In an embodiment, the abrasive particles can include a particular standard deviation of the domain size that can facilitate improved formation and performance of the abrasive particles. In an aspect, the standard deviation of the domain size can have an absolute value of not greater than 50% of the average domain size, not greater than 49%, not greater than 48%, not greater than 47%, not greater than 46%, not greater than 45%, not greater than 44%, not greater than 43%, not greater than 42%, not greater than 41%, not greater than 40%, not greater than 39%, not greater than 38%, not greater than 37%, not greater than 36%, not greater than 35%, not greater than 33%, not greater than 31%, not greater than 30%, not greater than 29%, not greater than 27%, not greater than 25%, not greater than 23%, not greater than 21%, not greater than 20%, not greater than 19%, not greater than 17%, not greater than 16%, not greater than 15%, not greater than 49%, not greater than 48%, not greater than 47%, not greater than 46%, not greater than 45%, not greater than 43%, not greater than 42%, not greater than 41%, not greater than 40%, not greater than 39%, not greater than 37%, not greater than 35%, not greater than 33%, not greater than 30%, not greater than 28%, not greater than 26%, not greater than 24%, not greater than 21%, not greater than 19%, not greater than 17%, not greater than 15%, not greater than 13%, not greater than 11%, not greater than 10%, not greater than 9%, not greater than 8%, not greater than 7%, or not greater than 5% of the average domain size of the coating. In another aspect, the abrasive particles can include a standard deviation of the domain size having an absolute value of at least 0.001% of the domain size of the coating, at least 0.01%, at least 0.1%, at least 1%, at least 2%, at least 4%, at least 3%, or at least 5% of the domain size of the coating. Moreover, the abrasive particles can include a standard deviation having an absolute value in a range including any of the minimum and maximum values noted herein.

In another embodiment, the abrasive particles can include a standard deviation having an absolute value of not greater than 65 nm, not greater than 63 nm, not greater than 61 nm, not greater than 60 nm, not greater than 58 nm, not greater than 55 nm, not greater than 53 nm, not greater than 51 nm, not greater than 50 nm, not greater than 49 nm, not greater than 47 nm, not greater than 45 nm, not greater than 43 nm, not greater than 41 nm, not greater than 40 nm, not greater than 38 nm, not greater than 36 nm, not greater than 32 nm, not greater than 30 nm, not greater than 28 nm, not greater than 25 nm, not greater than 23 nm, not greater than 22 nm, not greater than 20 nm, not greater than 19 nm, not greater than 17 nm, not greater than 16 nm, not greater than 15 nm, not greater than 14 nm, not greater than 13 nm, or not greater than 12 nm. In another aspect, the abrasive particles can include a standard deviation of the domain size having an absolute value of at least 0.1 nm, at least 0.3 nm, at least 0.5 nm, at least 1 nm, at least 2 nm, at least 3 nm, at least 4 nm, at least 5 nm, at least 6 nm, at least 7 nm, at least 8 nm, at least 9 nm, at least 10 nm, at least 11 nm, at least 12 nm, at least 13 nm, at least 14 nm, at least 15 nm, at least 16 nm, or at least 17 nm. Moreover, the standard deviation can have an absolute value in a range including any of the minimum and maximum values noted herein.

In an embodiment, the first portion of the coating can include a particular roughness that can facilitate improved formation and performance of the abrasive particles. In an aspect, the first portion of the coating can include an average root-mean-square roughness (Rq). Root-mean-square roughness (Rq) can be determined as follows. AFM scans can be acquired over 500×500 nm² or 2000×2000 nm² of the surface of the abrasive particles 200. Roughness was determined on areas of ca. 200×200 nm² over 5 random areas, typically at center, top-left, top-right, bottom-left and bottom-right of the images. The average value of root-mean-square roughness (Rq) obtained from at least 20 images of randomly selected grains is referred to as average root-mean-square roughness (Rq). In an example, the average root-mean-square roughness (Rq) can be less than 6 nm, such as at most 5.5 nm, at most 5 nm, at most 4.6 nm, at most 4 nm, at most 3.7 nm, at most 3.5 nm, or at most 3 nm. In another example, the average root-mean-square roughness (Rq) can be greater than 0.5 nm, such as greater than 1 nm, at least 1.5 nm, at least 2 nm, at least 2.5 nm, at least 2.8 nm, or at least 3 nm. Moreover, the first portion of the coating can include an average root-mean-square roughness (Rq) in a range including any of the minimum and maximum values noted herein.

Referring to FIG. 1, the process can continue to Block 102, to form a second portion of the coating overlying at least a portion of the core. Forming the second portion can include treating abrasive particles 200 with a second material. In an embodiment, the second material can include a coupling agent, for example, a silicon-containing compound, such as a silane or another organosilicon compound. In particular, the second material can include organosilicon coupling agents that can provide improved binding between a surface having —OH functional groups and organic polymeric materials. For instance, the second material can include organosilanes having amino, alkoxy, alkylalkoxy, alkyltrialkoxy, vinyl, acrylo, methacrylo, mercapto, or other functional groups, or any combination thereof. Particular example of silanes can include aminosilanes including, for instance, bis-aminosilane, aminoalkyltrialkoxysilanes, aminoethyltriethoxysilane, aminopropyltriethoxysilane, phenylaminoalkyltrialkoxysilane, or any combination thereof. Further example of organosilicon compound can include siloxanes, silicone fluids, silsesquioxanes, or the like, or any combination thereof.

In an exemplary implementation, abrasive particles 200 can be wetted with a solution including a silane in a solvent, such as water or ethanol. The concentration of silane can be in a range, for example, from 2 vol % to 6 vol %. In other implementations, spraying in-situ or other methods known in the art may be used to coat abrasive particles 200 with the second material.

Forming the second portion of the coating may further include drying the wetted or otherwise coated abrasive particles 200. Drying may be conducted at a temperature from 20° C. to 180° C. for 10 minutes to up to 36 hours for the second portion the coating.

Referring to FIG. 2B, a cross section of an abrasive particle 210 is illustrated. The abrasive particle 210 includes the core 201 and the coating 205 overlying the core 201. The coating 205 includes the first portion 202 overlying the core 201 and a second portion 203 overlying the first portion 202 and the core 201. The first portion 202 is between the surface of the core 201 and the second portion 203. The second portion 203 can be in direct contact with the first portion 202. In an embodiment, the second portion 203 can overlie the entire surface of the core 201, the entire first portion 202, or both. In one embodiment, the second portion 203 can overlie a majority of the first portion 202. For instance, a portion of the first portion 202 may not be covered by the second portion 203. In one embodiment, a portion of the core surface can be in direct contact with the second portion 203. In a further embodiment, the second portion 203 can bond to the first portion 202 and bond to the core 201.

In an embodiment, the second portion 203 of the coating 205 can include silane or a silane reaction product. The silane reaction product is intended to refer to a silane derivative that may be formed in the process of forming the coating.

In an embodiment, the coating 205 of abrasive particles 210 and the coating 202 of abrasive particles 200 can include silicon in a particular content that can facilitate improved formation and properties of abrasive particles 210 and 200. In an aspect, the content of silicon of abrasive particles 210 and 200 can be determined by Energy Dispersive Spectroscopy and can include an average Energy Dispersive Spectroscopy value. As used herein, an average Energy Dispersive Spectroscopy value of an element is intended to refer to an average of the peak values of that element as shown in the Energy Dispersive Spectroscopy readouts of at least 5 abrasive particles 210 and 200.

In an example, abrasive particles 210 and 200 can include an average Silicon Energy Dispersive Spectroscopy value of at least 0.39, such as at least 0.41, at least 0.43, at least 0.45, at least 0.47, at least 0.48, at least 0.49, at least 0.50, at least 0.51, at least 0.52, at least 0.54, at least 0.55, at least 0.56, at least 0.57, at least 0.59, at least 0.60, at least 0.61, at least 0.62, at least 0.64, at least 0.66, at least 0.67, at least 0.69, at least 0.70, at least 0.72, at least 0.74, at least 0.75, at least 0.77, at least 0.78, at least 0.79, at least 0.81, at least 0.83, at least 0.85, at least 0.87, at least 0.89, at least 0.90, at least 0.92, at least 0.93, at least 0.94, at least 0.95, at least 0.96, at least 0.97, at least 0.99, at least 1.00, at least 1.10, at least 1.15, at least 1.20, at least 1.25, at least 1.30, at least 1.35, at least 1.40, at least 1.45, at least 1.50, at least 1.55, at least 1.60, at least 1.65, at least 1.70, at least 1.75, at least 1.80, at least 1.85, at least 1.90, at least 1.95, at least 2.00, at least 2.10, at least 2.15, at least 2.20, at least 2.25, at least 2.30, at least 2.35, at least 2.40, at least 2.45, at least 2.50, at least 2.55, at least 2.60, at least 2.65, at least 2.70, at least 2.75, at least 2.80, at least 2.85, at least 2.90, at least 2.95, or at least 3.00. In another example, the average Silicon Energy Dispersive Spectroscopy value may be not greater than 6.00, not greater than 5.95, not greater than 5.90, not greater than 5.85, not greater than 5.80, not greater than 5.75, not greater than 5.60, not greater than 5.50, not greater than 5.45, not greater than 5.35, not greater than 5.20, not greater than 5.10, not greater than 5.00, not greater than 4.95, not greater than 4.90, not greater than 4.85, not greater than 4.80, not greater than 4.75, not greater than 4.60, not greater than 4.50, not greater than 4.45, not greater than 4.35, not greater than 4.20, not greater than 4.10, not greater than 4.00, not greater than 3.95, not greater than 3.90, not greater than 3.85, not greater than 3.80, not greater than 3.75, not greater than 3.60, not greater than 3.50, not greater than 3.45, not greater than 3.35, not greater than 3.20, or not greater than 3.10. Moreover, the abrasive particles 210 and 200 can include an average Silicon Energy Dispersive Spectroscopy value in a range including any of the minimum and maximum values noted herein.

In a further embodiment, the core 201 can include a ceramic material including an element forming a cation of the ceramic material, and the abrasive particles 210 and 200 can include an average Energy Dispersive Spectroscopy value of the cation (also referred to as “EDS_{Cation}”). Abrasive particles 210 and 200 may further include a particular average Silicon/Cation Energy Dispersive Spectroscopy Percentage that can facilitate improved formation and properties of abrasive particles 210 and 200. As used herein, average Silicon/Cation Energy Dispersive Spectroscopy Percentage is determined by the formula, [EDS_{Si}/EDS_{Cation}]×100%, wherein EDS_{Si} is the average Silicon Energy Dispersive Spectroscopy value.

For example, the average Silicon/Cation Energy Dispersive Spectroscopy Percentage can be at least 0.87%, such as at least 0.9%, at least 1.0%, at least 1.2%, at least 1.5%, at least 1.7%, at least 1.9%, at least 2.0%, at least 2.1%, at least 2.2%, at least 2.4%, at least 2.7%, at least 2.9%, at least 3.0%, at least 3.1%, at least 3.3%, at least 3.5%, at least 3.7%, at least 3.9%, at least 4.1%, at least 4.3%, at least 4.5%, at least 4.7%, at least 4.9%, at least 5.0%, at least 5.1%, at least 5.2%, at least 5.4%, at least 5.6%, at least 5.8%, at least 6.0%, at least 6.1%, at least 6.3%, at least 6.5%, at least 6.7%, at least 6.9%, at least 7.0%, or at least 7.1%. In another example, the average Silicon/Cation Energy Dispersive Spectroscopy Percentage can be not greater than 10.0%, not greater than 9.9%, not greater than 9.7%, not greater than 9.5%, not greater than 9.3%, not greater than 9.1%, not greater than 9.0%, not greater than 8.9%, not greater than 8.7%, not greater than 8.5%, not greater than 8.4%, not greater than 8.3%, not greater than 8.1%, not greater than 8.0%, not greater than 7.9%, not greater than 7.8%, not greater than 7.6%, not greater than 7.5%, not greater than 7.4%, not greater than 7.3%, or not greater than 7.2%. Moreover, abrasive particles 210 and 200 can include an average Silicon/Cation Energy Dispersive Spectroscopy Percentage in a range including any of the minimum and maximum percentages noted herein.

In an aspect, the element forming the cation can include aluminum, zirconium, magnesium, or a combination thereof. In a particular aspect, the element forming the cation can consist of aluminum. In another particular aspect, abrasive particles 210 and 200 can include an average Silicon/Aluminum Energy Dispersive Spectroscopy Percentage including any of the average Silicon/Cation Energy Dispersive Spectroscopy Percentages noted herein.

In an embodiment, abrasive particles 210 and 200 can include an average Energy Dispersive Spectroscopy value of an element selected from the group consisting of alkali metal and alkaline earth metal of not greater than 2.0, such as not greater than 1.9, not greater than 1.8, not greater than 1.7, not greater than 1.6, not greater than 1.5, not greater than 1.4, not greater than 1.3, not greater than 1.2, not greater than 1.1, not greater than 1.0, not greater than 0.9, not greater than 0.8, not greater than 0.7, or not greater than 0.6. In a particular embodiment, the coating 205 can be essentially free of an element selected from alkali and alkaline earth metal or any combination thereof.

In an aspect, abrasive particles 210 and 200 can include an average Sodium Energy Dispersive Spectroscopy value of not greater than 1, such as not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01. In another aspect, abrasive particles 210 can include a ratio of average Silicon Energy Dispersive Spectroscopy Value to average Sodium Energy Dispersive Spectroscopy Value (also referred to as “Silicon/Sodium Energy Dispersive Spectroscopy ratio”) of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100. In a particular aspect, the coating 205 can be essentially free of sodium.

In a further aspect, abrasive particles 210 and 200 may include an average Potassium Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01. In a further aspect, abrasive particles 210 and 200 can include a ratio of average Silicon Energy Dispersive Spectroscopy Value to average Potassium Energy Dispersive Spectroscopy Value (also referred to as “Silicon/Potassium Energy Dispersive Spectroscopy ratio”) of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100. In a particular aspect, the coating 205 can be essentially free of potassium.

In an aspect, abrasive particles 210 and 200 can include an average Calcium Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01. In another aspect, abrasive particles 210 can include a ratio of average Silicon Energy Dispersive Spectroscopy value to average Calcium Energy Dispersive Spectroscopy Vale (also referred to as “Silica/Calcium Energy Dispersive Spectroscopy ratio”) of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100. In a particular aspect, the coating 205 and 202 can be essentially free of calcium.

In an aspect, abrasive particles 210 and 200 can include an average Magnesium Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01. In another aspect, abrasive particles 210 and 200 can include a ratio of average Silicon Energy Dispersive Spectroscopy Value to average Magnesium Energy Dispersive Spectroscopy Value (also referred to as “Silica/Magnesium Energy Dispersive Spectroscopy ratio”) of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100. In a particular aspect, the coating 205 can be essentially free of magnesium.

In an aspect, abrasive particles 210 and 200 may include an average Barium Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01. In another aspect, abrasive particles 210 may include a ratio of average Silicon Energy Dispersive Spectroscopy Value to average Barium Energy Dispersive Spectroscopy Value (also referred to as “Silicon/Barium Energy Dispersive Spectroscopy ratio”) of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100. In a particular aspect, the coating 205 and 202 can be essentially free of barium.

In an embodiment, abrasive particles 210 and 201 may include an average Boron Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01. In a further embodiment, abrasive particles 210 and 201 may include a ratio of average Silicon Energy Dispersive Spectroscopy Value to average Boron Energy Dispersive Spectroscopy Value (also referred to as “Silicon/Boron Energy Dispersive Spectroscopy ratio”) of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100. In a particular embodiment, the coating 205 and 202 can be essentially free of boron.

In an embodiment, abrasive particles 210 and 201 may include an average Energy Dispersive Spectroscopy Value of an element selected from transition metal of not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01. In a further embodiment, abrasive particles 210 and 201 may include a ratio of average Silicon Energy Dispersive Spectroscopy Value to average Energy Dispersive Spectroscopy Value of transition metal (also referred to as “Silicon/TM Energy Dispersive Spectroscopy ratio”) of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100. In a particular embodiment, the coating 205 and 202 can be essentially free of an element selected from transitional metal or any combination thereof. For example, the coating 205 can be essentially free of iron, cobalt, nickel, boron, aluminum, or any combination thereof.

In an embodiment, abrasive particles 210 and 201 can include a particular average content of the coating 205 or 202 that can facilitate improved formation and properties of abrasive particle 210 or 201. For example, abrasive particle 210 or 201 can include an average content of the coating 205 of at least 0.01 wt. % for the weight of the core 201, such as at least 0.02 wt. %, at least 0.03 wt. %, at least 0.04 wt. %, at least 0.05 wt. %, at least 0.06 wt. %, at least 0.07 wt. %, at least 0.08 wt. %, at least 0.09 wt. %, at least 0.1 wt. %, at least 0.15 wt. %, at least 0.16 wt. %, at least 0.17 wt. %, at least 0.18 wt. %, at least 0.19 wt. %, at least 0.2 wt. %, at least 0.25 wt. %, at least 0.26 wt. %, at least 0.27 wt. %, at least 0.28 wt. %, at least 0.29 wt. %, or at least 0.3 wt. % for a weight of the core 201. As used herein, an average content of coating 205 or 202 can be an average of the coating contents of at least 5 abrasive particles 210 or 201. In another instance, abrasive particles 210 or 201 may include an average content of the coating 205 or 202 of not greater than 1 wt. % for the weight of the core 201, not greater than 0.9 wt. %, not greater than 0.8 wt. %, not greater than 0.7 wt. %, not greater than 0.6 wt. %, not greater than 0.55 wt. %, not greater than 0.5 wt. %, not greater than 0.48 wt. %, not greater than 0.46 wt. %, not greater than 0.45 wt. %, not greater than 0.43 wt. %, not greater than 0.42 wt. %, not greater than 0.41 wt. %, not greater than 0.4 wt. %, not greater than 0.38 wt. %, not greater than 0.37 wt. %, not greater than 0.36 wt. %, not greater than 0.35 wt. %, or not greater than 0.34 wt. % for the weight of the core 201. Moreover, abrasive particles 210 can include an average content of coating 205 in a range including any of the minimum and maximum percentages noted herein.

In an embodiment, abrasive particles 210 can include a particular average thickness of coating 205 that can facilitate improved formation and properties of abrasive particle 210. For example, abrasive particle 210 may include an average thickness of coating 205 of not greater than 10 microns, not greater than 9 microns, not greater than 8 microns, not greater than 7 microns, not greater than 6 microns, not greater than 5 microns, not greater than 4 microns, not greater than 3 microns, not greater than 2 microns, not greater than 1 microns, not greater than 0.9 microns, not greater than 0.8 microns, not greater than 0.7 microns, not greater than 0.6 microns, not greater than 0.5 microns, not greater than 0.4 microns, not greater than 0.3 microns, or not greater than 0.2 microns. In another example, abrasive particle 210 can include an average thickness of coating 205 of at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16 microns, at least 0.17 microns, at least 0.18 microns, at least 0.19 microns, at least 0.20 microns, at least 0.21 microns, at least 0.22 microns, at least 0.24 microns, at least 0.26 microns, at least 0.28 microns, at least 0.29 microns, at least 0.30 microns, or at least 0.31 microns. Moreover, abrasive particles 210 can include an average thickness of coating 205 in a range including any of the minimum and maximum percentages noted herein. As used herein, an average thickness of coating 205 can refer to an average of thickness of coating 205 of at least 5 abrasive particles 210.

In an embodiment, abrasive particles 210 or 201 can include a particular ratio of an average thickness of coating 205 or 202 to an average particle size of core 201, respectively, that can facilitate improved formation and properties of abrasive particle 210. For example, the ratio can be less than 1, such as not greater than 0.9, not greater than 0.7, not greater than 0.5, not greater than 0.4, not greater than 0.2, not greater than 0.1, not greater than 0.08, not greater than 0.06, not greater than 0.05, not greater than 0.03, not greater than 0.02, not greater than 0.01, not greater than 0.009, not greater than 0.008, not greater than 0.007, not greater than 0.006, not greater than 0.005, not greater than 0.004, not greater than 0.003, not greater than 0.002, or not greater than 0.1. In another instance, the ratio of an average thickness of coating 205 or 202 to an average particle size of core 201 can be at least 0.0005, at least 0.0007, at least 0.0009, at least 0.001, at least 0.002, at least 0.003, at least 0.004, at least 0.005, at least 0.006, at least 0.007, at least 0.008, at least 0.009, at least 0.01, at least 0.02, or at least 0.03. Moreover, the ratio of an average thickness of coating 205 or 202 to an average particle size of core 201 can be in a range including any of the minimum and maximum percentages noted herein. As used herein, the average particle size of core 201 is intended to refer to D₅₀ of core 201.

In an embodiment, abrasive particles 210 and 201 can include an average particle size (i.e., D₅₀) of at least 10 microns, at least 30 microns, at least 40 microns, at least 50 microns, at least 60 microns, at least 70 microns, at least 80 microns, at least 90 microns, at least 100 microns, at least 120 microns, at least 140 microns, at least 150 microns, at least 170 microns, at least 180 microns, at least 200 microns, at least 210 microns, at least 230 microns, at least 250 microns, at least 260 microns, at least 270 microns, at least 290 microns, at least 300 microns, at least 320 microns, at least 340 microns, at least 350 microns, at least 360 microns, at least 380 microns, at least 400 microns, at least 420 microns, at least 430 microns, at least 440 microns, at least 450 microns, at least 460 microns, at least 470 microns, at least 490 microns, or at least 500 microns. In another embodiment, abrasive particles 210 and 201 may include an average particle size of not greater than 3 mm, such as not greater than 2 mm, not greater than 1.8 mm, not greater than 1.6 mm, not greater than 1.5 mm, not greater than 1.2 mm, not greater than 1 mm, not greater than 900 microns, not greater than 850 microns, not greater than 830 microns, not greater than 800 microns, not greater than 750 microns, not greater than 700 microns, not greater than 650 microns, not greater than 600 microns, not greater than 550 microns, not greater than 500 microns, not greater than 450 microns, or not greater than 400 microns. Moreover, abrasive particles 210 and 201 can include an average particle size in a range including any of the minimum and maximum values noted herein.

In an embodiment, coating 205 can include a polycrystalline material. In an aspect, a majority of coating 205 can be polycrystalline. For example, at least 51 vol % of a total volume of coating 205 can be polycrystalline, such as at least 52 vol %, at least 53 vol %, at least 54 vol %, at least 55 vol %, at least 56 vol %, at least 57 vol %, at least 58 vol %, at least 59 vol %, at least 60 vol %, at least 61 vol %, at least 62 vol %, at least 63 vol %, at least 64 vol %, at least 65 vol %, at least 66 vol %, at least 67 vol %, at least 68 vol %, at least 69 vol %, at least 70 vol %, at least 71 vol %, at least 72 vol %, at least 73 vol %, at least 74 vol %, at least 75 vol %, at least 76 vol %, at least 77 vol %, at least 78 vol %, at least 79 vol %, at least 80 vol %, at least 81 vol %, at least 82 vol %, at least 83 vol %, at least 84 vol %, at least 85 vol %, at least 86 vol %, at least 87 vol %, at least 88 vol %, at least 89 vol %, at least 90 vol %, at least 91 vol %, at least 92 vol %, at least 93 vol %, at least 94 vol %, at least 95 vol %, at least 96 vol %, at least 97 vol %, at least 98 vol %, or at least 99 vol % of the total volume of coating 205 can be polycrystalline. In a particular aspect, coating 205 consist essentially of a polycrystalline material. In another particular aspect, coating 205 can be essentially free of an amorphous phase.

In a particular embodiment, a majority of coating 205 can be silica. For instance, at least 51 wt. % of a total weight of coating 205 can be silica, such as at least 52 wt. %, at least 53 wt. %, at least 54 wt. %, at least 55 wt. %, at least 56 wt. %, at least 57 wt. %, at least 58 wt. %, at least 59 wt. %, at least 60 wt. %, at least 61 wt. %, at least 62 wt. %, at least 63 wt. %, at least 64 wt. %, at least 65 wt. %, at least 66 wt. %, at least 67 wt. %, at least 68 wt. %, at least 69 wt. %, at least 70 wt. %, at least 71 wt. %, at least 72 wt. %, at least 73 wt. %, at least 74 wt. %, at least 75 wt. %, at least 76 wt. %, at least 77 wt. %, at least 78 wt. %, at least 79 wt. %, at least 80 wt. %, at least 81 wt. %, at least 82 wt. %, at least 83 wt. %, at least 84 wt. %, at least 85 wt. %, at least 86 wt. %, at least 87 wt. %, at least 88 wt. %, at least 89 wt. %, at least 90 wt. %, at least 91 wt. %, at least 92 wt. %, at least 93 wt. %, at least 94 wt. %, or at least 95 wt. % of a total weight of coating 205 can be silica. In a particular aspect, coating 205 can consist essentially of silica.

In a further embodiment, coating 205 can include a polycrystalline material including silica grains having a particular average crystallite size that can facilitate improved properties of abrasive grains 210. For instance, the silica grains can have an average crystallite size of at least 0.01 microns, at least, at least 0.02 microns, at least 0.03 microns, at least 0.04 microns, at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16, at least 0.17 microns, at least 0.18 microns, at least 0.19 microns, at least 0.2 microns, at least 0.3 microns, at least 0.4 microns, at least 0.5 microns, at least 0.6 microns, at least 0.7 microns, at least 0.8 microns, at least 0.9 microns, at least 1 micron, at least 1.2 microns, at least 1.4 microns, at least 1.6 microns, at least 1.8 microns, at least 2 microns, at least 2.3 microns, at least 2.6 microns, at least 2.8 microns, at least 3 microns, at least 3.2 microns, at least 3.4 microns, at least 3.6 microns, at least 3.8 microns, at least 4 microns, at least 4.2 microns, at least 4.5 microns, at least 4.8, at least 5 microns, at least 5.2 microns, at least 5.4 microns, at least 5.5 microns, at least 5.7 microns, at least 6 microns, at least 6.2 microns, at least 6.3 microns, at least 6.5 microns, at least 6.7 microns, at least 6.8 microns, at least 7 microns, at least 7.2, at least 7.4 microns, at least 7.5 microns, at least 7.8 microns, at least 8 microns, at least 8.1 microns, at least 8.3 microns, at least 8.5 microns, at least 8.6 microns, at least 8.7 microns, at least 8.9 microns, at least 9, at least 9.1 microns, at least 9.3 microns, at least 9.4 microns, at least 9.6 microns, at least 9.8 microns, or at least 10 microns. In another instance, the silica grains may have an average crystallite size of not greater than 10 microns, not greater than 9.8 microns, not greater than 9.6 microns, not greater than 9.4 microns, not greater than 9.2 microns, not greater than 9 microns, not greater than 8.7 microns, not greater than 8.5 microns, not greater than 8.3 microns, not greater than 8.1 microns, not greater than 8 microns, not greater than 7.8 microns, not greater than 7.6 microns, not greater than 7.4 microns, not greater than 7.2 microns, not greater than 7 microns, not greater than 6.8 microns, not greater than 6.6 microns, not greater than 6.4 microns, not greater than 6.3 microns, not greater than 6.2 microns, not greater than 6 microns, not greater than 5.8 microns, not greater than 5.6 microns, not greater than 5.4 microns, not greater than 5.3 microns, not greater than 5 microns, not greater than 4.8 microns, not greater than 4.6 microns, not greater than 4.4 microns, not greater than 4.2 microns, not greater than 4 microns, not greater than 3.8 microns, not greater than 3.6 microns, not greater than 3.4 microns, not greater than 3.2 microns, not greater than 2.9 microns, not greater than 2.8 microns, not greater than 2.6 microns, not greater than 2.4 microns, not greater than 2.2 microns, not greater than 2 microns, not greater than 1.8 microns, not greater than 1.6 microns, not greater than 1.4 microns, not greater than 1.2 microns, not greater than 1 microns, not greater than 0.9 microns, not greater than 0.8 microns, not greater than 0.7 microns, not greater than 0.6 microns, not greater than 0.5 microns, not greater than 0.4 microns, not greater than 0.3 microns, not greater than 0.2 microns, not greater than 0.1 microns, not greater than 0.09 microns, not greater than 0.08 microns, not greater than 0.07 microns, not greater than 0.06 microns, not greater than 0.05 microns, not greater than 0.04 microns, not greater than 0.03 microns, not greater than 0.02 microns, or not greater than 0.01 microns. Moreover, the coating 250 can include silica grains having an average crystallite size in a range including any of the minimum and maximum values noted herein.

In a further embodiment, first portion 202 of coating 205 can consist essentially of silica grains. In another embodiment, the majority of coating 205 can consist essentially of silica grains. In at least one embodiment, coating 205 can consist essentially of silica grains.

It is notable the abrasive particles of embodiments herein can have improved features, property, and/or performance compared to corresponding conventional abrasive particles. As used herein, corresponding conventional abrasive particles are intended to refer to abrasive particles that have the same core and coating to the abrasive particles of embodiments herein except the coating of the conventional abrasive particles is formed using a process different from the abrasive particles of embodiments herein. Such improved features of the abrasive particles can include morphology, coating coverage, average thickness of the coating, uniformity of the thickness of the coating, such as standard deviation of the coating thickness, average domain size of the coating, standard deviation of the domain size of the coating, or any combination thereof. In particular, the abrasive particles of embodiments herein have a sample size that is statistically relevant, and the improved features, property, and performance are described with respect to all the samples of the abrasive particles. For example, the abrasive particles can at least 1 kg of abrasive particles, at least 2 kg of abrasive particles, at least 4 kg of abrasive particles, at least 5 kg of abrasive particles, at least 7 kg of abrasive particles, at least 8 kg of abrasive particles, at least 10 kg of abrasive particles, at least 20 kg of abrasive particles, at least 30 kg of abrasive particles, at least 50 kg of abrasive particles, at least 100 kg of abrasive particles, at least 250 kg, at least 500 kg, or at least 1 ton of abrasive particles. In another example, the abrasive particles can make up a significant percentage of abrasive particles from a fixed abrasive article. In still another example, the at least 100 abrasive particles, at least 500 abrasive particles, at least 1000 abrasive particles, at least 2000 abrasive particles, at least 5000 abrasive particles, at least 8000 abrasive particles, at least 10000 abrasive particles, or at least 500000 abrasive particles.

It is also notable that variables and parameters of the process of embodiments herein are controlled and/or adapted to facilitate formation of improved coating property and abrasive particles having the improved features, property, and performance. The process of embodiments herein can facilitate formation of abrasive particles having improved quality, compared to corresponding conventional abrasive particles. For example, the sintering conditions, silica concentrations, mixing conditions, and/or other process features as noted in embodiments herein can help reduce formation of agglomerates of abrasive particles and prevent deterioration of core materials and formation of the improved coating. The abrasive particles can include coating that can be conformal and uniform. The improved low average thickness of the coating can help reduce formation of cracks in the sintered coating.

In an embodiment, the abrasive particles comprise an end-of-life Specific Grinding Energy (SGE) value of at least 1500 g, such as at least 1600 g, at least 1700 g, at least 1800 g, at least 1900 g, at least 2000 g, or at least 2100 g. In another embodiment, the abrasive particles can include an end-of-life SGE value of at least 5% better than a plurality of corresponding conventional abrasive particles, at least 10% better, at least 15% better, at least 20% better, at least 25% better, at least 30% better, at least 35% better, or at least 40% better than a plurality of corresponding conventional abrasive particles.

In an embodiment, the plurality of abrasive particles can include a Coating Uniformity Factor at least 5% better than a plurality of corresponding conventional abrasive particles, such as at least 8% better, at least 10% better, at least 12% better, at least 15% better, at least 18% better, at least 20% better, at least 22% better, at least 24% better, at least 25% better, at least 28% better, at least 30% better, at least 32% better, at least 35% better, at least 36% better, at least 38% better, or at least 40% better than a plurality of corresponding conventional abrasive particles.

In another embodiment, the abrasive particles can include a moisture absorption rate of at least 5% better than a plurality of corresponding conventional abrasive particles, at least 8% better, at least 10% better, at least 12% better, at least 15% better, at least 18% better, at least 20% better, at least 22% better, at least 24% better, at least 25% better, at least 28% better, at least 30% better, at least 32% better, at least 35% better, at least 36% better, at least 38% better, or at least 40% better than a plurality of corresponding conventional abrasive particles.

In a further embodiment, the abrasive particles 201 or 210 can include an Anti-aging Factor of at least 5% better than a plurality of corresponding conventional abrasive particles, at least 8% better, at least 10% better, at least 12% better, at least 15% better, at least 18% better, at least 20% better, at least 22% better, at least 24% better, at least 25% better, at least 28% better, at least 30% better, at least 32% better, at least 35% better, at least 36% better, at least 38% better, or at least 40% better than a plurality of corresponding conventional abrasive particles.

In a further embodiment, the abrasive particles 200 or 210 can include an Adhesion Value of at least 5% better than a plurality of corresponding conventional abrasive particles, at least 8% better, at least 10% better, at least 12% better, at least 15% better, at least 18% better, at least 20% better, at least 22% better, at least 24% better, at least 25% better, at least 28% better, at least 30% better, at least 32% better, at least 35% better, at least 36% better, at least 38% better, or at least 40% better than a plurality of corresponding conventional abrasive particles.

In an embodiment, the abrasive particles 200 or 210 can include the coating 202 or 205 including a particular average total content of silica (SiO₂) that can facilitate improved performance and/or property of abrasive particles 200 and 210 and/or formation of abrasive articles for a total weight of the abrasive articles. In an aspect, the average total content of SiO₂ in the coating may be at least 200 ppm relative to the total weight of the abrasive particles 200 or 210, such as at least 220 ppm, at least 240 ppm, at least 250 ppm, at least 280 ppm, at least 300 ppm, at least 320 ppm, at least 340 ppm, at least 350 ppm, at least 380 ppm, at least 400 ppm, at least 420 ppm, at least 440 ppm, at least 450 ppm, at least 480 ppm, at least 500 ppm, at least 500 ppm, at least 520 ppm, at least 540 ppm, at least 550 ppm, at least 580 ppm, at least 600 ppm, at least 620 ppm, at least 640 ppm, at least 650 ppm, at least 680 ppm, at least 700 ppm, at least 720 ppm, at least 740 ppm, at least 750 ppm, at least 780 ppm, at least 800 ppm, at least 820 ppm, at least 840 ppm, at least 850 ppm, at least 880 ppm, at least 820 ppm, at least 840 ppm, at least 850 ppm, at least 880 ppm, or at least 900 ppm. In another aspect, the coating may include SiO₂ in an average total content of less than 5000 ppm for a total weight of the abrasive particles, such as at most 4700 ppm, at most 4200 ppm, at most 3900 ppm, at most 3500 ppm, at most 3000 ppm, at most 2700 ppm, at most 2400 ppm, at most 2000 ppm, at most 1700 ppm, at most 1500 ppm, at most 1200 ppm, at most 1000 ppm, at most 980 ppm, at most 960 ppm, at most 940 ppm, at most 910 ppm at most 890 ppm, at most 870 ppm, at most 860 ppm, at most 840 ppm, at most 830 ppm, at most 820 ppm, at most 800 ppm, at most 770 ppm, at most 750 ppm, at most 730 ppm, at most 710 ppm, at most 690 ppm, at most 670 ppm, at most 650 ppm, at most 630 ppm, at most 610 ppm, at most 600 ppm, at most 580 ppm, at most 560 ppm, at most 530 ppm, at most 500 ppm, at most 480 ppm, at most 430 ppm, at most 400 ppm, or at most 390 ppm. In a further aspect, the abrasive particles 200 or 210 may include the coating 202 or 205 including an average total content of SiO₂ in a range including any of the minimum and maximum values noted herein. The average total content of SiO₂ can be determined as follows. Abrasive particles 200 or 210 can be weighed and directly treated with excess hydrofluoric acid (HF) to dissolve SiO₂. Abrasive cores can be removed, and the aqueous solution of digested SiO₂ can be analyzed by Inductively Coupled Plasma (hereinafter “ICP”) to determine the total content of SiO₂ in the coating of the abrasive particles 200 or 210. The average total content can be obtained by dividing the total content of SiO₂ by the weight of the abrasive particles 200 or 210.

In an embodiment, abrasive particles 200 or 210 can include the coating 202 or 205 including loose silica (SiO₂), friable SiO₂, bonded SiO₂, or any combination thereof. As used herein, loose SiO₂ is intended to refer to SiO₂ that dissociates from abrasive particles 200 or 210 in distilled water without intentionally shaking the mixture of abrasive particles and distilled water. In a particular embodiment, abrasive particles 200 or 210 may include a particular average content of loose silica (SiO₂) in the coating 202 or 205 for a total weight of the abrasive particles. The average content of loose SiO₂ can be determined as follows. Abrasive particles 200 or 210 can be weighed and put in distilled water without particular shaking or mixing. The aqueous solution can be recovered after sieving to remove abrasive cores and analyzed by ICP after addition of HF to determine the content of loose silica. The average content of loose silica can be determined by dividing the content of loose silica by the weight of the abrasive particles. In an embodiment, abrasive particles 200 or 210 may include an average particular average content of loose SiO₂ in the coating 202 or 205 that can facilitate formation of improved abrasive particles 200 or 210 and/or abrasive articles. In an aspect, abrasive particles 200 or 210 can include loose SiO₂ in an average content of less than 500 ppm for a total weight of the abrasive particles, such as at most 450 ppm, at most 430 ppm, at most 410 ppm, at most 390 ppm, at most 370 ppm, at most 350 ppm, at most 330 ppm, at most 310 ppm, at most 290 ppm, at most 270 ppm, at most 250 ppm, at most 230 ppm, at most 210 ppm, at most 200 ppm, at most 180 ppm, at most 160 ppm, at most 150 ppm, at most 130 ppm, at most 110 ppm, at most 100 ppm, at most 90 ppm, at most 80 ppm, at most 70 ppm, at most 60 ppm, or at most 50 ppm. In certain aspect, abrasive particles 200 or 210 can include coating 202 or 205 including loose SiO₂ in an average content of at least 10 ppm for a total weight of the abrasive particles, such as at least 13 ppm, at least 15 ppm, at least 18 ppm, at least 20 ppm, at least 22 ppm, at least 25 ppm, at least 28 ppm, at least 30 ppm, at least 33 ppm, at least 35 ppm, at least 37 ppm, at least 40 ppm, at least 43 ppm, at least 46 ppm, at least 48 ppm, or at least 50 ppm for a total weight of the abrasive particles. In a further aspect, the abrasive particles 200 or 210 may include a coating including an average content of loose SiO₂ in a range including any of the minimum and maximum values noted herein.

In an embodiment, loose silica may make up a particular content of the total silica (SiO₂) in the coating 202 or 205 that can facilitate improved performance and/or property of the abrasive particles and the abrasive articles. The relative content of the loose silica to the total content of silica may be based on the weight percentages of the loose silica relative to the weight percentage of the total silica. The weight percentage of both the loose silica and total silica is relative to the total weight of the abrasive particles. In an aspect, at most 49% of the total SiO₂ in the coating can be loose SiO₂, such as at most 45%, at most 42%, at most 40%, at most 38%, at most 36%, at most 34%, at most 32%, at most 30%, at most 29%, at most 25%, at most 22%, at most 20%, at most 18%, at most 16%, at most 14%, at most 12% of the total SiO₂ may be loose SiO₂. In another aspect, the coating can include loose SiO₂ of at least 1% out of the total SiO₂, such as at least 2%, at least 3%, at least 4%, at least 5%, at least 7%, at least 8%, at least 9%, at least 10%, at least 11%, or at least 12% of loose SiO₂ out of the total SiO₂. In a further aspect, the coating 202 or 205 can include loose SiO₂ out of the total silica in a range including any of the minimum and maximum percentages noted herein.

In a further embodiment, abrasive particles 200 or 210 may include a particular average content of friable SiO₂ in the coating 202 or 205 that can facilitate formation of improved abrasive particles 200 or 210 and/or abrasive articles. As used herein, friable SiO₂ is intended to refer to SiO₂ that dissociates from abrasive particles in distilled water due to agitation by vortex mixing for a minute after loose SiO₂ is removed. The average content of friable SiO₂ can be determined as follows. After loose SiO₂ is removed as described in this disclosure, abrasive particles can be agitated in distilled water for 1 minute by vortex mixing. The solution can be recovered by removing abrasive particles by sieving and analyzed by ICP after addition of HF determine the content of friable silica. The average content of friable silica can be determined by dividing the content of friable silica by the weight of the abrasive particles. In an aspect, abrasive particles 200 or 210 can include a coating including friable SiO₂ in an average content of at most 1000 ppm for a total weight of the abrasive particles, such as at most 900 ppm, at most 850 ppm, at most 800 ppm, at most 780 ppm, at most 750 ppm, at most 730 ppm, at most 710 ppm, at most 690 ppm, at most 670 ppm, at most 650 ppm, at most 630 ppm, at most 610 ppm, at most 590 ppm, at most 570 ppm, at most 550 ppm, at most 530 ppm, at most 500 ppm, such as at most 450 ppm, at most 430 ppm, at most 410 ppm, at most 390 ppm, at most 370 ppm, at most 350 ppm, at most 330 ppm, at most 310 ppm, at most 290 ppm, at most 270 ppm, at most 250 ppm, at most 230 ppm, at most 210 ppm, at most 200 ppm, at most 180 ppm, at most 160 ppm, at most 150 ppm, at most 130 ppm, at most 110 ppm, at most 100 ppm, at most 90 ppm, at most 80 ppm, at most 75 ppm, or at most 70 ppm. In certain aspect, abrasive particles 200 or 210 can include a coating including friable SiO₂ in an average content of at least 10 ppm for a total weight of the abrasive particles, such as at least 13 ppm, at least 15 ppm, at least 18 ppm, at least 20 ppm, at least 22 ppm, at least 25 ppm, at least 28 ppm, at least 30 ppm, at least 33 ppm, at least 35 ppm, at least 37 ppm, at least 40 ppm, at least 43 ppm, at least 46 ppm, at least 48 ppm, or at least 50 ppm. In a further aspect, the abrasive particles 200 or 210 may include a coating including an average content of friable SiO₂ in a range including any of the minimum and maximum values noted herein.

In an embodiment, the coating 202 or 205 including a particular percentage of friable SiO₂ out of the total SiO₂ that can facilitate improved performance and/or property of the abrasive particles and the abrasive articles. The relative content of the friable silica to the total content of silica may be based on the weight percentage of the friable silica and the weight percentage of the total silica. The weight percentage of the friable silica and total silica is relative to the total weight of the abrasive particles. In an aspect, at most 65% of the total SiO₂ may be friable SiO₂, such as at most 60%, at most 57%, at most 53%, at most 50%, at most 47%, at most 44%, at most 42%, at most 40%, at most 38%, at most at most 36%, at most 34%, at most 32%, at most 30%, at most 29%, at most 27%, at most 25%, at most 23% or at most 20% the total SiO₂ may be friable SiO₂. In another aspect, the coating can include at least 3% of friable SiO₂ out of the total SiO₂, such as at least 4%, at least 5%, at least 7%, at least 8%, at least 9%, at least 10%, at least 11%, at least 13%, at least 15%, at least 17%, at least 18%, or at least 19% of friable SiO₂ out of the total SiO₂. In a further aspect, the abrasive particles 200 or 210 may include coating 202 or 205 including friable SiO₂ in a percentage including any of the minimum and maximum percentages noted herein.

In a further embodiment, the coating 202 or 205 of abrasive particles 200 or 210 may include bonded silica (SiO₂). In particular embodiments, a particular content of SiO₂ may be bonded to abrasive cores 201 that can facilitate formation of improved abrasive particles 200 or 210 and/or abrasive articles. The average content of bonded SiO₂ can be determined by using the formula, C_{bonded}=Cₜₒₜₐₗ−(Cₗₒₒₛₑ+C_{friable}), wherein C_{bonded} represents the average content of bonded SiO₂, Cₜₒₜₐₗ represents the average total content of SiO₂, represents the average content of loose SiO₂, and C_{bonded} represents the average content of friable SiO₂. In an aspect, the coating 202 or 205 can include an average content of bonded SiO₂ of at least 130 ppm for a total weight of the abrasive particles, such as at least 140 ppm, at least 150 ppm, at least 160 ppm, at least 170 ppm, at least 180 ppm, at least 190 ppm, at least 200 ppm, at least 210 ppm, at least 220 ppm, at least 240 ppm, at least 250 ppm, at least 260 ppm, at least 270 ppm, or at least 280 ppm. In an aspect, the coating 202 or 205 can include an average content of bonded SiO₂ of at most 930 ppm for a total weight of the abrasive particles, such as at most 900 ppm, at most 880 ppm, at most 860 ppm, at most 830 ppm, at most 810 ppm, at most 790 ppm, at most 760 ppm, at most 710 ppm, at most 680 ppm, at most 650 ppm, at most 630 ppm, at most 610 ppm, at most 590 ppm, at most 570 ppm, at most 550 ppm, at most 530 ppm, at most 510 ppm, at most 490 ppm, at most 470 ppm, at most 450 ppm, at most 430 ppm, at most 410 ppm, at most 380 ppm, at most 360 ppm, at most 330 ppm, at most 310 ppm, or at most 300 ppm. In a further aspect, the coating 202 or 205 may include an average content of bonded SiO₂ in a range including any of the minimum and maximum values noted herein.

In an embodiment, the coating may include a particular percentage of bonded SiO₂ out of the total SiO₂ that can facilitate improved performance and/or property of the abrasive particles and the abrasive articles. The relative content of the bonded silica to the total content of silica may be based on the weight percentage of the bonded silica relative to the weight percentage of the total silica. The weight percentage of both the bonded silica and total silica is relative to the total weight of the abrasive particles. In an aspect, at least 9% of the total SiO₂ may be bonded SiO₂, such as at least 10%, at least 11%, at least 13%, at least 15%, at least 17%, at least 18%, at least 19%, at least 20%, at least 21%, at least 22%, at least 23%, at least 25%, as at least 27%, at least 29%, at least 31%, at least 33%, at least 36%, at least 38%, at least 40%, at least 43%, at least 45%, at least 47%, at least 50%, at least 53%, at least 55%, at least 57%, at least 58%, at least 59%, or at least 60% of the total SiO₂ may be bonded SiO₂. In an aspect, the coating can include at most 95% of bonded SiO₂ out of the total content of SiO₂, such as at most 90%, at most 87%, at most 85%, at most 81%, at most 78%, at most 75%, at most 73%, at most 70%, at most 68%, at most at most 66%, at most 64%, at most 62%, at most 61%, or at most 60% of bonded SiO₂ out of the total SiO₂. In a further aspect, the coating may include a percentage of bonded SiO₂ in a range including any of the minimum and maximum percentages noted herein.

In an embodiment, the coating 202 or 205 can have a particular hardness that can facilitate improved performance and/or property of the abrasive particles and abrasive articles. In an aspect, the hardness may be greater than 1 GPa, such as at least 1.5 GPa, at least 1.8 GPa, at least 2 GPa, at least 2.2 GPa, at least 2.5 GPa, at least 2.8 GPa, or at least 3 GPa. In another aspect, the hardness may be less than 10 GPa, such as less than 8 GPa, at most 7 GPa, at most 6 GPa, at most 5 GPa, at most 4 GPa, at most 3.8 GPa, at most 3.5 GPa, at most 3.3 GPa, at most 3.2 GPa, or at most 3 GPa. In a further aspect, the coating 202 or 205 can have a hardness in a range including any of the minimum and maximum values noted herein. The hardness can be determined as follows. Silica suspension can be deposited on a flat alumina substrate (99.5% purity) by dip coating. The coated substrate can be sintered as described in embodiments herein. The final thickness of the silica coating can be about 350 nm as measured by contact profilometry. Nanoindentation can be performed on the coated plate with an indent depth of 300 nm. 20 indents can be formed to determine the hardness of the coating. FIG. 9 includes cross-sectional illustration of a bonded abrasive article 900 including a body 901 including abrasive particles 210 contained within a bond material 903. In at least one embodiment, the bond material 903 defines an interconnected and continuous phase throughout the entire volume of the body 901. In another embodiment, the bond material 903 can form a three-dimensional matrix. In another embodiment, the abrasive particles 201 can be used alone or in combination with abrasive particles 210 in forming the abrasive article 900.

In an embodiment, the abrasive particles 210 can bond to the bond material 903. In a further embodiment, a portion of the coating 203 can cross link to the bond material 903. For example, silane or silane derivative can cross link to the bond material in the process of forming the body 901.

In an embodiment, the bond material 903 can include an organic material, an inorganic material, a ceramic material, a vitreous material, a metal, or a metal alloy material. In a particular embodiment, the bond material 903 can include an organic material, such as one or more natural organic materials, synthetic organic materials, or a combination thereof. In particular instances, the organic material can be made of a resin, which may include a thermoset, a thermoplastic, and a combination thereof. For example, some suitable resins can include phenolics, epoxies, polyesters, cyanate esters, shellacs, polyurethanes, polybenzoxazines, polybismaleimides, polyimides, rubber, and a combination thereof.

The phenolic resin may be modified with a curing or cross-linking agent, such as hexamethylene tetramine. At temperatures in excess of about 90° C., some examples of the hexamethylene tetramine may form crosslinks to form methylene and dimethylene amino bridges that help cure the resin. The hexamethylene tetramine may be uniformly dispersed within the resin. More particularly, hexamethylene tetramine may be uniformly dispersed within resin regions as a cross-linking agent. Even more particularly, the phenolic resin may contain resin regions with cross-linked domains having a sub-micron average size.

In an embodiment, the body 901 can include a certain content of the bond material 903 that can facilitate improved formation of abrasive articles. In an instance, the body 901 may include not greater than 98 vol % the bond material 903 for a total volume of the body or not greater than 95 vol % or not greater than 90 vol % or not greater than 85 vol % or not greater than 80 vol % or not greater than 75 vol % or not greater than 70 vol % or not greater than 65 vol % or not greater than 60 vol % or not greater than 55 vol % or not greater than 50 vol % or not greater than 45 vol % or not greater than 40 vol % or not greater than 35 vol % or not greater than 30 vol % or not greater than 25 vol %. In another instance, the body 101 can include at least 1 vol % the bond material 103 for a total volume of the body or at least 2 vol % or at least 5 vol % or at least 10 vol % or at least 20 vol % or at least 30 vol % or at least 35 vol % or at least 40 vol % or at least 45 vol %. Moreover, the body 901 can include bond material 903 in a content including any of the minimum and maximum percentages noted herein.

In an embodiment, the body 901 can include a certain content of abrasive particles 210 and/or 201 that can facilitate improved properties and performance of abrasive articles. In an example, the body 901 may include not greater than 65 vol % abrasive particles 105 for a total volume of the body 901, such as not greater than 64 vol % or not greater than 62 vol % or not greater than 60 vol % or not greater than 58 vol % or not greater than 56 vol % or not greater than 54 vol % or not greater than 52 vol % or not greater than 50 vol % or not greater than 48 vol % or not greater than 46 vol % or not greater than 44 vol % or not greater than 42 vol % or not greater than 40 vol % or not greater than 38 vol % or not greater than 36 vol % or not greater than 34 vol % or not greater than 32 vol % or not greater than 30 vol % or not greater than 28 vol % or not greater than 26 vol % or not greater than 24 vol % or not greater than 22 vol % or not greater than 20 vol %. In another example, the body 901 can include at least 1 vol % abrasive particles 210 and/or 201 for a total volume of the body, such as at least 2 vol % or at least about 4 vol % or at least 6 vol % or at least 8 vol % or at least 10 vol % or at least 12 vol % or at least 14 vol % or at least 16 vol % or at least 18 vol % or at least 20 vol % or at least 25 vol % or at least 30 vol % or at least 35 vol % abrasive particles 210 and/or 201 for a total volume of the body 901. Moreover, the body 901 can include a content of abrasive particles 210 and/or 201 in a range including any of the minimum and maximum percentages noted herein.

In at least one embodiment, the body 901 can include abrasive particles including cores 201 having at least one different characteristics including composition, shape, hardness, particle size, friability, toughness, crystallite size, or any combination thereof. For example, cores 201 can include shaped abrasive particles and non-shaped particles or abrasive particles having different shapes. In a further instance, cores 201 can include a first type of abrasive particle including a premium abrasive particle (e.g., fused alumina, alumina-zirconia, seeded sol gel alumina, shaped abrasive particle, etc.) and a second type of abrasive particle including a diluent abrasive particle.

Referring to FIG. 9, the body 901 further includes a central opening 930 and an axial axis 131 extending through the central opening 930 in the axial direction, which can be perpendicular to a radial axis extending along a direction defining the diameter (d) of the body. It will be appreciated that any other fillers and/or phases (e.g., porosity) of the body can be contained within the bond material 903.

In an embodiment, the body 901 can include a type of porosity selected from the group consisting of closed porosity, open porosity, and a combination thereof. In an aspect, a majority of the porosity can be closed porosity defined by discrete pores, and in a particular aspect, the porosity can consist essentially of closed porosity. In another aspect, the majority of the porosity can be open defining a network of interconnected channels extending through at least a portion of the body, and in a particular aspect, essentially all of the porosity can be open porosity. In still another aspect, the porosity can include a combination of open and closed porosity.

In an embodiment, the body 901 can include a particular porosity that can facilitate improved properties and performance of abrasive articles. In an instance, the body 901 can include at least 1 vol % porosity for a total volume of the body or at least 2 vol % or at least 4 vol % or at least 6 vol % or at least 8 vol % or at least 10 vol % or at least 12 vol % or at least 14 vol % or at least 16 vol % or at least 18 vol % or at least 20 vol % or at least 25 vol % or at least 30 vol % or at least 40 vol % or at least 45 vol % or at least 50 vol % or at least 55 vol %. In another instance, the body 101 may include not greater than 80 vol % porosity for a total volume of the body or not greater than 75 vol % or not greater than 70 vol % or not greater than 65 vol % or not greater than 60 vol % or not greater than 55 vol % or not greater than 50 vol % or not greater than 45 vol % or not greater than 40 vol % or not greater than 35 vol % or not greater than 30 vol % or not greater than 25 vol % or not greater than 20 vol % or not greater than 15 vol % or not greater than 10 vol % or not greater than 5 vol % or not greater than 2 vol %. Moreover, the body 901 can include a porosity in a range including any of the minimum percentages and maximum percentages noted herein.

In an embodiment, the body 901 can include filler. For example, the body 901 may include not greater than 40 vol % filler for the total volume of the body. In a particular instance, the body 901 can have not greater than 35 vol %, such as not greater than 30 vol % or not greater than 25 vol % or not greater than 20 vol % or not greater than 15 vol % or not greater than 10 vol % or not greater than 8 vol % or not greater than 5 vol % or not greater than 4 vol % or even not greater than 3 vol % filler. For at least one embodiment, the body 901 may have no filler. According to one non-limiting embodiment, the body 901 can have at least 0.05 vol % filler for the total volume of the body 901, such as at least 0.5 vol % or at least 1 vol % or at least 2 vol % or at least 3 vol % or at least 5 vol % or at least 10 vol % or at least 15 vol % or at least 20 vol % or even at least 30 vol % filler. Moreover, filler within the body 901 can be within a range between any of the minimum and maximum percentages noted above, including for example, but not limited to a content within a range of at least 0.5 vol % and not greater than 30 vol %.

The filler may include a material selected from the group consisting of powders, granules, spheres, fibers, and a combination thereof. Moreover, in particular instances, the filler can include an inorganic material, an organic material, fibers, woven materials, non-woven materials, particles, minerals, nuts, shells, oxides, alumina, carbide, nitrides, borides, polymeric materials, naturally occurring materials, and a combination thereof. In a certain embodiment, the filler can include a material such as sand, bubble alumina, chromites, magnesite, dolomites, bubble mullite, borides, titanium dioxide, carbon products (e.g., carbon black, coke or graphite), silicon carbide, wood flour, clay, talc, hexagonal boron nitride, molybdenum disulfide, feldspar, nepheline syenite, glass spheres, glass fibers, CaF₂, KBF₄, Cryolite (Na₃AlF₆), potassium Cryolite (K₃AlF₆), pyrites, ZnS, copper sulfide, mineral oil, fluorides, carbonates, calcium carbonate, wollastonite, mullite, steel, iron, copper, brass, bronze, tin, aluminum, kyanite, alusite, garnet, quartz, fluoride, mica, nepheline syenite, sulfates (e.g., barium sulfate), carbonates (e.g., calcium carbonate), titanates (e.g., potassium titanate fibers), rock wool, clay, sepiolite, iron sulfide (e.g., Fe₂S₃, FeS₂, or a combination thereof), potassium fluoroborate (KBF₄), zinc borate, borax, boric acid, fine alundum powders, P15A, cork, glass spheres, silica microspheres (Z-light), silver, Saran™ resin, paradichlorobenzene, oxalic acid, alkali halides, organic halides, attapulgite or any combination thereof.

In at least one embodiment, the filler may include a material selected from the group consisting of an antistatic agent, a lubricant, a porosity inducer, coloring agent, and a combination thereof. In particular instances wherein the filler is particulate material, it may be distinct from the abrasive particles, being significantly smaller in average particle size than the abrasive particles.

The body 901 is illustrated in cross section as having a generally rectangular shape, which may be representative of a wheel or disc shape with a central opening 930, such that it is an annulus. It will be appreciated that the abrasive articles of the embodiments herein can have a body that may be in the form of a hone, a cone, a cup, flanged shapes, a cylinder, a wheel, a ring, and a combination thereof.

The body 901 can have a generally circular shape as viewed top down. It will be appreciated, that in three-dimensions the body 901 can have a certain thickness (t) such that the body 201 has a disk-like or a cylindrical shape. As illustrated, the body 901 can have an outer diameter (d) extending through the center of the body 901. The central opening 930 can extend through the entire thickness (t) of the body 901 such that the abrasive article 900 can be mounted on a spindle or other machine for rotation of the abrasive article 900 during operation. According to one embodiment, the body 901 may have a particular relationship between the thickness (t) and the diameter (d), such that an aspect ratio (d:t) of the body is at least 10:1, such as at least 20:1 or at least 30:1 or at least 40:1 or at least 50:1 or at least 60:1 or at least 70:1 or at least 80:1 or at least 90:1 or at least 100:1. Still, in one non-limiting embodiment, the aspect ratio (d:t) may be not greater than 1000:1 or not greater than 500:1. It will be appreciated that the aspect ratio (d:t) can be within a range including any of the minimum and maximum values noted above.

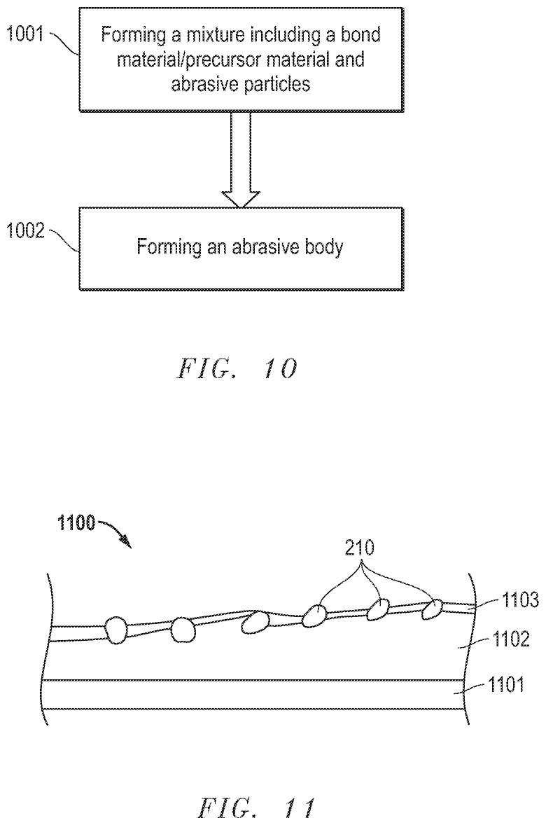

FIG. 10 includes an illustration of a process of forming an abrasive article including a body. At block 1001, the process can include forming a mixture including a bond material and/or bond precursor material and abrasive particles.

According to one embodiment, the bond material and/or bond precursor material may include a material selected from the group consisting of an organic material, an organic precursor material, an inorganic material, an inorganic precursor material, a natural material, and a combination thereof. In particular instances, the bond material may include a metal or metal alloy, such as a powder metal material, or a precursor to a metal material, suitable for formation of a metal bond matrix material during further processing.

According to another embodiment, the mixture may include a vitreous material, or a precursor of a vitreous material, suitable for formation of a vitreous bond material during further processing. For example, the mixture may include a vitreous material in the form of a powder, including for example, an oxygen-containing material, an oxide compound or complex, a frit, and any combination thereof.

In yet another embodiment, the mixture may include a ceramic material, or a precursor of a ceramic material, suitable for formation of a ceramic bond material during further processing. For example, the mixture may include a ceramic material in the form of a powder, including for example, an oxygen-containing material, an oxide compound or complex, and any combination thereof.

According to another embodiment, the mixture may include an organic material, or a precursor of an organic material, suitable for formation of an organic bond material during further processing. Such an organic material may include one or more natural organic materials, synthetic organic materials, and a combination thereof. In particular instances, the organic material can be made of a resin, which may include a thermoset, a thermoplastic, and a combination thereof. For example, some suitable resins can include phenolics, epoxies, polyesters, cyanate esters, shellacs, polyurethanes, polybenzoxazines, polybismaleimides, polyimides, rubber, and a combination thereof. In one particular embodiment, the mixture includes an uncured resin material configured to form a phenolic resin bond material through further processing.

The phenolic resin may be modified with a curing or cross-linking agent, such as hexamethylene tetramine. At temperatures in excess of about 90° C., some examples of the hexamethylene tetramine may form crosslinks to form methylene and dimethylene amino bridges that help cure the resin. The hexamethylene tetramine may be uniformly dispersed within the resin. More particularly, hexamethylene tetramine may be uniformly dispersed within resin regions as a cross-linking agent. Even more particularly, the phenolic resin may contain resin regions with cross-linked domains having a sub-micron average size.

Other materials, such as a filler, can be included in the mixture. The filler may or may not be present in the finally-formed abrasive article. After forming the mixture, the process of forming the abrasive article can further include forming a green body comprising abrasive particles contained in a bond material. A green body is a body that is unfinished and may undergo further processing before a finally-formed abrasive article is formed. Forming of the green body can include techniques such as pressing, molding, casting, printing, spraying, and a combination thereof. In one particular embodiment, forming of the green body can include pressing the mixture into a particular shape, including for example, conducting a pressing operation to form a green body in the form of a grinding wheel.

It will also be appreciated that one or more reinforcing materials may be included within the mixture, or between portions of the mixture to create a composite body including one or more abrasive portions (i.e., abrasive particles contained within the bond material as well as porosity, fillers and the like) and reinforcing portions made up of the reinforcing materials. Some suitable examples of reinforcing materials include woven materials, non-woven materials, fiberglass, fibers, naturally occurring materials, synthetic materials, inorganic materials, organic materials, or any combination thereof. As used herein, terms such as “reinforced” or “reinforcement” refer to discrete layers or portions of a reinforcing material that is different from the bond and abrasive materials employed to make the abrasive portions. Terms such as “internal reinforcement” or “internally reinforced” indicate that these components are within or embedded in the body of the abrasive article. In cut-off wheels the internal reinforcement can be, for example, in the shape of a disc with a middle opening to accommodate the arbor hole of the wheel. In some wheels, the reinforcing materials extend from the arbor hole to the periphery of the body. In others, reinforcing materials can extend from the periphery of the body to a point just under the flanges used to secure the body. Some abrasive articles may be “zone reinforced” with (internal) fiber reinforcement around the arbor hole and flange areas of the body (about 50% of the diameter of the body).

After forming the mixture with the desired components and applying the mixture in the desired processing apparatus, the process can continue by treating the mixture to form a finally-formed abrasive article. Some suitable examples of treating can include curing, heating, sintering, crystallizing, polymerization, pressing, and a combination thereof. In one example, the process may include bond batching, mixing abrasive particles with bond or bond precursor materials, filling a mold, pressing, and heating or curing the mixture.

After finishing the treating process, the abrasive article, such as abrasive article 900, is formed, including abrasive particles and any other additives contained within the bond material.

FIG. 11 includes a cross-sectional illustration of a coated abrasive article 1100 including a substrate 1101, a make coat 1102 overlying the substrate 1101, and abrasive particles 210. The coated abrasive article 1100 can optionally include filler, additives, or any combination thereof. A size coat 1103 overlies and bonds to abrasive particles 210 and the make coat 1102. In another embodiment, abrasive particles 200 may be used or in combination with abrasive particle 210 in forming the coated abrasive article 1100.

In an embodiment, the substrate 1101 can include an organic material, inorganic material, and a combination thereof. In certain instances, the substrate 1101 can include a woven material. However, the substrate 1101 may be made of a non-woven material. Particularly suitable substrate materials can include organic materials, including polymers, and particularly, polyester, polyurethane, polypropylene, polyimides such as KAPTON from DuPont, paper or any combination thereof. Some suitable inorganic materials can include metals, metal alloys, and particularly, foils of copper, aluminum, steel, and a combination thereof.

The make coat 1102 can be applied to the surface of the substrate 1101 in a single process, or alternatively, abrasive particles 210 can be combined with a make coat 1102 material and the combination of the make coat 1102 and abrasive particles 210 can be applied as a mixture to the surface of the substrate 1101. In certain instances, controlled deposition or placement of abrasive particles 210 in the make coat 1102 may be better suited by separating the processes of applying the make coat 1102 from the deposition of abrasive particles 210 in the make coat 1102. Still, it is contemplated that such processes may be combined. Suitable materials of the make coat 1102 can include organic materials, particularly polymeric materials, including for example, polyesters, epoxy resins, polyurethanes, polyamides, polyacrylates, polymethacrylates, polyvinylchlorides, polyethylene, polysiloxane, silicones, cellulose acetates, nitrocellulose, natural rubber, starch, shellac, and mixtures thereof. In one embodiment, the make coat 402 can include a polyester resin. The coated substrate can then be heated in order to cure the resin and bond abrasive particles 105 to the substrate 1101. In general, the coated substrate 1101 can be heated to a temperature of between about 100° C. to less than about 250° C. during this curing process.

After sufficiently forming the make coat 1102 with abrasive particles 210 contained therein, the size coat 1103 can be formed to overlie and bond abrasive particles 210 to the make coat 1102 and the substrate 1101. The size coat 1103 can include an organic material, and may be made essentially of a polymeric material, and notably, can use polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. An abrasive particle, comprising: a core including a ceramic material; a coating overlying the core, wherein the coating comprises: a first portion overlying at least a portion of the core, wherein the first portion comprises sintered colloidal silica; and a second portion overlying at least a portion of the core, wherein the second portion comprises silane or silane reaction product.

Embodiment 2. An abrasive particle, comprising: a core including a ceramic material including an average crystallite size of less than 1 micron; a coating overlying the core, wherein the coating comprises: a first portion overlying at least a portion of the core, wherein the first portion comprises a sintered ceramic material; and a second portion overlying at least a portion of the core, wherein the second portion comprises silane or silane reaction product.

Embodiment 3. A plurality of abrasive particles, wherein each of abrasive particles of the plurality of abrasive particles comprises: a core comprising a ceramic material including a first element forming a cation of the ceramic material and an average crystallite size of less than 1 micron; a coating overlying at least a portion of the core, wherein the coating comprises silicon; and an average Silicon/Cation Energy Dispersive Spectroscopy Percentage of at least 0.87%.

Embodiment 4. A plurality of abrasive particles, wherein each of abrasive particles of the plurality of abrasive particles comprises: a core comprising a ceramic material having an average crystallite size of less than 1 micron; and a coating overlying at least a portion of the core, wherein the coating comprises silicon; and an average Silicon Energy Dispersive Spectroscopy value of at least 0.39.

Embodiment 5. The abrasive particle or a plurality of abrasive particles of any one of embodiments 1 to 4, wherein the core comprises polycrystalline alpha-alumina comprising an average crystallite size of less than 1 micron.

Embodiment 6. The abrasive particle or a plurality of abrasive particles of any one of embodiments 1 to 5, wherein the core consists essentially of polycrystalline alpha-alumina including an average crystallite size of less than 1 micron.

Embodiment 7. The abrasive particle or a plurality of abrasive particles of embodiment 5 or 6, wherein the polycrystalline alpha-alumina comprising an average crystallite size of at least 0.01 microns, at least 0.02 microns, at least 0.03 microns, at least 0.04 microns, at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16, at least 0.17 microns, at least 0.18 microns, at least 0.19 microns, at least 0.2 microns, at least 0.3 microns, or at least 0.4 microns, or at least 0.5 microns.

Embodiment 8. The abrasive particle or a plurality of abrasive particles of any one of embodiments 5 to 7, wherein the polycrystalline alpha-alumina comprises an average crystallite size of not greater than 0.9 microns, not greater than 0.8 microns, not greater than 0.7 microns, not greater than 0.6 microns, not greater than 0.5 microns, not greater than 0.4 microns, not greater than 0.3 microns, not greater than 0.2 microns, not greater than 0.1 microns, not greater than 0.09 microns, not greater than 0.08 microns, not greater than 0.07 microns, not greater than 0.06 microns, not greater than 0.05 microns, not greater than 0.04 microns, not greater than 0.03 microns, not greater than 0.02 microns, or not greater than 0.01 microns.

Embodiment 9. The abrasive particle or a plurality of abrasive particles of any one of embodiments 5 to 8, wherein the polycrystalline alpha-alumina comprises an average crystallite size in a range including at least 0.01 microns and less than 1 micron, in a range including at least 0.03 microns and not greater than 0.8 microns, in a range including at least 0.05 microns and not greater than 0.6 microns, in a range including at least 0.08 microns and not greater than 0.4 microns, or in a range including at least 0.1 microns and not greater than 0.2 microns.

Embodiment 10. The abrasive particle or a plurality of abrasive particles of any one of embodiments 1 to 4, wherein the core comprises a sintered ceramic material including an oxide, a carbide, a nitride, a boride, an oxycarbide, an oxynitride, carbon-based materials, shaped abrasive particles, microcrystalline materials, nanocrystalline materials, or any combination thereof.

Embodiment 11. The abrasive particle or a plurality of abrasive particles of any one of embodiments 1 to 10, wherein the core comprises a density of at least 2.10 g/cm³, at least 2.20 g/cm³, 2.30 g/cm³, at least 2.40 g/cm³, at least 2.50 g/cm³, at least 2.60 g/cm³, at least 2.70 g/cm³, 2.80 g/cm³, at least 2.90 g/cm³, at least 3.00 g/cm³, at least 3.10 g/cm³, at least 3.20 g/cm³, at least 3.30 g/cm³, at least 3.40 g/cm³, 3.50 g/cm³, at least 3.55 g/cm³, at least 3.60 g/cm³, at least 3.65 g/cm³, at least 3.70 g/cm³, at least 3.75 g/cm³, at least 3.80 g/cm³, at least 3.85 g/cm³, at least 3.90 g/cm³, or at least 3.95 g/cm³.

Embodiment 12. The abrasive particle or a plurality of abrasive particles of any one of embodiments 1 to 10, wherein the core comprises a density of not greater than 5.80 g/cm³, not greater than 5.70 g/cm³, not greater than 5.60 g/cm³, not greater than 5.50 g/cm³, not greater than 5.40 g/cm³, not greater than 5.30 g/cm³, not greater than 5.20 g/cm³, not greater than 5.10 g/cm³, not greater than 5.00 g/cm³, not greater than 4.90 g/cm³, not greater than 4.80 g/cm³, not greater than 4.70 g/cm³, not greater than 4.60 g/cm³, not greater than 4.50 g/cm³, not greater than 4.40 g/cm³, not greater than 4.30 g/cm³, not greater than 4.20 g/cm³, not greater than 4.10 g/cm³, not greater than 4.00 g/cm³, or not greater than 3.97 g/cm³.

Embodiment 13. The abrasive particle or a plurality of abrasive particles of any one of embodiments 1 to 12, wherein the core comprises a density of at least 80% of its theoretical density, at least 85%, at least 88%, at least 90%, at least 92%, at least 95%, or at least 98% of its theoretical density.

Embodiment 14. The abrasive particle or a plurality of abrasive particles of any one of embodiments 1 to 13, wherein the core comprises a porosity not greater than 10 vol % for a total volume of the core, not greater than 9 vol %, not greater than 8 vol %, not greater than 7 vol %, not greater than 6 vol %, not greater than 5 vol %, not greater than 4 vol %, not greater than 3 vol %, not greater than 2 vol %, or not greater than 1 vol % for the total volume of the core.

Embodiment 15. The abrasive particle or a plurality of abrasive particles of any one of embodiments 1 to 14, wherein the core is essentially free of pores.

Embodiment 16. The abrasive particle or a plurality of abrasive particles of any one of embodiments 1 to 15, wherein the abrasive particle comprises an average Silicon Energy Dispersive Spectroscopy value of at least 0.39, at least 0.41, at least 0.43, at least 0.45, at least 0.47, at least 0.48, at least 0.49, at least 0.50, at least 0.51, at least 0.52, at least 0.54, at least 0.55, at least 0.56, at least 0.57, at least 0.59, at least 0.60, at least 0.61, at least 0.62, at least 0.64, at least 0.66, at least 0.67, at least 0.69, at least 0.70, at least 0.72, at least 0.74, at least 0.75, at least 0.77, at least 0.78, at least 0.79, at least 0.81, at least 0.83, at least 0.85, at least 0.87, at least 0.89, at least 0.90, at least 0.92, at least 0.93, at least 0.94, at least 0.95, at least 0.96, at least 0.97, at least 0.99, at least 1.00, at least 1.10, at least 1.15, at least 1.20, at least 1.25, at least 1.30, at least 1.35, at least 1.40, at least 1.45, at least 1.50, at least 1.55, at least 1.60, at least 1.65, at least 1.70, at least 1.75, at least 1.80, at least 1.85, at least 1.90, at least 1.95, at least 2.00, at least 2.10, at least 2.15, at least 2.20, at least 2.25, at least 2.30, at least 2.35, at least 2.40, at least 2.45, at least 2.50, at least 2.55, at least 2.60, at least 2.65, at least 2.70, at least 2.75, at least 2.80, at least 2.85, at least 2.90, at least 2.95, or at least 3.00.

Embodiment 17. The abrasive particle or a plurality of abrasive particles of any one of embodiments 1 to 16, wherein the abrasive particle comprises an average Silicon Energy Dispersive Spectroscopy value of not greater than 6.00, not greater than 5.95, not greater than 5.90, not greater than 5.85, not greater than 5.80, not greater than 5.75, not greater than 5.60, not greater than 5.50, not greater than 5.45, not greater than 5.35, not greater than 5.20, not greater than 5.10, not greater than 5.00, not greater than 4.95, not greater than 4.90, not greater than 4.85, not greater than 4.80, not greater than 4.75, not greater than 4.60, not greater than 4.50, not greater than 4.45, not greater than 4.35, not greater than 4.20, not greater than 4.10, not greater than 4.00, not greater than 3.95, not greater than 3.90, not greater than 3.85, not greater than 3.80, not greater than 3.75, not greater than 3.60, not greater than 3.50, not greater than 3.45, not greater than 3.35, not greater than 3.20, or not greater than 3.10.

Embodiment 18. The abrasive particle or a plurality of abrasive particles of any one of embodiments 1 to 17, wherein the core comprises a ceramic material including a first element forming a cation of the ceramic material, and wherein the abrasive particle comprises an average Silicon/Cation Energy Dispersive Spectroscopy Percentage of at least 0.9%, at least 1.0%, at least 1.2%, at least 1.5%, at least 1.7%, at least 1.9%, at least 2.0%, at least 2.1%, at least 2.2%, at least 2.4%, at least 2.7%, at least 2.9%, at least 3.0%, at least 3.1%, at least 3.3%, at least 3.5%, at least 3.7%, at least 3.9%, at least 4.1%, at least 4.3%, at least 4.5%, at least 4.7%, at least 4.9%, at least 5.0%, at least 5.1%, at least 5.2%, at least 5.4%, at least 5.6%, at least 5.8%, at least 6.0%, at least 6.1%, at least 6.3%, at least 6.5%, at least 6.7%, at least 6.9%, at least 7.0%, or at least 7.1%.

Embodiment 19. The abrasive particle or a plurality of abrasive particles of any one of embodiments 1 to 18, wherein the core comprises a ceramic material including a first element forming a cation of the ceramic material, and wherein the abrasive particle comprises an average Silicon/Cation Energy Dispersive Spectroscopy Percentage of not greater than 10.0%, not greater than 9.9%, not greater than 9.7%, not greater than 9.5%, not greater than 9.3%, not greater than 9.1%, not greater than 9.0%, not greater than 8.9%, not greater than 8.7%, not greater than 8.5%, not greater than 8.4%, not greater than 8.3%, not greater than 8.1%, not greater than 8.0%, not greater than 7.9%, not greater than 7.8%, not greater than 7.6%, not greater than 7.5%, not greater than 7.4%, not greater than 7.3%, or not greater than 7.2%.

Embodiment 20. The abrasive particle or a plurality of abrasive particles of any one of embodiments 3, 18, and 19, wherein the first element forming a cation of the ceramic material comprises aluminum, zirconium, magnesium, or a combination thereof.

Embodiment 21. The abrasive particle or a plurality of abrasive particles of any one of embodiments 3 and 18 to 20, wherein the first element forming a cation of the ceramic material consists of aluminum.

Embodiment 22. The abrasive particle or a plurality of abrasive particles of any one of embodiments 1 to 21, wherein the abrasive particle comprises an average Energy Dispersive Spectroscopy value of an element selected from the group consisting of alkali metal and alkaline earth metal of not greater than 2.0, not greater than 1.9, not greater than 1.8, not greater than 1.7, not greater than 1.6, not greater than 1.5, not greater than 1.4, not greater than 1.3, not greater than 1.2, not greater than 1.1, not greater than 1.0, not greater than 0.9, not greater than 0.8, not greater than 0.7, or not greater than 0.6.

Embodiment 23. The abrasive particle or a plurality of abrasive particles of any one of embodiments 1 to 22, wherein the abrasive particle comprises a sodium average Energy Dispersive Spectroscopy value of not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 24. The abrasive particle or a plurality of abrasive particles of any one of embodiments 1 to 23, wherein the abrasive particle comprises a potassium average Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 25. The abrasive particle or a plurality of abrasive particles of any one of embodiments 1 to 24, wherein the abrasive particle comprises a calcium average Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 26. The abrasive particle or a plurality of abrasive particles of any one of embodiments 1 to 25, wherein the abrasive particle comprises a magnesium average Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 27. The abrasive particle or a plurality of abrasive particles of any one of embodiments 1 to 26, wherein the abrasive particle comprises a barium average Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 28. The abrasive particle or a plurality of abrasive particles of any one of embodiments 1 to 27, wherein the abrasive particle comprises a boron Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 29. The abrasive particle or a plurality of abrasive particles of any one of embodiments 1 to 28, wherein the abrasive particle comprises a Silicon/Boron Energy Dispersive Spectroscopy ratio of at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100.

Embodiment 30. The abrasive particle or a plurality of abrasive particles of any one of embodiments 1 to 29, wherein the abrasive particle comprises a Silicon/Sodium Energy Dispersive Spectroscopy ratio of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100.

Embodiment 31. The abrasive particle or a plurality of abrasive particles of any one of embodiments 1 to 30, wherein the abrasive particle comprises a Silicon/Barium Energy Dispersive Spectroscopy ratio of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100.

Embodiment 32. The abrasive particle or a plurality of abrasive particles of any one of embodiments 1 to 31, wherein the abrasive particle comprises a Silicon/Potassium Energy Dispersive Spectroscopy ratio of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100.

Embodiment 33. The abrasive particle or a plurality of abrasive particles of any one of embodiments 1 to 32, wherein the abrasive particle comprises a Silicon/Calcium Energy Dispersive Spectroscopy ratio of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100.

Embodiment 34. The abrasive particle or a plurality of abrasive particles of any one of embodiments 1 to 33, wherein the abrasive particle comprises an average Energy Dispersive Spectroscopy value of an element selected from transition metal of not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 35. The abrasive particle or a plurality of abrasive particles of any one of embodiments 1 to 34, wherein the coating is essentially free of an element selected from alkali and alkaline earth metal.

Embodiment 36. The abrasive particle or a plurality of abrasive particles of any one of embodiments 1 to 35, wherein the coating is essentially free of an element selected from transitional metal.

Embodiment 37. The abrasive particle or a plurality of abrasive particles of any one of embodiments 1 to 36, wherein the coating is essentially free of boron, aluminum, or both.

Embodiment 38. The plurality of abrasive particles of embodiment 3 or 4, wherein the coating comprises: a first portion overlying at least a portion of the core, wherein the first portion comprises a sintered ceramic material including the silicon; and a second portion overlying at least a portion of the core, wherein the second portion comprises silane.

Embodiment 39. The plurality of abrasive particles of embodiment 38, wherein the coating comprises a sintered colloidal silica.

Embodiment 40. The abrasive particle or a plurality of abrasive particles of any one of embodiments 1 and 39, wherein the second portion overlies at least a portion of the first portion.

Embodiment 41. The abrasive particle or a plurality of abrasive particles of any one of embodiments 1 to 40, wherein the abrasive particle comprises a content of the coating of at least 0.01 wt. % for a total weight of the core, at least 0.02 wt. %, at least 0.03 wt. %, at least 0.04 wt. %, at least 0.05 wt. %, at least 0.06 wt. %, at least 0.07 wt. %, at least 0.08 wt. %, at least 0.09 wt. %, at least 0.1 wt. %, at least 0.15 wt. %, at least 0.16 wt. %, at least 0.17 wt. %, at least 0.18 wt. %, at least 0.19 wt. %, at least 0.2 wt. %, at least 0.25 wt. %, at least 0.26 wt. %, at least 0.27 wt. %, at least 0.28 wt. %, at least 0.29 wt. %, or at least 0.3 wt. % for a total weight of the core.

Embodiment 42. The abrasive particle or a plurality of abrasive particles of any one of embodiments 1 to 41, wherein the abrasive particle comprises a content of the coating of not greater than 1 wt. % for a total weight of the core, not greater than 0.9 wt. %, not greater than 0.8 wt. %, not greater than 0.7 wt. %, not greater than 0.6 wt. %, not greater than 0.55 wt. %, not greater than 0.5 wt. %, not greater than 0.48 wt. %, not greater than 0.46 wt. %, not greater than 0.45 wt. %, not greater than 0.43 wt. %, not greater than 0.42 wt. %, not greater than 0.41 wt. %, not greater than 0.4 wt. %, not greater than 0.38 wt. %, not greater than 0.37 wt. %, not greater than 0.36 wt. %, not greater than 0.35 wt. %, or not greater than 0.34 wt. % for a total weight of the core.

Embodiment 43. The abrasive particle or a plurality of abrasive particles of any one of embodiments 1 to 42, wherein the coating comprises a thickness of not greater than 10 microns, not greater than 9 microns, not greater than 8 microns, not greater than 7 microns, not greater than 6 microns, not greater than 5 microns, not greater than 4 microns, not greater than 3 microns, not greater than 2 microns, not greater than 1 microns, not greater than 0.9 microns, not greater than 0.8 microns, not greater than 0.7 microns, not greater than 0.6 microns, not greater than 0.5 microns, not greater than 0.4 microns, not greater than 0.3 microns, or not greater than 0.2 microns.

Embodiment 44. The abrasive particle or a plurality of abrasive particles of any one of embodiments 1 to 43, wherein the coating comprises a thickness of at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16 microns, at least 0.17 microns, at least 0.18 microns, at least 0.19 microns, at least 0.20 microns, at least 0.21 microns, at least 0.22 microns, at least 0.24 microns, at least 0.26 microns, at least 0.28 microns, at least 0.29 microns, at least 0.30 microns, or at least 0.31 microns.

Embodiment 45. The abrasive particle or a plurality of abrasive particles of any one of embodiments 1 to 44, wherein the abrasive particle comprises a ratio of a thickness of the coating to an average particle size of the core, wherein the ratio is less than 1, not greater than 0.9, not greater than 0.7, not greater than 0.5, not greater than 0.4, not greater than 0.2, not greater than 0.1, not greater than 0.08, not greater than 0.06, not greater than 0.05, not greater than 0.03, not greater than 0.02, not greater than 0.01, not greater than 0.009, not greater than 0.008, not greater than 0.007, not greater than 0.006, not greater than 0.005, not greater than 0.004, not greater than 0.003, not greater than 0.002, or not greater than 0.1.

Embodiment 46. The abrasive particle or a plurality of abrasive particles of any one of embodiments 1 to 45, wherein the abrasive particle comprises a ratio of a thickness of the coating to an average particle size of the core, wherein the ratio is at least 0.0005, at least 0.0007, at least 0.0009, at least 0.001, at least 0.002, at least 0.003, at least 0.004, at least 0.005, at least 0.006, at least 0.007, at least 0.008, at least 0.009, at least 0.01, at least 0.02, or at least 0.03.

Embodiment 47. The abrasive particle or a plurality of abrasive particles of any one of embodiments 1 to 46, wherein the coating comprises a polycrystalline material.

Embodiment 48. The abrasive particle or a plurality of abrasive particles of any one of embodiments 1 to 47, wherein a majority of the coating is polycrystalline.

Embodiment 49. The abrasive particle or a plurality of abrasive particles of any one of embodiments 1 to 48, wherein for a total volume of the coating, at least 51 vol % of the coating is polycrystalline, at least 52 vol %, at least 53 vol %, at least 54 vol %, at least 55 vol %, at least 56 vol %, at least 57 vol %, at least 58 vol %, at least 59 vol %, at least 60 vol %, at least 61 vol %, at least 62 vol %, at least 63 vol %, at least 64 vol %, at least 65 vol %, at least 66 vol %, at least 67 vol %, at least 68 vol %, at least 69 vol %, at least 70 vol %, at least 71 vol %, at least 72 vol %, at least 73 vol %, at least 74 vol %, at least 75 vol %, at least 76 vol %, at least 77 vol %, at least 78 vol %, at least 79 vol %, at least 80 vol %, at least 81 vol %, at least 82 vol %, at least 83 vol %, at least 84 vol %, at least 85 vol %, at least 86 vol %, at least 87 vol %, at least 88 vol %, at least 89 vol %, at least 90 vol %, at least 91 vol %, at least 92 vol %, at least 93 vol %, at least 94 vol %, at least 95 vol %, at least 96 vol %, at least 97 vol %, at least 98 vol %, or at least 99 vol % of the coating is polycrystalline.

Embodiment 50. The abrasive particle or a plurality of abrasive particles of any one of embodiments 1 to 49, wherein the coating consists essentially of a polycrystalline material.

Embodiment 51. The abrasive particle or a plurality of abrasive particles of any one of embodiments 1 to 50, wherein the coating is essentially free of an amorphous phase.

Embodiment 52. The abrasive particle or a plurality of abrasive particles of any one of embodiments 1 to 51, wherein a majority of the coating is silica.

Embodiment 53. The abrasive particle or a plurality of abrasive particles of any one of embodiments 1 to 52, wherein for a total weight of the coating, at least 51 wt. % of the coating is silica, at least 52 wt. %, at least 53 wt. %, at least 54 wt. %, at least 55 wt. %, at least 56 wt. %, at least 57 wt. %, at least 58 wt. %, at least 59 wt. %, at least 60 wt. %, at least 61 wt. %, at least 62 wt. %, at least 63 wt. %, at least 64 wt. %, at least 65 wt. %, at least 66 wt. %, at least 67 wt. %, at least 68 wt. %, at least 69 wt. %, at least 70 wt. %, at least 71 wt. %, at least 72 wt. %, at least 73 wt. %, at least 74 wt. %, at least 75 wt. %, at least 76 wt. %, at least 77 wt. %, at least 78 wt. %, at least 79 wt. %, at least 80 wt. %, at least 81 wt. %, at least 82 wt. %, at least 83 wt. %, at least 84 wt. %, at least 85 wt. %, at least 86 wt. %, at least 87 wt. %, at least 88 wt. %, at least 89 wt. %, at least 90 wt. %, at least 91 wt. %, at least 92 wt. %, at least 93 wt. %, at least 94 wt. %, or at least 95 wt. % of the coating is silica.

Embodiment 54. The abrasive particle or a plurality of abrasive particles of any one of embodiments 1 to 53, wherein the coating consists essentially of silica.

Embodiment 55. The abrasive particle or a plurality of abrasive particles of any one of embodiments 1 to 54, wherein the coating comprises silica grains having an average crystallite size of at least 0.01 microns, at least, at least 0.02 microns, at least 0.03 microns, at least 0.04 microns, at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16 microns, at least 0.17 microns, at least 0.18 microns, at least 0.19 microns, at least 0.2 microns, at least 0.3 microns, at least 0.4 microns, at least 0.5 microns, at least 0.6 microns, at least 0.7 microns, at least 0.8 microns, at least 0.9 microns, at least 1 micron, at least 1.2 microns, at least 1.4 microns, at least 1.6 microns, at least 1.8 microns, at least 2 microns, at least 2.3 microns, at least 2.6 microns, at least 2.8 microns, at least 3 microns, at least 3.2 microns, at least 3.4 microns, at least 3.6 microns, at least 3.8 microns, at least 4 microns, at least 4.2 microns, at least 4.5 microns, at least 4.8 microns, at least 5 microns, at least 5.2 microns, at least 5.4 microns, at least 5.5 microns, at least 5.7 microns, at least 6 microns, at least 6.2 microns, at least 6.3 microns, at least 6.5 microns, at least 6.7 microns, at least 6.8 microns, at least 7 microns, at least 7.2 microns, at least 7.4 microns, at least 7.5 microns, at least 7.8 microns, at least 8 microns, at least 8.1 microns, at least 8.3 microns, at least 8.5 microns, at least 8.6 microns, at least 8.7 microns, at least 8.9 microns, at least 9 microns, at least 9.1 microns, at least 9.3 microns, at least 9.4 microns, at least 9.6 microns, at least 9.8 microns, or at least 10 microns.

Embodiment 56. The abrasive particle or a plurality of abrasive particles of any one of embodiments 1 to 55, wherein the coating comprises silica grains having an average crystallite size of not greater than 10 microns, not greater than 9.8 microns, not greater than 9.6 microns, not greater than 9.4 microns, not greater than 9.2 microns, not greater than 9 microns, not greater than 8.7 microns, not greater than 8.5 microns, not greater than 8.3 microns, not greater than 8.1 microns, not greater than 8 microns, not greater than 7.8 microns, not greater than 7.6 microns, not greater than 7.4 microns, not greater than 7.2 microns, not greater than 7 microns, not greater than 6.8 microns, not greater than 6.6 microns, not greater than 6.4 microns, not greater than 6.3 microns, not greater than 6.2 microns, not greater than 6 microns, not greater than 5.8 microns, not greater than 5.6 microns, not greater than 5.4 microns, not greater than 5.3 microns, not greater than 5 microns, not greater than 4.8 microns, not greater than 4.6 microns, not greater than 4.4 microns, not greater than 4.2 microns, not greater than 4 microns, not greater than 3.8 microns, not greater than 3.6 microns, not greater than 3.4 microns, not greater than 3.2 microns, not greater than 2.9 microns, not greater than 2.8 microns, not greater than 2.6 microns, not greater than 2.4 microns, not greater than 2.2 microns, not greater than 2 microns, not greater than 1.8 microns, not greater than 1.6 microns, not greater than 1.4 microns, not greater than 1.2 microns, not greater than 1 microns, not greater than 0.9 microns, not greater than 0.8 microns, not greater than 0.7 microns, not greater than 0.6 microns, not greater than 0.5 microns, not greater than 0.4 microns, not greater than 0.3 microns, not greater than 0.2 microns, not greater than 0.1 microns, not greater than 0.09 microns, not greater than 0.08 microns, not greater than 0.07 microns, not greater than 0.06 microns, not greater than 0.05 microns, not greater than 0.04 microns, not greater than 0.03 microns, not greater than 0.02 microns, or not greater than 0.01 microns.

Embodiment 57. The abrasive particle or a plurality of abrasive particles of any one of embodiments 1 to 56, wherein the majority of the coating consists essentially of silica grains.

Embodiment 58. The abrasive particle or a plurality of abrasive particles of any one of embodiments 1 to 57, wherein the coating consists essentially of silica grains.

Embodiment 59. The abrasive particle or a plurality of abrasive particles of any one of embodiments 1 to 58, wherein the abrasive particle comprises an average particle size of at least 10 microns, at least 30 microns, at least 40 microns, at least 50 microns, at least 60 microns, at least 70 microns, at least 80 microns, at least 90 microns, at least 100 microns, at least 120 microns, at least 140 microns, at least 150 microns, at least 170 microns, at least 180 microns, at least 200 microns, at least 210 microns, at least 230 microns, at least 250 microns, at least 260 microns, at least 270 microns, at least 290 microns, at least 300 microns, at least 320 microns, at least 340 microns, at least 350 microns, at least 360 microns, at least 380 microns, at least 400 microns, at least 420 microns, at least 430 microns, at least 440 microns, at least 450 microns, at least 460 microns, at least 470 microns, at least 490 microns, or at least 500 microns.

Embodiment 60. The abrasive particle or a plurality of abrasive particles of any one of embodiments 1 to 59, wherein the abrasive particle comprises an average particle size of not greater than 2000 microns, not greater than 1800 microns, not greater than 1600 microns, not greater than 1500 microns, not greater than 1400 microns, not greater than 1300 microns, not greater than 1200 microns, not greater than 1100 microns, not greater than 1000 microns, not greater than 900 microns, not greater than 850 microns, not greater than 830 microns, not greater than 800 microns, not greater than 750 microns, not greater than 700 microns, not greater than 650 microns, not greater than 600 microns, not greater than 550 microns, not greater than 500 microns, not greater than 450 microns, or not greater than 400 microns.

Embodiment 61. The abrasive particle or a plurality of abrasive particles of any one of embodiments 1 to 60, wherein the coating comprises silane, wherein the silane is in form of an organic-inorganic compound.

Embodiment 62. The abrasive particle or a plurality of abrasive particles of embodiment 61, wherein the compound comprises organosilicon.

Embodiment 63. The abrasive particle or a plurality of abrasive particles of embodiment 61 or 62, wherein the compound comprises aminosilane, bis-aminosilane, gamma-aminopropyltriethoxysilane, or any combination thereof.

Embodiment 64. The abrasive particle or a plurality of abrasive particles of any one of embodiments 1 to 63, wherein the first portion comprises an average domain size of at least 10 nm, at least 12 nm, at least 15 nm, at least 18 nm, at least 20 nm, at least 22 nm, at least 25 nm, at least 28 nm, at least 30 nm, at least 33 nm, at least 35 nm, at least 38 nm, at least 40 nm, at least 42 nm, at least 45 nm, at least 47 nm, at least 50 nm, at least 53 nm, at least 55 nm, at least 58 nm, at least 60 nm, at least 62 nm, at least 65 nm, at least 68 nm, at least 70 nm, at least 73 nm, or at least 75 nm.

Embodiment 65. The abrasive particle or a plurality of abrasive particles of any one of embodiments 1 to 64, wherein the first portion comprises an average domain size can be at most 200 nm, at most 180 nm, at most 170 nm, at most 160 nm, at most 150 nm, at most 130 nm, at most 120 nm, at most 100 nm, at most 90 nm, at most 85 nm, at most 83 nm, at most 80 nm, at most 78 nm, at most 75 nm, at most 72 nm, at most 70 nm, at most 68 nm, at most 65 nm, at most 62 nm, at most 60 nm, at most 58 nm, at most 55 nm, at most 52 nm, or at most 50 nm.

Embodiment 66. The abrasive particle or a plurality of abrasive particles of any one of embodiments 1 to 65, wherein the first portion comprises an average root-mean-square roughness (Rq) of less than 11.9 nm, at most 11.8 nm, at most 11.5 nm, at most 11.2 nm, at most 11 nm, at most 10.8 nm, at most 10.5 nm, at most 10 nm, at most 9.5 nm, at most 9.2 nm, at most 9 nm, at most 8.5 nm, at most 8 nm, at most 7.8 nm, at most 7.5 nm, at most 7 nm, at most 6.5 nm, at most 6 nm, at most 5.5 nm, or at most 5 nm.

Embodiment 67. The abrasive particle or a plurality of abrasive particles of any one of embodiments 1 to 66, wherein the first portion comprises an average root-mean-square roughness (Rq) of greater than 4.6 nm, such as at least 4.7 nm, at least 5 nm, at least 5.3 nm, at least 5.5 nm, at least 5.8 nm, at least 6 nm, at least 6.3 nm, at least 6.5 nm, at least 6.8 nm, at least 7 nm, at least 7.3 nm, at least 7.5 nm, at least 7.8 nm, at least 8 nm, at least 8.5 nm, at least 9 nm, at least 9.5 nm, or at least 10 nm.

Embodiment 68. A fixed abrasive article, comprising: a body including: a bond material comprising an organic material; abrasive particles contained in the bond material, wherein the abrasive particles comprise the abrasive particle or a plurality of abrasive particles of any one of embodiments 1 to 67.

Embodiment 69. A plurality of abrasive particles, wherein each of the plurality of abrasive particles comprises a sintered coating overlying a core, wherein the sintered coating comprises an oxide material, and wherein the plurality of abrasive particles comprise an average thickness of the sintered coating of at most 2 micron.

Embodiment 70. A plurality of abrasive particles, wherein each of the plurality of abrasive particles comprise a coating overlying a core, wherein the coating comprises an oxide material, and wherein the plurality of abrasive particles comprise an average thickness and a thickness standard deviation of the coating, wherein an absolute value of the thickness standard deviation is at most 200% of the average thickness.

Embodiment 71. A plurality of abrasive particles, wherein: each of the plurality of abrasive particles comprises a coating overlying a core, wherein the coating comprises an oxide material; and the plurality of abrasive particles comprise an average domain size of the coating of greater than 19 nm and a domain size standard deviation, wherein an absolute value of the domain size standard deviation is at most 50% of the average domains size.

Embodiment 72. A plurality of abrasive particles, wherein: each of the plurality of abrasive particles comprises a coating overlying a core, wherein the coating comprises an oxide material; and the plurality of abrasive particles comprise: an average domain size of the coating of not greater than 130 nm; and an average coating coverage of at least 50% of a surface of the core.

Embodiment 73. A plurality of abrasive particles, wherein: each of the plurality of abrasive particles comprises a coating overlying a core, wherein the coating comprises an oxide material; and the plurality of abrasive particles comprise an average domain size of the coating of greater than 19 nm and not greater than 130 nm.

Embodiment 74. A plurality of abrasive particles, wherein: each of the plurality of abrasive particles comprises a coating overlying a core, wherein the coating comprises an oxide material; and the plurality of abrasive particles comprise an end-of-life Specific Grinding Energy (SGE) value of at least 1500 g.

Embodiment 75. A plurality of abrasive particles, wherein: each of the plurality of abrasive particles comprises a coating overlying a core, wherein the coating comprises an oxide material; and Specific Grinding Energy (SGE) of the plurality of abrasive particles is improved at least 10% compared to a plurality of corresponding conventional abrasive particles.

Embodiment 76. A plurality of abrasive particles, wherein: each of the plurality of abrasive particles comprises a sintered coating overlying a core, wherein the sintered coating comprises an oxide material; and the plurality of abrasive particles, as sintered, comprise not greater than 30 wt % of agglomerated abrasive particles for a total weight of the as-sintered plurality of abrasive particles.

Embodiment 77. The plurality of abrasive particles of any one of embodiments 69 to 76 wherein the coating comprises silica.

Embodiment 78. The plurality of abrasive particles of any one of embodiments 69 to 76, comprising an average coating thickness of at least 10 nm, at least 12 nm, at least 15 nm, at least 18 nm, at least 20 nm, at least 25 nm, at least 28 nm, at least 30 nm, at least 32 nm, at least 35 nm, at least 38 nm, at least 40 nm, at least 43 nm, at least 45 nm, at least 48 nm, at least 50 nm, at least 52 nm, at least 55 nm, at least 58 nm, at least 60 nm, at least 63 nm, at least 68 nm, at least 70 nm, at least 74 nm, at least 76 nm, at least 80 nm, at least 83 nm, at least 86 nm, at least 90 nm, at least 93 nm, at least 95 nm, at least 98 nm, at least 100 nm, at least 105 nm, at least 110 nm, at least 114 nm, at least 116 nm, at least 120 nm, at least 125 nm, at least 130 nm, at least 135 nm, at least 138 nm, at least 140 nm, at least 145 nm, at least 148 nm, at least 149 nm, at least 152 nm, at least 155 nm, at least 158 nm, at least 160 nm, at least 163 nm, at least 165 nm, at least 168 nm, at least 170 nm, at least 172 nm, at least 175 nm, at least 178 nm, at least 180 nm, at least 184 nm, at least 188 nm, at least 190 nm, at least 192 nm, at least 194 nm, at least 196 nm, at least 198 nm, at least 200 nm, at least 203 nm, at least 205 nm, at least 207 nm, at least 210 nm, at least 212 nm, at least 215 nm, at least 217 nm, at least 219 nm, at least 200 nm, at least 202 nm, at least 204 nm, at least 206 nm, at least 208 nm, at least 210 nm, at least 212 nm, at least 213 nm, at least 215 nm, at least 218 nm, at least 220 nm, at least 222 nm, at least 225 nm, at least 228 nm, at least 230 nm, at least 231 nm, at least 234 nm, at least 236 nm, at least 238 nm, at least 240 nm, at least 242 nm, at least 246 nm, at least 248 nm, at least 250 nm, at least 252 nm, at least 254 nm, at least 257 nm, at least 260 nm, at least 263 nm, at least 265 nm, at least 268 nm, at least 270 nm, at least 273 nm, at least 275 nm, at least 277 nm, at least 280 nm, at least 283 nm, at least 285 nm, at least 287 nm, at least 289 nm, at least 290 nm, at least 293 nm, at least 295 nm, at least 300 nm, at least 310 nm, at least 315 nm, at least 320 nm, at least 325 nm, at least 330 nm, at least 335 nm, at least 340 nm, at least 345 nm, at least 350 nm, at least 355 nm, at least 360 nm, at least 365 nm, at least 370 nm, at least 375 nm, at least 380 nm, at least 385 nm, at least 390 nm, at least 395 nm, or at least 400 nm.

Embodiment 79. The plurality of abrasive particles of any one of embodiments 69 to 76, comprising an average coating thickness of not greater than 2 microns, not greater than 1 micron, not greater than 900 nm, not greater than 890 nm, not greater than 880 nm, not greater than 870 nm, not greater than 860 nm, not greater than 850 nm, not greater than 840 nm, not greater than 830 nm, not greater than 810 nm, not greater than 800 nm, not greater than 780 nm, not greater than 770 nm, not greater than 760 nm, not greater than 750 nm, not greater than 740 nm, not greater than 730 nm, not greater than 710 nm, not greater than 700 nm, not greater than 690 nm, not greater than 680 nm, not greater than 670 nm, not greater than 660 nm, not greater than 650 nm, not greater than 640 nm, not greater than 630 nm, not greater than 610 nm, not greater than 600 nm, not greater than 590, not greater than 580 nm, not greater than 570 nm, not greater than 560 nm, not greater than 550 nm, not greater than 540 nm, not greater than 530 nm, not greater than 510 nm, not greater than 500 nm, not greater than 490 nm, not greater than 480 nm, not greater than 470 nm, not greater than 460 nm, not greater than 450 nm, not greater than 440 nm, not greater than 430 nm, not greater than 420 nm, not greater than 410 nm, not greater than 400 nm, not greater than 390 nm, not greater than 380 nm, not greater than 370 nm, not greater than 360 nm, not greater than 350 nm, not greater than 340 nm, not greater than 330 nm, not greater than 320 nm, not greater than 310 nm, not greater than 300 nm, not greater than 290 nm, not greater than 280 nm, not greater than 270 nm, not greater than 260 nm, not greater than 250 nm, not greater than 240 nm, not greater than 230 nm, not greater than 220 nm, not greater than 210 nm, not greater than 200 nm, not greater than 190 nm, not greater than 180 nm, not greater than 170 nm, not greater than 160 nm, not greater than 150 nm, not greater than 140 nm, not greater than 130 nm, not greater than 120 nm, not greater than 110 nm, not greater than 100 nm, not greater than 90 nm, not greater than 80 nm, not greater than 70 nm, not greater than 60 nm, or not greater than 50 nm.

Embodiment 80. The plurality of abrasive particles of any one of embodiments 69 to 76, wherein the plurality of abrasive particles comprise an average thickness and a thickness standard deviation of the coating, wherein an absolute value of the thickness standard deviation is not greater than 200% of the average thickness, not greater than 150%, not greater than 100%, not greater than 80%, not greater than 50%, not greater than 49%, not greater than 47%, not greater than 44%, not greater than 42%, not greater than 40%, not greater than 38%, not greater than 36%, not greater than 34%, not greater than 33%, not greater than 31%, not greater than 30%, not greater than 29%, not greater than 27%, not greater than 25%, not greater than 23%, not greater than 21%, not greater than 20%, not greater than 19%, not greater than 18%, not greater than 17%, not greater than 16%, not greater than 14%, not greater than 12%, not greater than 11%, not greater than 10%, not greater than 9%, not greater than 8%, not greater than 7%, not greater than 6%, not greater than 5%, not greater than 4%, not greater than 3%, not greater than 2%, not greater than 1%, not greater than 0.8%, not greater than 0.7%, or not greater than 0.5% of the average thickness of the coating.

Embodiment 81. The plurality of abrasive particles of any one of embodiments 69 to 76, wherein the plurality of abrasive particles comprise an average thickness and a thickness standard deviation of the coating, wherein an absolute value of the thickness standard deviation is at least 0.001% of the average thickness, at least 0.05%, at least 0.08%, at least 0.1%, at least 0.2%, at least 0.3%, at least 0.4%, at least 0.5%, at least 0.7%, at least 0.8%, at least 0.9%, at least 1%, at least 1.2%, at least 1.5%, at least 1.8%, at least 2%, at least 2.2%, at least 2.5%, at least 2.8%, at least 3%, at least 4%, or at least 5% of the average thickness of the coating.

Embodiment 82. The plurality of abrasive particles of any one of embodiments 69 to 76, wherein the plurality of abrasive particles comprise an average domain size of the coating of at least 15 nm, at least 16 nm, at least 17 nm, at least 18 nm, at least 19 nm, at least 20 nm, at least 21 nm, at least 22 nm, at least 23 nm, at least 24 nm, at least 25 nm, at least 26 nm, at least 27 nm, or at least 28.

Embodiment 83. The plurality of abrasive particles of embodiment 82, wherein the average domain size of the coating is greater than 19 nm or greater than 26 nm.

Embodiment 84. The plurality of abrasive particles of any one of embodiments 69 to 76, wherein the plurality of abrasive particles comprise an average domain size of the coating of not greater than 130 nm, not greater than 126 nm, not greater than 125 nm, not greater than 124 nm, not greater than 122 nm, not greater than 120 nm, not greater than 115 nm, not greater than 110 nm, not greater than 105 nm, not greater than 100 nm, not greater than 90 nm, not greater than 85 nm, not greater than 80, not greater than 75 nm, not greater than 70 nm, not greater than 65 nm, not greater than 60 nm, not greater than 55 nm, not greater than 50 nm, not greater than 45 nm, not greater than 40 nm, not greater than 35 nm, or not greater than 30 nm.

Embodiment 85. The plurality of abrasive particles of any one of embodiments 69 to 76, wherein the plurality of abrasive particles comprise an average domain size of the coating and a standard deviation of the average domain size, wherein an absolute value of the standard deviation is not greater than 50% of the average domain size, not greater than 49%, not greater than 48%, not greater than 47%, not greater than 46%, not greater than 45%, not greater than 44%, not greater than 43%, not greater than 42%, not greater than 41%, not greater than 40%, not greater than 39%, not greater than 38%, not greater than 37%, not greater than 36%, not greater than 35%, not greater than 33%, not greater than 31%, not greater than 30%, not greater than 29%, not greater than 27%, not greater than 25%, not greater than 23%, not greater than 21%, not greater than 20%, not greater than 19%, not greater than 17%, not greater than 16%, not greater than 15%, not greater than 49%, not greater than 48%, not greater than 47%, not greater than 46%, not greater than 45%, not greater than 43%, not greater than 42%, not greater than 41%, not greater than 40%, not greater than 39%, not greater than 37%, not greater than 35%, not greater than 33%, not greater than 30%, not greater than 28%, not greater than 26%, not greater than 24%, not greater than 21%, not greater than 19%, not greater than 17%, not greater than 15%, not greater than 13%, not greater than 11%, not greater than 10%, not greater than 9%, not greater than 8%, not greater than 7%, or not greater than 5% of the average domain size of the coating.

Embodiment 86. The plurality of abrasive particles of any one of embodiments 69 to 76, wherein the plurality of abrasive particles comprise an average domain size of the coating and a standard deviation of the average domain size, wherein an absolute value of the standard deviation is at least 0.001% of the domain size of the coating, at least 0.01%, at least 0.1%, at least 1%, at least 2%, at least 4%, at least 3%, or at least 5% of the domain size of the coating.

Embodiment 87. The plurality of abrasive particles of any one of embodiments 69 to 76, wherein the plurality of abrasive particles comprise an average domain size of the coating and a standard deviation of the average domain size, wherein an absolute value of the standard deviation is not greater than 65 nm, not greater than 63 nm, not greater than 61 nm, not greater than 60 nm, not greater than 58 nm, not greater than 55 nm, not greater than 53 nm, not greater than 51 nm, not greater than 50 nm, not greater than 49 nm, not greater than 47 nm, not greater than 45 nm, not greater than 43 nm, not greater than 41 nm, not greater than 40 nm, not greater than 38 nm, not greater than 36 nm, not greater than 32 nm, not greater than 30 nm, not greater than 28 nm, not greater than 25 nm, not greater than 23 nm, not greater than 22 nm, not greater than 20 nm, not greater than 19 nm, not greater than 17 nm, not greater than 16 nm, not greater than 15 nm, not greater than 14 nm, not greater than 13 nm, or not greater than 12 nm.

Embodiment 88. The plurality of abrasive particles of any one of embodiments 69 to 76, wherein the plurality of abrasive particles comprise an average domain size of the coating and a standard deviation of the average domain size, wherein an absolute value of the standard deviation is at least 0.1 nm, at least 0.3 nm, at least 0.5 nm, at least 1 nm, at least 2 nm, at least 3 nm, at least 4 nm, at least 5 nm, at least 6 nm, at least 7 nm, at least 8 nm, at least 9 nm, at least 10 nm, at least 11 nm, at least 12 nm, at least 13 nm, at least 14 nm, at least 15 nm, at least 16 nm, or at least 17 nm.

Embodiment 89. The plurality of abrasive particles of any one of embodiments 69 to 76, comprising an average coating thickness and a standard deviation of the average coating thickness, wherein an absolute value of the standard deviation is at least 1 nm, at least 3 nm, at least 5 nm, at least 7 nm, at least 9 nm, at least 10 nm, at least 13 nm, at least 15 nm, at least 17 nm, at least 19 nm, at least 21 nm, at least 23 nm, at least 25 nm, at least 28 nm, at least 30 nm, at least 32 nm, at least 34 nm, at least 36 nm, at least 39 nm, at least 41 nm, at least 45 nm, at least 46 nm, at least 48 nm, or at least 50 nm.

Embodiment 90. The plurality of abrasive particles of any one of embodiments 69 to 76, comprising an average coating thickness and a standard deviation of the average coating thickness, wherein an absolute value of the standard deviation is not greater than 500 nm, not greater than 480 nm, not greater than 460 nm, not greater than 420 nm, not greater than 400 nm, not greater than 350 nm, not greater than 320 nm, not greater than 310 nm, not greater than 300 nm, not greater than 280 nm, not greater than 260 nm, not greater than 230 nm, not greater than 210 nm, not greater than 190 nm, not greater than 170 nm, not greater than 150 nm, not greater than 130 nm, not greater than 120 nm, not greater than 110 nm, not greater than 100 nm, not greater than 90 nm, not greater than 80 nm, not greater than 70 nm, not greater than 60 nm, not greater than 50 nm, not greater than 40 nm, not greater than 30 nm, not greater than 20 nm, not greater than 18 nm, not greater than 15 nm, not greater than 12 nm, not greater than 10 nm, or not greater than 5 nm.

Embodiment 91. The plurality of abrasive particles of any one of embodiments 69 to 76, comprise an average coating coverage of at least 50% of a surface of the core, at least 55%, at least 57%, at least 59%, at least 61%, at least 63%, at least 65%, at least 68%, at least 70%, at least 72%, at least 75%, at least 76%, at least 77%, at least 79%, at least 80%, at least 82%, at least 84%, at least 85%, at least 87%, at least 88%, at least 90%, at least 91%, at least 92%, at least 93%, at least 94%, at least 95%, at least 96%, at least 97%, and at least 98%, at least 99%, and not greater than 100% of the surface of the core.

Embodiment 92. The plurality of abrasive particles of any one of embodiments 69 to 76, comprising a percentage crystallinity of the coating of at least 1%, at least 2%, at least 3%, at least 4%, at least 5%, at least 6%, at least 7%, at least 8%, at least 9%, at least 10%, or at least 11%.

Embodiment 93. The plurality of abrasive particles of any one of embodiments 69 to 76, comprising a percentage crystallinity of the coating of not greater than 63%, not greater than 62%, not greater than 61%, not greater than 60%, not greater than 58%, not greater than 55%, not greater than 53%, not greater than 51%, not greater than 50%, not greater than 48%, not greater than 46%, not greater than 44%, not greater than 41%, not greater than 40%, not greater than 38%, not greater than 36%, not greater than 34%, not greater than 31%, not greater than 30%, not greater than 28%, not greater than 26%, not greater than 24%, not greater than 22%, not greater than 20%, not greater than 18%, not greater than 16%, not greater than 14%, not greater than 12%, not greater than 10%, not greater than 8%, not greater than 7%, not greater than 5%, not greater than 4, or not greater than 3%.

Embodiment 94. The plurality of abrasive particles of any one of embodiments 69 to 76, comprising: a Coating Uniformity Factor at least 5% better than a plurality of corresponding conventional abrasive particles, at least 8%, at least 10%, at least 12%, at least 15%, at least 18%, at least 20%, at least 22%, at least 24%, at least 25%, at least 28%, at least 30%, at least 32%, at least 35%, at least 36%, at least 38%, or at least 40% better than a plurality of corresponding conventional abrasive particles; a moisture absorption rate of at least 5% better than a plurality of corresponding conventional abrasive particles, at least 8%, at least 10%, at least 12%, at least 15%, at least 18%, at least 20%, at least 22%, at least 24%, at least 25%, at least 28%, at least 30%, at least 32%, at least 35%, at least 36%, at least 38%, or at least 40% better than a plurality of corresponding conventional abrasive particles; an Anti-aging Factor of at least 5% better than a plurality of corresponding conventional abrasive particles, at least 8%, at least 10%, at least 12%, at least 15%, at least 18%, at least 20%, at least 22%, at least 24%, at least 25%, at least 28%, at least 30%, at least 32%, at least 35%, at least 36%, at least 38%, or at least 40% better than a plurality of corresponding conventional abrasive particles; an Adhesion Value of at least 5% better than a plurality of corresponding conventional abrasive particles, at least 8%, at least 10%, at least 12%, at least 15%, at least 18%, at least 20%, at least 22%, at least 24%, at least 25%, at least 28%, at least 30%, at least 32%, at least 35%, at least 36%, at least 38%, or at least 40% better than a plurality of corresponding conventional abrasive particles; or any combination thereof.

Embodiment 95. The plurality of abrasive particles of any one of embodiments 69 to 76, wherein the plurality is at least 100 abrasive particles, at least 500 abrasive particles, at least 1000 abrasive particles, at least 2000 abrasive particles, at least 5000 abrasive particles, at least 8000 abrasive particles, at least 10000 abrasive particles, or at least 500000 abrasive particles.

Embodiment 96. The plurality of abrasive particles of any one of embodiments 69 to 76, wherein the plurality is at least 1 kg of abrasive particles, at least 2 kg of abrasive particles, at least 4 kg of abrasive particles, at least 5 kg of abrasive particles, at least 7 kg of abrasive particles, at least 8 kg of abrasive particles, at least 10 kg of abrasive particles, at least 20 kg of abrasive particles, at least 30 kg of abrasive particles, at least 50 kg of abrasive particles, at least 100 kg of abrasive particles, or at least 1 ton of abrasive particles.

Embodiment 97. The plurality of abrasive particles of any one of embodiments 69 to 76, wherein the plurality makes up a significant percentage of abrasive particles from a fixed abrasive article.

Embodiment 98. The plurality of abrasive particles of any one of embodiments 69 to 76, wherein the plurality of abrasive particles, as sintered, comprise not greater than 30 wt. % of agglomerated abrasive particles for a total weight of the as-sintered plurality of abrasive particles, not greater than 25 wt. %, not greater than 20 wt. %, not greater than 15 wt. %, not greater than 10 wt. %, not greater than 5 wt. %, not greater than 2 wt. %, not greater than 1 wt. %, not greater than 0.8 wt. %, not greater than 0.5%, not greater than 0.3 wt. %, or not greater than 0.1 wt. % of agglomerated abrasive particles for a total weight of the as-sintered plurality of abrasive particles.

Embodiment 99. The plurality of abrasive particles of any one of embodiments 69 to 76, wherein the plurality of abrasive particles, as sintered, are essentially free of agglomerated abrasive particles.

Embodiment 100. The plurality of abrasive particles of any one of embodiments 69 to 76, comprising an end-of-life SGE value of at least 1500 g, at least 1600 g, at least 1700 g, at least 1800 g, at least 1900 g, at least 2000 g, or at least 2100 g.

Embodiment 101. The plurality of abrasive particles of any one of embodiments 69 to 76, wherein an end-of-life SGE value is at least 5% better than a plurality of corresponding conventional abrasive particles, at least 10% better, at least 15% better, at least 20% better, at least 25% better, at least 30% better, at least 35% better, or at least 40% better than a plurality of corresponding conventional abrasive particles.

Embodiment 102. The plurality of abrasive particles of any one of embodiments 69 to 76, wherein the core comprises a ceramic material.

Embodiment 103. The plurality of abrasive particles of any one of embodiments 69 to 76, wherein the core comprises a carbide or an oxide.

Embodiment 104. The plurality of abrasive particles of any one of embodiments 69 to 76, wherein the core comprises silicon carbide.

Embodiment 105. The plurality of abrasive particles of any one of embodiments 69 to 76, wherein the core comprises alumina including fused alumina, sol-gel alumina, nanocrystalline alumina, or any combination thereof.

Embodiment 106. The plurality of abrasive particles of embodiment 36, wherein the core comprises brown fused alumina.

Embodiment 107. The plurality of abrasive particles of any one of embodiments 69 to 76, wherein the coating is conformal overlying substantially an entire surface of the core.

Embodiment 108. The plurality of abrasive particles of any one of embodiments 69 to 76, wherein the coating consists of sintered silica.

Embodiment 109. The plurality of abrasive particles of any one of embodiments 69 to 76, wherein the coating comprises: a first portion overlying at least a portion of the core, wherein the first portion comprises sintered colloidal silica; and a second portion overlying at least a portion of the core, wherein the second portion comprises silane or silane reaction product.

Embodiment 110. The plurality of abrasive particles of any one of embodiments 69 to 76, wherein the coating comprises: a first portion overlying at least a portion of the core, wherein the first portion comprises a sintered ceramic material; and a second portion overlying at least a portion of the core, wherein the second portion comprises silane or silane reaction product.

Embodiment 111. The plurality of abrasive particles of any one of embodiments 69 to 76, wherein: the core comprises a ceramic material including a first element forming a cation of the ceramic material; and the coating comprises silicon; wherein the plurality of abrasive particles comprises: an average Silicon/Cation Energy Dispersive Spectroscopy Percentage of at least 0.87%; an average Silicon Energy Dispersive Spectroscopy value is at least 0.39; or a combination thereof.

Embodiment 112. The plurality of abrasive particles of any one of embodiments 69 to 76, wherein: the core comprises a ceramic material having an average crystallite size of less than 1 micron; and the coating comprises silicon; wherein an average Silicon Energy Dispersive Spectroscopy value is at least 0.39.

Embodiment 113. The plurality of abrasive particles of any one of embodiments 69 to 76, wherein the core comprises polycrystalline alpha-alumina comprising an average crystallite size of less than 1 micron.

Embodiment 114. The plurality of abrasive particles of any one of embodiments 69 to 76, wherein the core consists essentially of polycrystalline alpha-alumina including an average crystallite size of less than 1 micron.

Embodiment 115. The plurality of abrasive particles of embodiment 113 or 114, wherein the polycrystalline alpha-alumina comprises an average crystallite size of at least 0.01 microns, at least 0.02 microns, at least 0.03 microns, at least 0.04 microns, at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16, at least 0.17 microns, at least 0.18 microns, at least 0.19 microns, at least 0.2 microns, at least 0.3 microns, at least 0.4 microns, or at least 0.5 microns.

Embodiment 116. The plurality of abrasive particles of any one of embodiments 113 to 115, wherein the polycrystalline alpha-alumina comprises an average crystallite size of not greater than 0.9 microns, not greater than 0.8 microns, not greater than 0.7 microns, not greater than 0.6 microns, not greater than 0.5 microns, not greater than 0.4 microns, not greater than 0.3 microns, not greater than 0.2 microns, not greater than 0.1 microns, not greater than 0.09 microns, not greater than 0.08 microns, not greater than 0.07 microns, not greater than 0.06 microns, not greater than 0.05 microns, not greater than 0.04 microns, not greater than 0.03 microns, not greater than 0.02 microns, or not greater than 0.01 microns.

Embodiment 117. The plurality of abrasive particles of any one of embodiments 113 to 116, wherein the polycrystalline alpha-alumina comprises an average crystallite size in a range including at least 0.01 microns and less than 1 micron, in a range including at least 0.03 microns and not greater than 0.8 microns, in a range including at least 0.05 microns and not greater than 0.6 microns, in a range including at least 0.08 microns and not greater than 0.4 microns, or in a range including at least 0.1 microns and not greater than 0.2 microns.

Embodiment 118. The plurality of abrasive particles of any one of embodiments 69 to 76, wherein the core comprises a sintered ceramic material including an oxide, a carbide, a nitride, a boride, an oxycarbide, an oxynitride, superabrasives, carbon-based materials, agglomerates, aggregates, shaped abrasive particles, microcrystalline materials, nanocrystalline materials, or any combination thereof.

Embodiment 119. The plurality of abrasive particles of any one of embodiments 69 to 76, wherein the core comprises a density of at least 2.10 g/cm³, at least 2.20 g/cm³, 2.30 g/cm³, at least 2.40 g/cm³, at least 2.50 g/cm³, at least 2.60 g/cm³, at least 2.70 g/cm³, 2.80 g/cm³, at least 2.90 g/cm³, at least 3.00 g/cm³, at least 3.10 g/cm³, at least 3.20 g/cm³, at least 3.30 g/cm³, at least 3.40 g/cm³, 3.50 g/cm³, at least 3.55 g/cm³, at least 3.60 g/cm³, at least 3.65 g/cm³, at least 3.70 g/cm³, at least 3.75 g/cm³, at least 3.80 g/cm³, at least 3.85 g/cm³, at least 3.90 g/cm³, or at least 3.95 g/cm³.

Embodiment 120. The plurality of abrasive particles of any one of embodiments 69 to 76, wherein the core comprises a density of not greater than 5.80 g/cm³, not greater than 5.70 g/cm³, not greater than 5.60 g/cm³, not greater than 5.50 g/cm³, not greater than 5.40 g/cm³, not greater than 5.30 g/cm³, not greater than 5.20 g/cm³, not greater than 5.10 g/cm³, not greater than 5.00 g/cm³, not greater than 4.90 g/cm³, not greater than 4.80 g/cm³, not greater than 4.70 g/cm³, not greater than 4.60 g/cm³, not greater than 4.50 g/cm³, not greater than 4.40 g/cm³, not greater than 4.30 g/cm³, not greater than 4.20 g/cm³, not greater than 4.10 g/cm³, not greater than 4.00 g/cm³, or not greater than 3.97 g/cm³.

Embodiment 121. The plurality of abrasive particles of any one of embodiments 69 to 76, wherein the core comprises a density of at least 80% of its theoretical density, at least 85%, at least 88%, at least 90%, at least 92%, at least 95%, or at least 98% of its theoretical density.

Embodiment 122. The plurality of abrasive particles of any one of embodiments 69 to 76, wherein the core comprises a porosity not greater than 10 vol % for a total volume of the core, not greater than 9 vol %, not greater than 8 vol %, not greater than 7 vol %, not greater than 6 vol %, not greater than 5 vol %, not greater than 4 vol %, not greater than 3 vol %, not greater than 2 vol %, or not greater than 1 vol % for the total volume of the core.

Embodiment 123. The plurality of abrasive particles of any one of embodiments 69 to 76, wherein the core is essentially free of pores.

Embodiment 124. The plurality of abrasive particles of any one of embodiments 69 to 76, wherein the abrasive particle comprises an average Silicon Energy Dispersive Spectroscopy value of at least 0.39, at least 0.41, at least 0.43, at least 0.45, at least 0.47, at least 0.48, at least 0.49, at least 0.50, at least 0.51, at least 0.52, at least 0.54, at least 0.55, at least 0.56, at least 0.57, at least 0.59, at least 0.60, at least 0.61, at least 0.62, at least 0.64, at least 0.66, at least 0.67, at least 0.69, at least 0.70, at least 0.72, at least 0.74, at least 0.75, at least 0.77, at least 0.78, at least 0.79, at least 0.81, at least 0.83, at least 0.85, at least 0.87, at least 0.89, at least 0.90, at least 0.92, at least 0.93, at least 0.94, at least 0.95, at least 0.96, at least 0.97, at least 0.99, at least 1.00, at least 1.10, at least 1.15, at least 1.20, at least 1.25, at least 1.30, at least 1.35, at least 1.40, at least 1.45, at least 1.50, at least 1.55, at least 1.60, at least 1.65, at least 1.70, at least 1.75, at least 1.80, at least 1.85, at least 1.90, at least 1.95, at least 2.00, at least 2.10, at least 2.15, at least 2.20, at least 2.25, at least 2.30, at least 2.35, at least 2.40, at least 2.45, at least 2.50, at least 2.55, at least 2.60, at least 2.65, at least 2.70, at least 2.75, at least 2.80, at least 2.85, at least 2.90, at least 2.95, or at least 3.00.

Embodiment 125. The plurality of abrasive particles of any one of embodiments 69 to 76, wherein the abrasive particle comprises an average Silicon Energy Dispersive Spectroscopy value of not greater than 6.00, not greater than 5.95, not greater than 5.90, not greater than 5.85, not greater than 5.80, not greater than 5.75, not greater than 5.60, not greater than 5.50, not greater than 5.45, not greater than 5.35, not greater than 5.20, not greater than 5.10, not greater than 5.00, not greater than 4.95, not greater than 4.90, not greater than 4.85, not greater than 4.80, not greater than 4.75, not greater than 4.60, not greater than 4.50, not greater than 4.45, not greater than 4.35, not greater than 4.20, not greater than 4.10, not greater than 4.00, not greater than 3.95, not greater than 3.90, not greater than 3.85, not greater than 3.80, not greater than 3.75, not greater than 3.60, not greater than 3.50, not greater than 3.45, not greater than 3.35, not greater than 3.20, or not greater than 3.10.

Embodiment 126. The plurality of abrasive particles of any one of embodiments 69 to 76, wherein the core comprises a ceramic material including a first element forming a cation of the ceramic material, and wherein the abrasive particle comprises an average Silicon/Cation Energy Dispersive Spectroscopy Percentage of at least 0.9%, at least 1.0%, at least 1.2%, at least 1.5%, at least 1.7%, at least 1.9%, at least 2.0%, at least 2.1%, at least 2.2%, at least 2.4%, at least 2.7%, at least 2.9%, at least 3.0%, at least 3.1%, at least 3.3%, at least 3.5%, at least 3.7%, at least 3.9%, at least 4.1%, at least 4.3%, at least 4.5%, at least 4.7%, at least 4.9%, at least 5.0%, at least 5.1%, at least 5.2%, at least 5.4%, at least 5.6%, at least 5.8%, at least 6.0%, at least 6.1%, at least 6.3%, at least 6.5%, at least 6.7%, at least 6.9%, at least 7.0%, or at least 7.1%.

Embodiment 127. The plurality of abrasive particles of any one of embodiments 69 to 76, wherein the core comprises a ceramic material including a first element forming a cation of the ceramic material, and wherein the abrasive particle comprises an average Silicon/Cation Energy Dispersive Spectroscopy Percentage of not greater than 10.0%, not greater than 9.9%, not greater than 9.7%, not greater than 9.5%, not greater than 9.3%, not greater than 9.1%, not greater than 9.0%, not greater than 8.9%, not greater than 8.7%, not greater than 8.5%, not greater than 8.4%, not greater than 8.3%, not greater than 8.1%, not greater than 8.0%, not greater than 7.9%, not greater than 7.8%, not greater than 7.6%, not greater than 7.5%, not greater than 7.4%, not greater than 7.3%, or not greater than 7.2%.

Embodiment 128. The plurality of abrasive particles of any one of embodiments 111, 126, and 127, wherein the first element forming a cation of the ceramic material comprises aluminum, zirconium, magnesium, or a combination thereof.

Embodiment 129. The plurality of abrasive particles of any one of embodiments 111 and 126 to 128, wherein the first element forming a cation of the ceramic material consists of aluminum.

Embodiment 130. The plurality of abrasive particles of any one of embodiments 69 to 76, wherein the abrasive particle comprises an average Energy Dispersive Spectroscopy value of an element selected from the group consisting of alkali metal and alkaline earth metal of not greater than 2.0, not greater than 1.9, not greater than 1.8, not greater than 1.7, not greater than 1.6, not greater than 1.5, not greater than 1.4, not greater than 1.3, not greater than 1.2, not greater than 1.1, not greater than 1.0, not greater than 0.9, not greater than 0.8, not greater than 0.7, or not greater than 0.6.

Embodiment 131. The plurality of abrasive particles of any one of embodiments 69 to 76, wherein the abrasive particle comprises a sodium average Energy Dispersive Spectroscopy value of not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 132. The plurality of abrasive particles of any one of embodiments 69 to 76, wherein the abrasive particle comprises a potassium average Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 133. The plurality of abrasive particles of any one of embodiments 69 to 76, wherein the abrasive particle comprises a calcium average Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 134. The plurality of abrasive particles of any one of embodiments 69 to 76, wherein the abrasive particle comprises a magnesium average Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 135. The plurality of abrasive particles of any one of embodiments 69 to 76, wherein the abrasive particle comprises a barium average Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 136. The plurality of abrasive particles of any one of embodiments 69 to 76, wherein the abrasive particle comprises a boron Energy Dispersive Spectroscopy value of not greater than not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 137. The plurality of abrasive particles of any one of embodiments 69 to 76, wherein the abrasive particle comprises a Silicon/Boron Energy Dispersive Spectroscopy ratio of at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100.

Embodiment 138. The plurality of abrasive particles of any one of embodiments 69 to 76, wherein the abrasive particle comprises a Silicon/Sodium Energy Dispersive Spectroscopy ratio of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100.

Embodiment 139. The plurality of abrasive particles of any one of embodiments 69 to 76, wherein the abrasive particle comprises a Silicon/Barium Energy Dispersive Spectroscopy ratio of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100.

Embodiment 140. The plurality of abrasive particles of any one of embodiments 69 to 76, wherein the abrasive particle comprises a Silicon/Potassium Energy Dispersive Spectroscopy ratio of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100.

Embodiment 141. The plurality of abrasive particles of any one of embodiments 69 to 76, wherein the abrasive particle comprises a Silicon/Calcium Energy Dispersive Spectroscopy ratio of at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 30, at least 31, at least 32, at least 34, at least 35, at least 36, at least 37, at least 38, at least 39, at least 40, at least 45, at least 50, at least 55, or at least 60, or at least 100.

Embodiment 142. The plurality of abrasive particles of any one of embodiments 69 to 76, wherein the abrasive particle comprises an average Energy Dispersive Spectroscopy value of an element selected from transition metal of not greater than 1, not greater than 0.9, not greater than 0.8, not greater than 0.7, not greater than 0.6, not greater than 0.5, not greater than 0.4, not greater than 0.3, not greater than 0.2, not greater than 0.1, not greater than 0.09, not greater than 0.08, not greater than 0.07, not greater than 0.06, not greater than 0.05, not greater than 0.04, not greater than 0.03, not greater than 0.02, or not greater than 0.01.

Embodiment 143. The plurality of abrasive particles of any one of embodiments 69 to 76, wherein the coating is essentially free of an element selected from alkali and alkaline earth metal.

Embodiment 144. The plurality of abrasive particles of any one of embodiments 69 to 76, wherein the coating is essentially free of an element selected from transitional metal.

Embodiment 145. The plurality of abrasive particles of any one of embodiments 69 to 76, wherein the coating is essentially free of boron, aluminum, or both.

Embodiment 146. The plurality of abrasive particles of embodiment 111 or 112, wherein the coating comprises: a first portion overlying at least a portion of the core, wherein the first portion comprises a sintered ceramic material including the silicon; and a second portion overlying at least a portion of the core, wherein the second portion comprises silane.

Embodiment 147. The plurality of abrasive particles of embodiment 146, wherein the coating comprises a sintered colloidal silica.

Embodiment 148. The plurality of abrasive particles of any one of embodiments 109 and 147, wherein the second portion overlies at least a portion of the first portion.

Embodiment 149. The plurality of abrasive particles of any one of embodiments 69 to 76, wherein the abrasive particle comprises a content of the coating of at least 0.01 wt. % for a total weight of the core, at least 0.02 wt. %, at least 0.03 wt. %, at least 0.04 wt. %, at least 0.05 wt. %, at least 0.06 wt. %, at least 0.07 wt. %, at least 0.08 wt. %, at least 0.09 wt. %, at least 0.1 wt. %, at least 0.15 wt. %, at least 0.16 wt. %, at least 0.17 wt. %, at least 0.18 wt. %, at least 0.19 wt. %, at least 0.2 wt. %, at least 0.25 wt. %, at least 0.26 wt. %, at least 0.27 wt. %, at least 0.28 wt. %, at least 0.29 wt. %, or at least 0.3 wt. % for a total weight of the core.

Embodiment 150. The plurality of abrasive particles of any one of embodiments 69 to 76, wherein the abrasive particle comprises a content of the coating of not greater than 1 wt. % for a total weight of the core, not greater than 0.9 wt. %, not greater than 0.8 wt. %, not greater than 0.7 wt. %, not greater than 0.6 wt. %, not greater than 0.55 wt. %, not greater than 0.5 wt. %, not greater than 0.48 wt. %, not greater than 0.46 wt. %, not greater than 0.45 wt. %, not greater than 0.43 wt. %, not greater than 0.42 wt. %, not greater than 0.41 wt. %, not greater than 0.4 wt. %, not greater than 0.38 wt. %, not greater than 0.37 wt. %, not greater than 0.36 wt. %, not greater than 0.35 wt. %, or not greater than 0.34 wt. % for a total weight of the core.

Embodiment 151. The plurality of abrasive particles of any one of embodiments 69 to 76, wherein the coating comprises a thickness of not greater than 10 microns, not greater than 9 microns, not greater than 8 microns, not greater than 7 microns, not greater than 6 microns, not greater than 5 microns, not greater than 4 microns, not greater than 3 microns, not greater than 2 microns, not greater than 1 microns, not greater than 0.9 microns, not greater than 0.8 microns, not greater than 0.7 microns, not greater than 0.6 microns, not greater than 0.5 microns, not greater than 0.4 microns, not greater than 0.3 microns, or not greater than 0.2 microns.

Embodiment 152. The plurality of abrasive particles of any one of embodiments 69 to 76, wherein the coating comprises a thickness of at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16 microns, at least 0.17 microns, at least 0.18 microns, at least 0.19 microns, at least 0.20 microns, at least 0.21 microns, at least 0.22 microns, at least 0.24 microns, at least 0.26 microns, at least 0.28 microns, at least 0.29 microns, at least 0.30 microns, or at least 0.31 microns.

Embodiment 153. The plurality of abrasive particles of any one of embodiments 69 to 76, wherein the abrasive particle comprises a ratio of a thickness of the coating to an average particle size of the core, wherein the ratio is less than 1, not greater than 0.9, not greater than 0.7, not greater than 0.5, not greater than 0.4, not greater than 0.2, not greater than 0.1, not greater than 0.08, not greater than 0.06, not greater than 0.05, not greater than 0.03, not greater than 0.02, not greater than 0.01, not greater than 0.009, not greater than 0.008, not greater than 0.007, not greater than 0.006, not greater than 0.005, not greater than 0.004, not greater than 0.003, not greater than 0.002, or not greater than 0.1.

Embodiment 154. The plurality of abrasive particles of any one of embodiments 69 to 76, wherein the abrasive particle comprises a ratio of a thickness of the coating to an average particle size of the core, wherein the ratio is at least 0.0005, at least 0.0007, at least 0.0009, at least 0.001, at least 0.002, at least 0.003, at least 0.004, at least 0.005, at least 0.006, at least 0.007, at least 0.008, at least 0.009, at least 0.01, at least 0.02, or at least 0.03.

Embodiment 155. The plurality of abrasive particles of any one of embodiments 69 to 76, wherein the coating comprises a polycrystalline material.

Embodiment 156. The plurality of abrasive particles of any one of embodiments 69 to 76, wherein a majority of the coating is polycrystalline.

Embodiment 157. The plurality of abrasive particles of any one of embodiments 69 to 76, wherein for a total volume of the coating, at least 51 vol % of the coating is polycrystalline, at least 52 vol %, at least 53 vol %, at least 54 vol %, at least 55 vol %, at least 56 vol %, at least 57 vol %, at least 58 vol %, at least 59 vol %, at least 60 vol %, at least 61 vol %, at least 62 vol %, at least 63 vol %, at least 64 vol %, at least 65 vol %, at least 66 vol %, at least 67 vol %, at least 68 vol %, at least 69 vol %, at least 70 vol %, at least 71 vol %, at least 72 vol %, at least 73 vol %, at least 74 vol %, at least 75 vol %, at least 76 vol %, at least 77 vol %, at least 78 vol %, at least 79 vol %, at least 80 vol %, at least 81 vol %, at least 82 vol %, at least 83 vol %, at least 84 vol %, at least 85 vol %, at least 86 vol %, at least 87 vol %, at least 88 vol %, at least 89 vol %, at least 90 vol %, at least 91 vol %, at least 92 vol %, at least 93 vol %, at least 94 vol %, at least 95 vol %, at least 96 vol %, at least 97 vol %, at least 98 vol %, or at least 99 vol % of the coating is polycrystalline.

Embodiment 158. The plurality of abrasive particles of any one of embodiments 69 to 76, wherein the coating consists essentially of a polycrystalline material.

Embodiment 159. The plurality of abrasive particles of any one of embodiments 69 to 76, wherein the coating is essentially free of an amorphous phase.

Embodiment 160. The plurality of abrasive particles of any one of embodiments 69 to 76, wherein a majority of the coating is silica.

Embodiment 161. The plurality of abrasive particles of any one of embodiments 69 to 76, wherein for a total weight of the coating, at least 51 wt. % of the coating is silica, at least 52 wt. %, at least 53 wt. %, at least 54 wt. %, at least 55 wt. %, at least 56 wt. %, at least 57 wt. %, at least 58 wt. %, at least 59 wt. %, at least 60 wt. %, at least 61 wt. %, at least 62 wt. %, at least 63 wt. %, at least 64 wt. %, at least 65 wt. %, at least 66 wt. %, at least 67 wt. %, at least 68 wt. %, at least 69 wt. %, at least 70 wt. %, at least 71 wt. %, at least 72 wt. %, at least 73 wt. %, at least 74 wt. %, at least 75 wt. %, at least 76 wt. %, at least 77 wt. %, at least 78 wt. %, at least 79 wt. %, at least 80 wt. %, at least 81 wt. %, at least 82 wt. %, at least 83 wt. %, at least 84 wt. %, at least 85 wt. %, at least 86 wt. %, at least 87 wt. %, at least 88 wt. %, at least 89 wt. %, at least 90 wt. %, at least 91 wt. %, at least 92 wt. %, at least 93 wt. %, at least 94 wt. %, or at least 95 wt. % of the coating is silica.

Embodiment 162. The plurality of abrasive particles of any one of embodiments 69 to 76, wherein the coating consists essentially of silica.

Embodiment 163. The plurality of abrasive particles of any one of embodiments 69 to 76, wherein the coating comprises silica grains having an average crystallite size of at least 0.01 microns, at least, at least 0.02 microns, at least 0.03 microns, at least 0.04 microns, at least 0.05 microns, at least 0.06 microns, at least 0.07 microns, at least 0.08 microns, at least 0.09 microns, at least 0.1 microns, at least 0.11 microns, at least 0.12 microns, at least 0.13 microns, at least 0.14 microns, at least 0.15 microns, at least 0.16, at least 0.17 microns, at least 0.18 microns, at least 0.19 microns, at least 0.2 microns, at least 0.3 microns, at least 0.4 microns, at least 0.5 microns, at least 0.6 microns, at least 0.7 microns, at least 0.8 microns, at least 0.9 microns, at least 1 micron, at least 1.2 microns, at least 1.4 microns, at least 1.6 microns, at least 1.8 microns, at least 2 microns, at least 2.3 microns, at least 2.6 microns, at least 2.8 microns, at least 3 microns, at least 3.2 microns, at least 3.4 microns, at least 3.6 microns, at least 3.8 microns, at least 4 microns, at least 4.2 microns, at least 4.5 microns, at least 4.8, at least 5 microns, at least 5.2 microns, at least 5.4 microns, at least 5.5 microns, at least 5.7 microns, at least 6 microns, at least 6.2 microns, at least 6.3 microns, at least 6.5 microns, at least 6.7 microns, at least 6.8 microns, at least 7 microns, at least 7.2, at least 7.4 microns, at least 7.5 microns, at least 7.8 microns, at least 8 microns, at least 8.1 microns, at least 8.3 microns, at least 8.5 microns, at least 8.6 microns, at least 8.7 microns, at least 8.9 microns, at least 9, at least 9.1 microns, at least 9.3 microns, at least 9.4 microns, at least 9.6 microns, at least 9.8 microns, or at least 10 microns.

Embodiment 164. The plurality of abrasive particles of any one of embodiments 69 to 76, wherein the coating comprises silica grains having an average crystallite size of not greater than 10 microns, not greater than 9.8 microns, not greater than 9.6 microns, not greater than 9.4 microns, not greater than 9.2 microns, not greater than 9 microns, not greater than 8.7 microns, not greater than 8.5 microns, not greater than 8.3 microns, not greater than 8.1 microns, not greater than 8 microns, not greater than 7.8 microns, not greater than 7.6 microns, not greater than 7.4 microns, not greater than 7.2 microns, not greater than 7 microns, not greater than 6.8 microns, not greater than 6.6 microns, not greater than 6.4 microns, not greater than 6.3 microns, not greater than 6.2 microns, not greater than 6 microns, not greater than 5.8 microns, not greater than 5.6 microns, not greater than 5.4 microns, not greater than 5.3 microns, not greater than 5 microns, not greater than 4.8 microns, not greater than 4.6 microns, not greater than 4.4 microns, not greater than 4.2 microns, not greater than 4 microns, not greater than 3.8 microns, not greater than 3.6 microns, not greater than 3.4 microns, not greater than 3.2 microns, not greater than 2.9 microns, not greater than 2.8 microns, not greater than 2.6 microns, not greater than 2.4 microns, not greater than 2.2 microns, not greater than 2 microns, not greater than 1.8 microns, not greater than 1.6 microns, not greater than 1.4 microns, not greater than 1.2 microns, not greater than 1 microns, not greater than 0.9 microns, not greater than 0.8 microns, not greater than 0.7 microns, not greater than 0.6 microns, not greater than 0.5 microns, not greater than 0.4 microns, not greater than 0.3 microns, not greater than 0.2 microns, not greater than 0.1 microns, not greater than 0.09 microns, not greater than 0.08 microns, not greater than 0.07 microns, not greater than 0.06 microns, not greater than 0.05 microns, not greater than 0.04 microns, not greater than 0.03 microns, not greater than 0.02 microns, or not greater than 0.01 microns.

Embodiment 165. The plurality of abrasive particles of any one of embodiments 69 to 76, wherein the majority of the coating consists essentially of silica grains.

Embodiment 166. The plurality of abrasive particles of any one of embodiments 69 to 76, wherein the coating consists essentially of silica grains.

Embodiment 167. The plurality of abrasive particles of any one of embodiments 69 to 76, wherein the abrasive particle comprises an average particle size of at least 10 microns, at least 30 microns, at least 40 microns, at least 50 microns, at least 60 microns, at least 70 microns, at least 80 microns, at least 90 microns, at least 100 microns, at least 120 microns, at least 140 microns, at least 150 microns, at least 170 microns, at least 180 microns, at least 200 microns, at least 210 microns, at least 230 microns, at least 250 microns, at least 260 microns, at least 270 microns, at least 290 microns, at least 300 microns, at least 320 microns, at least 340 microns, at least 350 microns, at least 360 microns, at least 380 microns, at least 400 microns, at least 420 microns, at least 430 microns, at least 440 microns, at least 450 microns, at least 460 microns, at least 470 microns, at least 490 microns, or at least 500 microns.

Embodiment 168. The plurality of abrasive particles of any one of embodiments 69 to 76, wherein the abrasive particle comprises an average particle size of not greater than 2000 microns, not greater than 1800 microns, not greater than 1600 microns, not greater than 1500 microns, not greater than 1400 microns, not greater than 1300 microns, not greater than 1200 microns, not greater than 1100 microns, not greater than 1000 microns, not greater than 900 microns, not greater than 850 microns, not greater than 830 microns, not greater than 800 microns, not greater than 750 microns, not greater than 700 microns, not greater than 650 microns, not greater than 600 microns, not greater than 550 microns, not greater than 500 microns, not greater than 450 microns, or not greater than 400 microns.

Embodiment 169. The plurality of abrasive particles of any one of embodiments 69 to 76, wherein the coating comprises silane, wherein the silane is in form of an organic-inorganic compound.

Embodiment 170. The plurality of abrasive particles of embodiment 169, wherein the compound comprises organosilicon.

Embodiment 171. The plurality of abrasive particles of embodiment 169 or 170, wherein the compound comprises aminosilane, bis-aminosilane, gamma-aminopropyltriethoxysilane, or any combination thereof.

Embodiment 172. The plurality of abrasive particles of any one of embodiments 69 to 76, wherein the first portion comprises an average domain size of at least 10 nm, at least 12 nm, at least 15 nm, at least 18 nm, at least 20 nm, at least 22 nm, at least 25 nm, at least 28 nm, at least 30 nm, at least 33 nm, at least 35 nm, at least 38 nm, at least 40 nm, at least 42 nm, at least 45 nm, at least 47 nm, at least 50 nm, at least 53 nm, at least 55 nm, at least 58 nm, at least 60 nm, at least 62 nm, at least 65 nm, at least 68 nm, at least 70 nm, at least 73 nm, or at least 75 nm.

Embodiment 173. The plurality of abrasive particles of any one of embodiments 69 to 76, wherein the first portion comprises an average domain size can be at most 200 nm, at most 180 nm, at most 170 nm, at most 160 nm, at most 150 nm, at most 130 nm, at most 120 nm, at most 100 nm, at most 90 nm, at most 85 nm, at most 83 nm, at most 80 nm, at most 78 nm, at most 75 nm, at most 72 nm, at most 70 nm, at most 68 nm, at most 65 nm, at most 62 nm, at most 60 nm, at most 58 nm, at most 55 nm, at most 52 nm, or at most 50 nm.

Embodiment 174. The plurality of abrasive particles of any one of embodiments 69 to 76, wherein the first portion comprises an average root-mean-square roughness (Rq) of less than 11.9 nm, at most 11.8 nm, at most 11.5 nm, at most 11.2 nm, at most 11 nm, at most 10.8 nm, at most 10.5 nm, at most 10 nm, at most 9.5 nm, at most 9.2 nm, at most 9 nm, at most 8.5 nm, at most 8 nm, at most 7.8 nm, at most 7.5 nm, at most 7 nm, at most 6.5 nm, at most 6 nm, at most 5.5 nm, or at most 5 nm.

Embodiment 175. The plurality of abrasive particles of any one of embodiments 69 to 76, wherein the first portion comprises an average root-mean-square roughness (Rq) of greater than 4.6 nm, such as at least 4.7 nm, at least 5 nm, at least 5.3 nm, at least 5.5 nm, at least 5.8 nm, at least 6 nm, at least 6.3 nm, at least 6.5 nm, at least 6.8 nm, at least 7 nm, at least 7.3 nm, at least 7.5 nm, at least 7.8 nm, at least 8 nm, at least 8.5 nm, at least 9 nm, at least 9.5 nm, or at least 10 nm.

Embodiment 176. A plurality of abrasive particles, wherein each of the plurality of abrasive particles comprises a sintered coating overlying a core, wherein the sintered coating comprises an oxide material, and wherein the plurality of abrasive particles comprise an average total silica content of at most 0.3 wt. % for a total weight of the plurality of abrasive particles and an average coating coverage of at least 50% of a surface of the core.

Embodiment 177. A plurality of abrasive particles, wherein each of the plurality of abrasive particles comprise a coating overlying a core, wherein the coating comprises an oxide material and an average content of bonded silica relative to a total content of silica in the coating of at least 15% and an average coating coverage of at least 50% of a surface of the core.

### EXAMPLES

### Example 1

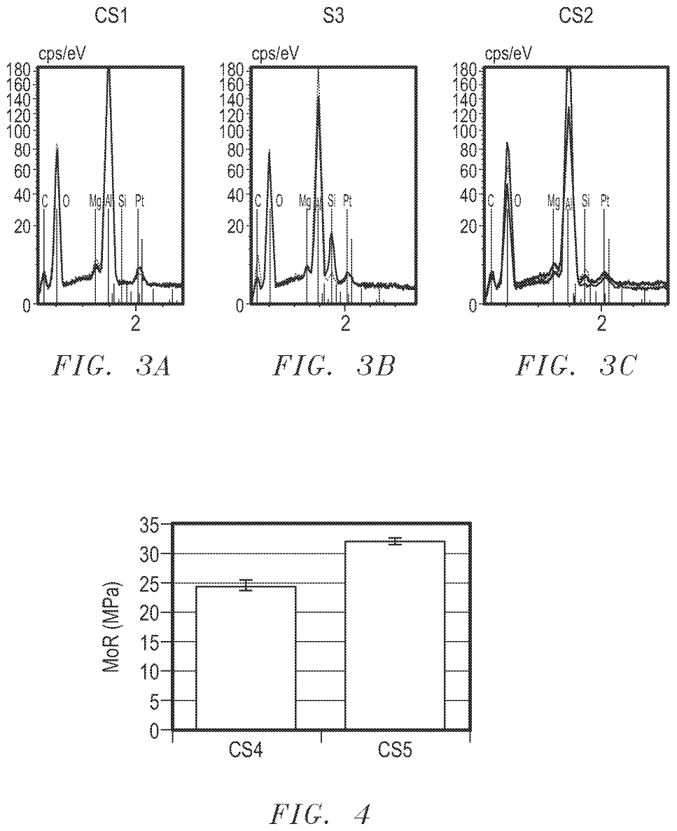

HiPal® alumina particles were mixed with Ludox® colloidal silica at a silica content of 0.1 wt. % for a total weight of the alumina particles for 3 to 5 minutes. A portion of the wetted particles were sintered at 850° C. for 15 minutes to form coated particle Sample S3. Another portion of the wetted particles were dried at 250° C. to form Sample CS2. Untreated particles are referred to as Sample CS1. All the samples were analyzed using Energy Dispersive Spectroscopy. The readout of represent of each Sample is included in FIGS. 3A to 3C, respectively. As illustrated, Sample S3 demonstrated a distinct and higher Silicon peak compared to Samples CS1 and CS2.

Average Energy Dispersive Spectroscopy Values of some elements based on tests on at least 5 abrasive particles are included in Table 1 below.

TABLE 1

| | | C | O | Mg | Al | Si | Pt |
|---|---|---|---|---|---|---|---|
| CS1 | Mean value: | 4.16 | 48.79 | 0.76 | 46.29 | 0.00 | 0.00 |
| | Standard deviation | 0.93 | 0.69 | 0.13 | 0.42 | 0.00 | 0.00 |
| S3 | Mean value: | 5.52 | 48.48 | 0.71 | 42.26 | 3.03 | 0.00 |
| | Standard deviation | 4.42 | 1.77 | 0.13 | 4.92 | 1.61 | 0.00 |
| CS2 | Mean value: | 4.72 | 48.65 | 0.65 | 45.59 | 0.39 | 0.00 |
| | Standard deviation | 2.84 | 2.56 | 0.04 | 3.14 | 0.26 | 0.00 |

Samples CS1, S3, and CS2 were further analyzed using atomic force microscope. FIG. 8A includes an image of Sample CS1. FIG. 8B includes an image of the coating portion of Sample CS2, and FIG. 8C includes an image of the coating portion of Sample S 3. Sample CS2 has an average domain size smaller than the average domain size of Sample S3.

Table 2 includes root-mean-square roughness of the samples.

TABLE 2

| Samples | Rq Roughness (nm) |
|---|---|
| CS1 | 8.3 |
| CS2 | 11.9 |
| S3 | 4.6 |

### Example 2

HiPal® Alumina particles were mixed with a colloidal silica suspension at a silica content of 0.1 wt. % for a total weight of the alumina particles. The wetted grains were heated to 850° C. at a 30 minutes ramp from room temperature (approximately 20° C. to 25° C.), sintered for 15 minutes at 850° C., and then cooled down in the air. The coated alumina particles were further treated with 3-aminopropyltriethoxysilane and dried to form abrasive particles representative of embodiments herein. Abrasive particles and untreated alumina particles were mixed with phenolic resin, respectively, pressed, and cured to form bar samples. Bar samples including representative abrasive particles are referred to as Sample S5, and bar samples including untreated alumina particles are referred to as Sample CS4. Flexural strength (i.e., MoR) were tested on all the bar samples.

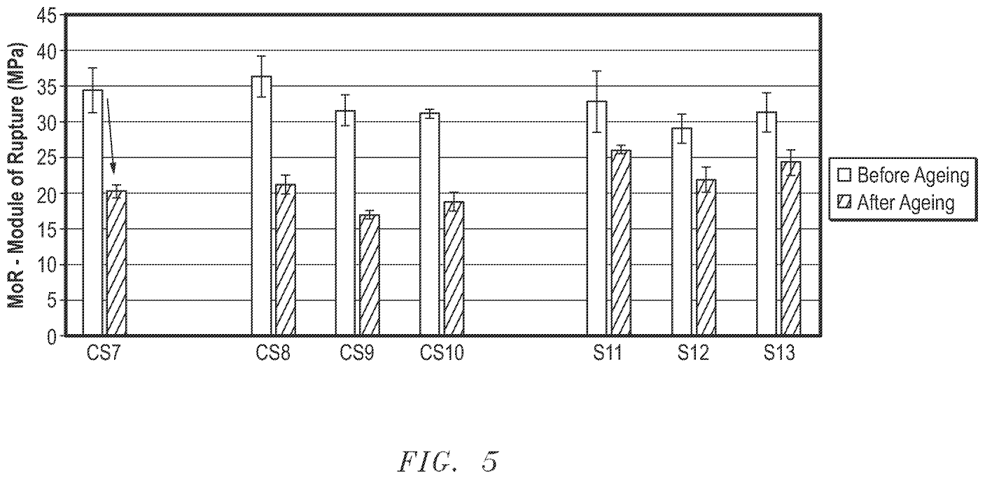

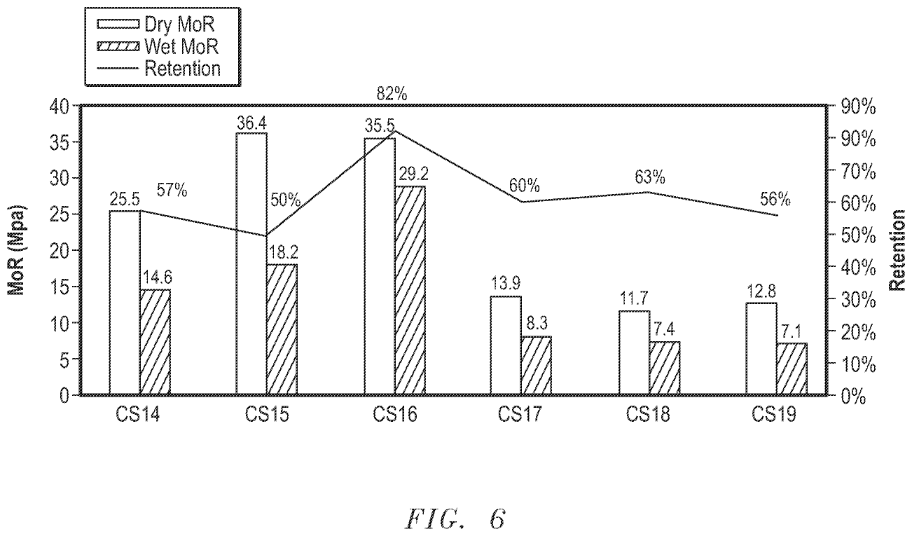

As illustrated in FIG. 4, Sample S5 demonstrated significantly improved MoR over Sample CS4.

### Example 3

Particle samples CS1, CS2, and S3 from Example 1 were further treated as described in the following paragraphs. Coating with silane was performed in the same manner as described in Example 2 and 3-aminopropyltriethoxysilane was used. Bar Samples were formed in the same manner as described in Example 2.

CS1 particles were coated with silane and used to form bar Sample CS7.

Particles of Sample CS2 and S3 were mixed with water using a Kenwood mixer at high speed for an hour, respectively. Water-treated CS2 particles were divided into 2 portions. One portion was coated with silane and then used to form bar Sample CS10, and another portion was not coated with silane and directly used to form bar Sample CS9. Untreated CS2 particles were coated with silane and used to form bar Sample CS8.

Untreated S3 particles were coated with silane and used to form bar Sample S11. A portion of water-treated S3 particles were coated with silane and formed into bar Sample S13, and another portion of water-treated S3 particles were not coated with silane and directly used to form bar Sample S12.

At least 3 bars from each Sample were aged at 50° C. and 90% relative humidity and then tested for MoR. At least 3 unaged bars from each Sample were also tested for MoR. FIG. 5 includes an illustration of MoR of all the Samples.

As illustrated, aged Sample CS7 demonstrated a drop in MoR of 41% compared to unaged Sample CS7. Aged Sample CS8 demonstrated a reduction in MoR of about 42% compared to unaged CS8. Aged Sample CS9 demonstrated a reduction in MoR of about 46% compared to unaged Sample CS9. Aged Sample CS10 demonstrated a reduction in MoR of about 40% compared to unaged Sample CS10.

Aged Sample S11 demonstrated a reduction in MoR of about 21% compared to unaged Sample S11. Aged Sample S12 demonstrated a reduction in MoR of about 25% compared to unaged Sample S12. Aged Sample S13 demonstrated a reduction in MoR of about 22% compared to unaged Sample S13.

### Example 4

Hipal® alumina particles were treated with 3-aminopropyltriethoxysilane and then dried at 150° C. Amino silane coated particles were used to form bar Sample CS14. All bar Samples were formed in the same manner as described in Example 2.

Additional Hipal® alumina particles were wetted using a Ludox® colloidal silica suspension in the same manner as described in Example 1. A portion of wetted particles were sintered at 960° C. and used to form Sample CS15. A second portion of wetted particles were sintered at 960° C. and then coated with 3-aminopropyltriethoxysilane and dried at 150° C. to form abrasive particles representative of embodiments herein. Bar Sample S16 were formed using the representative abrasive particles.

A third portion of wetted particles were dried at 150° C. and used to form bar Sample CS17. A fourth portion of wetted particles were dried at 150° C., coated with 3-aminopropyltriethoxysilane, dried again at 150° C., and then used to form bar Sample CS18. A fifth portion of wetted particles were dried at 150° C., coated with 3-aminopropyltriethoxysilane, dried at room temperature (20 to 25° C.), and then used to form bar Sample CS19.

Bars from each Sample were tested for both wet MoR and dry MoR. Wet MoR refers to MoR tested on bars that had been boiled in water for 150 minutes. FIG. 6 includes an illustration of wet and dry MoR and retention of MoR after boiling for all Samples. Sample S16 demonstrated highest wet MoR (29.2 MPa) and MoR retention (82%) after boiling compared to respective wet MoR and MoR retention of Samples CS14 (14.6 MPa; 57%), CS15 (18.2 MPa; 50%), CS17 (8.3 MPa; 60%), CS18 (7.4 MPa; 63%), and CS19 (7.1 MPa; 56%).

### Example 5

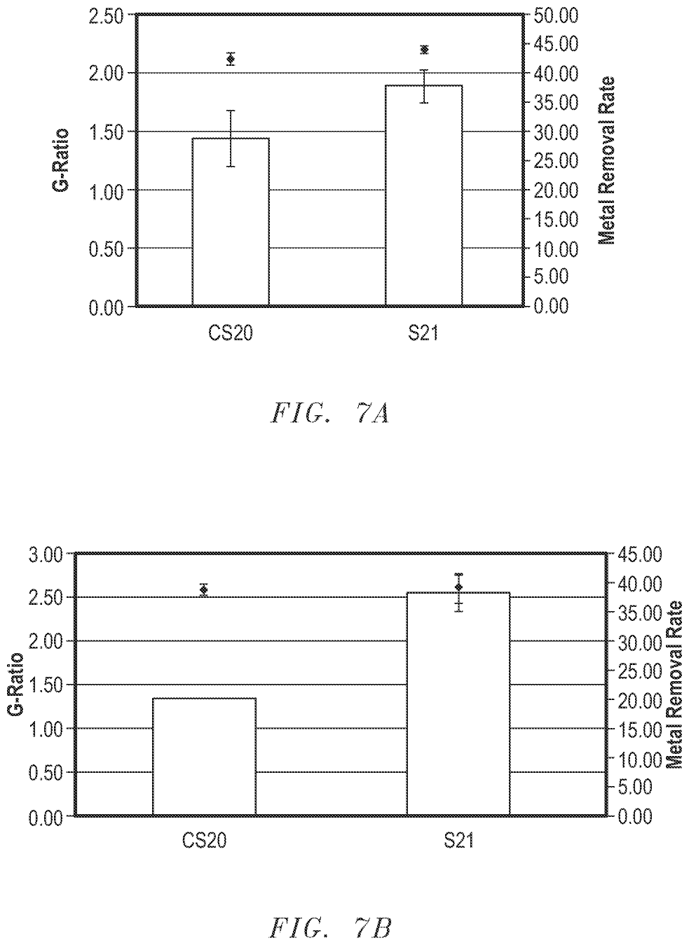

Grinding wheels Sample CS20 were formed using Hipal® alumina particles. Additional Hipal® alumina particles were treated with colloidal silica and then silane in the same manner as disclosed in Example 2 to form representative abrasive particles, which were used to form grinding wheels Sample S21. At least 3 wheels from each Wheel Sample were tested on grinding a workpiece of stainless steel and a workpiece of carbon steel, respectively. FIG. 7A includes a plot of G-Ratio vs. Material Removal Rate of Samples tested on stainless steel. FIG. 7B includes a plot of G-Ratio vs. Material Removal Rate of Samples tested on carbon steel.

As illustrated, Wheel Sample S21, compared to Sample CS20, demonstrated improved G-Ratio and Material Removal Rate on both types of workpieces.

### Example 6

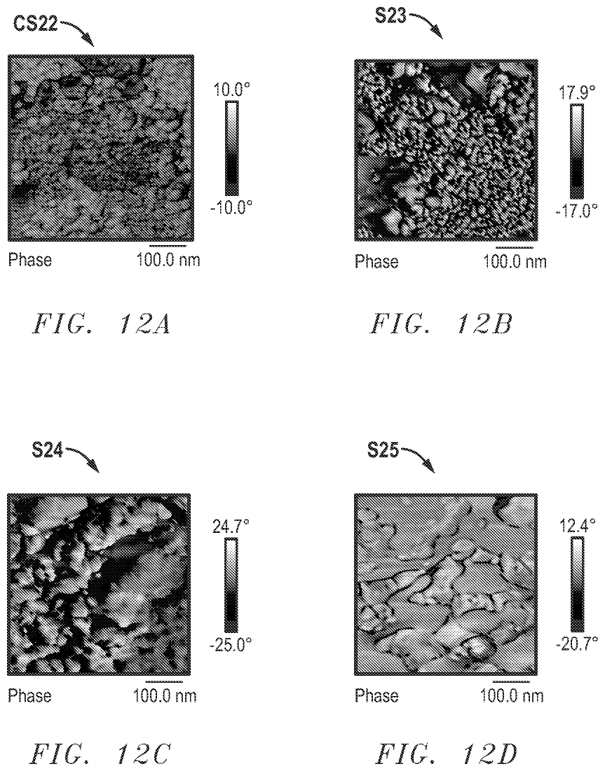

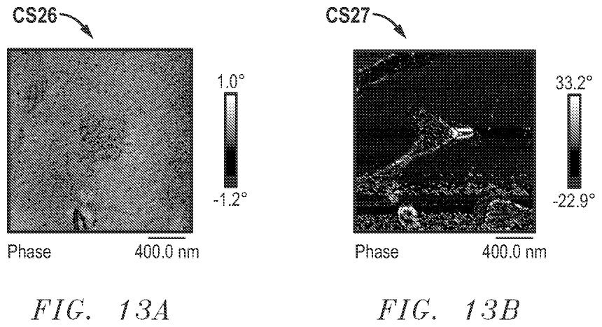

HiPal® alumina particles of 36 grits were mixed with Ludox® colloidal silica at a silica content of 0.1 wt. % for a total weight of the alumina particles for 3 to 5 minutes. Portions of the wetted particles were sintered at 850° C., 960° C., and 1100° C. for 15 minutes to form coated particle Sample S23, S24, S25, respectively. Another portion of the wetted particles were dried at 250° C. to form Sample CS22 Roughness and domain sizes of all the samples were analyzed according to embodiments herein and included in Table 3 below. Crystallinity of all the samples were analyzed according to embodiments herein, except powder sample of Sample CS22 was prepared at the heating temperature of 250° C. AFM phase images of the samples are included in FIGS. 12A to 12D.

TABLE 3

| | CS22 | S23 | S24 | S25 |
|---|---|---|---|---|
| Average Rq (nm) | 6 | 3 | 3 | 3 |
| Average Domain size | 19 | 28 | 56 | 126 |
| Crystallinity | 0% | 3% | 63% | 61% |

Flat pure crystalline alumina substrates (Al₂O₃ content >99.5%) were coated with sodium silicate using a solution including silica at the concentration of 26% and Na₂O 8%. The sodium silicate includes 76 wt % of silica and 24 wt % of sodium oxide. Coated substrates were heated at 850° C. and 1100° C. to form sintered sodium silicate coating Sample CS26 and CS27, respectively. Average roughness of the sintered sodium silicate coating was measured in the same manner as described in embodiments herein with respect to the first portion. Average roughness of the sintered coating on the flat pure crystalline alumina substrate prepared as disclosed herein is similar to the roughness of the sintered coating on abrasive particle cores. Crystallinity of powder sodium silicate sintered at 850° C. and 1100° C. was determined in according to embodiments herein. AFM phase images of Sample CS26 and CS27 are included in FIGS. 13A and 13B, respectively.

TABLE 4

| | CS26 | CS27 |
|---|---|---|
| Average Rq (nm) | 0.5 | 1 |
| Crystallinity | >0% | 0% |

### Example 7

Two samples (S7-1 and CS7-2) of white fused alumina grains of grit 36 were coated using the following process.

7.5 g of Ludox® colloidal silica having 33 wt. % of silica were mixed with 17.5 g of deionized water (final concentration of approximately 0.1 wt % of silica) for 5 min to form a suspension. 2.5 kg of grains were mixed with the silica suspension for 5 minutes using a mixer set at a certain mixing speed of revolution per minute (rpm) as specified in the below paragraph. The wet grains were transferred to crucibles and placed in a furnace that was preheated to 650° C., and then the furnace temperature was increased to 850° C. in 30 min. The grains were heated at 850° C. for 15 min and cooled down to the room temperature (approximately 22° C.) in air.

Sample S7-1 was formed using the mixing speed of 190 rpm; while Sample CS7-2 were formed using the mixing speed of 60 rpm.

The coating coverage of Samples S7-1 and CS7-2 were determined according to the EDS analysis described in embodiments herein. Specifically, 20 coated grains of Sample CS7-2 were randomly selected, and a total of 100 spots were analyzed with 3 to 5 spots per grain, in which 15 spots had less than 0.1 atomic % of Si, and 5 grains were not fully covered. 18 coated grains of Sample S7-1 were randomly selected, and a total of 65 spots were analyzed with 3 to 5 spots per grain, in which 1 spot had less than 0.1 atomic % of Si and 1 grain was not fully covered. Test results are summarized in Table 5 below.

TABLE 5

| | Mixing speed | Average coating | % grains fully |
|---|---|---|---|
| sample | (rpm) | coverage | covered |
| CS7-2 | 60 | 85% | 75% |
| S7-1 | 190 | 96% | 94.4% |

As noted in Table 5, the average coating coverage of Sample CS7-2 was 85%, while the average coating coverage of Sample S7-1 was 96%. Further determined as disclosed in embodiments herein, Sample CS7-2 included 75% of grains that were fully covered; while Sample S7-1 included 94.4% of grains that were fully covered.

The thickness of the coating of Sample S7-1 was estimated to be approximately 0.2 μm and a content of SiO₂ of approximately 0.1 wt. % for the total weight of the abrasive particles as determined in accordance to embodiments herein.

### Example 8

Abrasive particles (cores) are mixed with Ludox® colloidal silica at a silica content of 0.1 wt. % for a total weight of the particles for 3 to 5 minutes. Portions of the wetted particles are dried at 500° C. or sintered at 850° C., 1200° C., and 1500° C. Coated particle samples are tested at a humid condition for Moisture Absorption Rate. Additional coated particle samples are tested for Adhesion Value. Further coated abrasive particles samples are tested at an accelerated aging condition for Anti-aging Factor.

Abrasive samples are formed using the coated abrasive particles, and material removal tests are conducted on the abrasive samples.

Abrasive particles sintered at 850° C. compared to those treated at the other temperatures have notably different features including one or more of surface morphology, contents of agglomerated particles, average coating thickness, average domain size, crystallinity, thickness deviation, and domain size deviation.

### Example 9

Representative coated abrasive particles are formed as follows. HiPal® alumina particles are mixed with Ludox® colloidal silica at a silica content of 0.1 wt. % for a total weight of the alumina particles for 3 to 5 minutes. The wetted particles are sintered at 850° C. in a rotary tube tilted at an angle not greater than 20°. The particles are moved by gravity in the rotary tube. Residence time is 20 min.

### Example 10

HiPal® 24 grits Alumina particles are mixed with a colloidal silica suspension at a silica content of 0.1 wt. % for a total weight of the alumina particles using the mixing parameters noted in Table 6 below. The wetted particles are heated to 850° C. at a 30 minutes ramp from room temperature (approximately 20° C. to 25° C.), sintered for 15 minutes at 850° C., and then cooled down in the air. Coating coverage of all the samples, S38 to S41, are tested as described in embodiments herein.

TABLE 6

| Samples | Mixing time | RPM | Temperature | Mixer type |
|---|---|---|---|---|
| S38 | 3 to 5 | 70 | 20° C. | Hobart mixers |
| | minutes | | | |
| | min | | | |
| S39 | 3 to 5 | 180 | 20° C. | Hobart mixers |
| | minutes | | | |
| S40 | 1 min | 180 | 20° C. | Hobart mixers |

### Example 11

HiPal® 24 grits alumina particles were mixed with Ludox® colloidal silica at a silica content of 0.1 wt. % for a total weight of the alumina particles. The wetted particles were sintered at 850° C. for 15 minutes to form Sample S45. Additional HiPal® 24 grits alumina particles were mixed with Ludox® colloidal silica at a silica content of 0.3 wt. % for a total weight of the alumina particles and sintered at 850° C. for 15 minutes to form Sample S46.Total silica contents of Samples S45 and S46 were determined by directing mixing 10 g of abrasive particles of each sample with Hydrofluoric acid (HF). After dissolution of silica, abrasive particles were removed, and distilled water was added to the solution to a total volume of 50 mL. The liquid was used to perform ICP analysis to determine the total contents of silica of Samples S45 and S46.

Loose silica content of each of Samples S45 and S46 were tested. 10 g of abrasive particles of each of Samples S45 and S46 were added to 20 mL of distilled water. Without intentionally shaking the mixture of abrasive particles and distilled water, the abrasive particles were removed by sieving the mixture and kept for further tests of friable silica. Hydrofluoric acid (HF) of 0.25 ml was added to the liquid and the total volume was brought up to 50 mL by addition of distilled water. ICP was performed to analysis the content of loose silica of Samples S45 and S46.

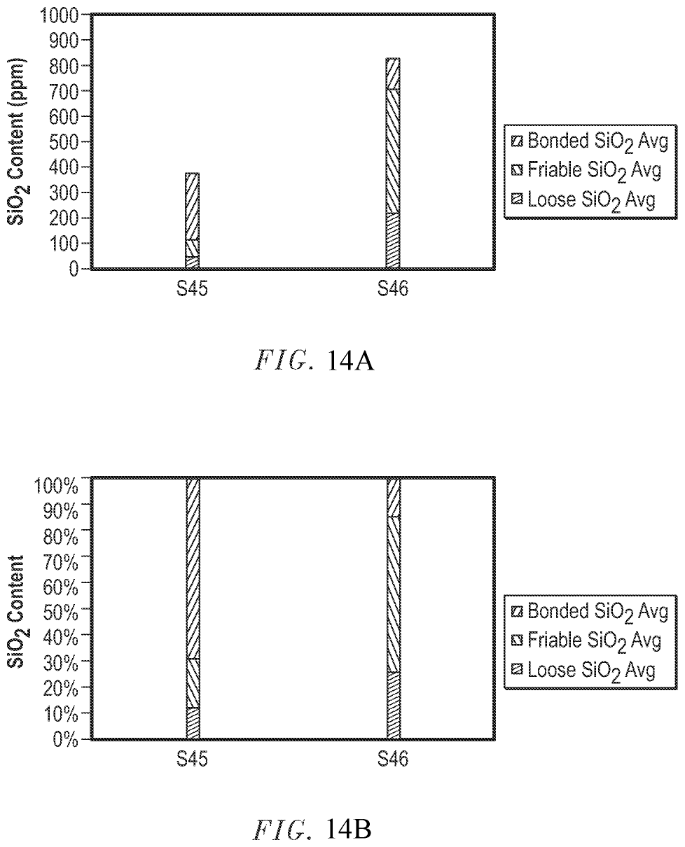

After removal of loose silica, 10 g of abrasive particles from each of Samples S45 and S46 were mixed with 20 mL distilled water by vortex mixing for 1 minute. Abrasive particles were separated, and 0.25 mL of HF was added to the liquid and distilled water was added to a total volume of 50 mL. The liquid was analyzed by ICP to determine friable silica of Samples S45 and S46. The bonded silica content was determined by deducting the contents of the loose silica and friable silica from the total contents of silica. Results are summarized in FIGS. 14A and 14B.

As illustrated in FIG. 14A, Sample S45 includes an average total content of silica of about 390 ppm, an average content of loose silica content of about 50 ppm, an average content of friable silica content of about 70 ppm, and average content of bonded silica of about 270 ppm for a total weight of the abrasive particles. Sample S46 includes an average total content of silica of 820 ppm, an average loose silica content of about 210 ppm, an average friable silica content of about 490 ppm, and an average bonded silica content of about 120 ppm for a total weight of the abrasive particles.

As illustrated in FIG. 14B, Sample 45 includes about 12% of loose silica, about 19% of friable silica and about 69% of bonded silica. Sample 45 includes about 28% of loose silica, 57% of friable silica and about 15% of bonded silica.

### Example 12

Flat alumina substrates (99.5% purity) was dip coated in Ludox® colloidal silica solution and heated at 250° C. or 500° C. or sintered at 850° C., 960° C., or 1100° C. for 15 minutes to form a coating with the final thickness of about 350 nm as measured by contact profilometry. Nanoindentation was performed on the coated substrates with an indent depth of 300 nm, and 20 indents were made for the coated substrates. Hardness of substrates coated at different conditions is included in Table 7 below.

TABLE 7

| | |
|---|---|
| Substrates/Heating Temperature | Hardness (GPa) |

| | | |
|---|---|---|
| 1/250° | C. | about 1 |
| 2/500° | C. | about 1 |
| 3/850° | C. | about 3 |
| 4/960° | C. | about 3 |
| 5/1100° | C. | about 8 |

### Example 12

Abrasive particles (Sample S12-1, S12-2, S12-3, and S12-4) including cores of various materials and coating are being formed in the same manner as disclosed in Example 7. While not wishing to be bound to any theory, it is noted certain parameters of the coating process can improve certain coating properties. Properties of the coating, including average coating coverage, percentage of fully covered grains, average thickness of the coating, domain size, crystallinity, contents of loose silica, friable silica and bonded silica, and conformability of the coating, are being evaluated.

TABLE 8

| Sample | Core materials |
|---|---|
| S12-1 | Brown fused alumina |
| S12-2 | Ruby alumina |
| S12-3 | SiC |
| S12-4 | Sintered sol-gel alumina |

The foregoing embodiments represent a departure from the state-of-the-art. Embodiments are directed to abrasive particles including a coating overlying a core. In particular, the abrasive particles can include a thin conformal coating with improved average thickness and uniformity, which can facilitates improvement of performance of the abrasive particles in fixed abrasives, such as lowering the friction associated with their use in material removal operations, anti-ageing, and a chemical and mechanical bonding of the conformal layer to the surface of the abrasive particles (i.e., core particles). Furthermore, the abrasive particles can have improved bonding strength and reduced moisture absorption and/or permeation and be particularly suitable for use in coated abrasives and thin wheels.

Abrasive articles formed with representative abrasive particles further demonstrate improved performance and properties, such as wet MoR, G-Ratio, and MMR over abrasive articles including abrasive particles including a dried coating. Not wishing to be bound to any theory, improved properties and performance of abrasive articles may be facilitated by one or more factors including the composition, microstructure, thickness, content of silica, content of silicon of the coating of abrasive particles of embodiments herein, which may help form an improved interface and improved bonding between the bond material and abrasive particles.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1-15. (canceled)

16. A plurality of abrasive particles, wherein each of the plurality of abrasive particles comprises a sintered coating overlying a core, wherein the sintered coating comprises an oxide material, and wherein more than 75% of the plurality of abrasive particles are fully covered.

17. The plurality of abrasive particles of claim 16, wherein the sintered coating comprises silica.

18. The plurality of abrasive particles of claim 17, wherein the sintered coating comprises for a content of silica, at least 15% of bonded silica, at least 10% of friable silica, not greater than 27% loose silica, or any combination thereof, wherein the bonded silica is bonded to the core.

19. The plurality of abrasive particles of claim 16, wherein the sintered coating comprises a percentage of crystallinity of at least 1% and not greater than 63%.

20. The plurality of abrasive particles of claim 16, wherein the plurality of abrasive particles comprise an average domain size of the sintered coating of not greater than 130 nm.

21. The plurality of abrasive particles of claim 16, wherein the average domain size of the sintered coating is greater than 19 nm, wherein an absolute value of a domain size standard deviation is at most 50% of the average domains size.

22. The plurality of abrasive particles of claim 16, comprising an average coating coverage of at least 86% of a surface of the core.

23. The plurality of abrasive particles of claim 16, wherein the core comprises a ceramic material.

24. A plurality of abrasive particles, wherein:
each of the plurality of abrasive particles comprises a coating overlying a core, wherein the coating comprises an oxide material; and
the plurality of abrasive particles comprise:
an average domain size of the coating of not greater than 130 nm; and
an average coating coverage of greater than 85% of a surface of the core.

25. The plurality of abrasive particles of claim 24, wherein the coating comprises silica.

26. The plurality of abrasive particles of claim 25, wherein silica is in a content of at most 1000 ppm relative to a weight of the plurality of abrasive particles.

27. The plurality of abrasive particles of claim 25, wherein the coating comprises at least 15% of bonded silica relative to a content of silica, wherein the bonded silica is bonded to the core.

28. The plurality of abrasive particles of claim 25, wherein the coating comprises relative to a content of silica, at least 10% of friable silica, not greater than 27% loose silica, or any combination thereof.

29. The plurality of abrasive particles of claim 24, comprising an average domain size of the coating of greater than 19 nm and a domain size standard deviation, wherein an absolute value of the domain size standard deviation is at most 50% of the average domains size.

30. A plurality of abrasive particles, wherein each of the plurality of abrasive particles comprise a coating overlying a core, wherein the coating comprises an oxide material and an average content of bonded silica relative to a total content of silica in the coating of at least 15% and an average coating coverage of at least 86% of a surface of the core.

31. The plurality of abrasive particles of claim 30, wherein the coating comprises silica.

32. The plurality of abrasive particles of claim 30, wherein:
the plurality of abrasive particles comprise an average domain size of the coating of greater than 19 nm and not greater than 130 nm.

33. The plurality of abrasive particles of claim 30, wherein the coating comprises a percentage of crystallinity, wherein of at least 1% and not greater than 63%.

34. The plurality of abrasive particles of claim 30, comprising an average coating coverage of at least 90% of a surface of the core.

35. The plurality of abrasive particles of claim 30, wherein the plurality is at least 1 kg of abrasive particles.
